(19) United States
(12) Patent Application Publication
(10) Pub. No.: US 2018/0282623 A1
(43) Pub. Date: Oct. 4, 2018

(54) LIQUID-CRYSTAL COMPOSITION, LIQUID-CRYSTAL DISPLAY ELEMENT, AND LIQUID-CRYSTAL DISPLAY

(71) Applicant: DIC Corporation, Tokyo (JP)

(72) Inventors: Tsuyoshi Sasaki, Kita-adachi-gun (JP); Hidenari Akiyama, Kita-adachi-gun (JP); Yasuo Umezu, Kita-adachi-gun (JP); Kazunori Maruyama, Kita-adachi-gun (JP); Haruki Ohishi, Kita-adachi-gun (JP); Shinji Ogawa, Kita-adachi-gun (JP); Yoshinori Iwashita, Kita-adachi-gun (JP)

(73) Assignee: DIC Corporation, Tokyo (JP)

(21) Appl. No.: 15/765,796

(22) PCT Filed: Nov. 1, 2016
(86) PCT No.: PCT/JP2016/082403

§ 371 Date: Apr. 4, 2018

(30) Foreign Application Priority Data
Nov. 19, 2015 (JP) 2015-227100

(51) Int. Cl. C09K 19/30; C09K 19/58; C09K 19/54; G02F 1/137

(52) U.S. Cl. CPC C09K 19/3066; C09K 19/3003; C09K 19/586; C09K 19/542; G02F 1/137; G02F 2001/13712; C09K 2019/3009; C09K 2019/301; C09K 2019/3016; C09K 2019/548; C09K 2019/3004

(57) ABSTRACT

The liquid crystal composition is designed to improve light transmittance using an elastic constant and has a negative value of dielectric anisotropy (Δε), a liquid crystal display element using the liquid crystal composition, and the liquid crystal display. The liquid crystal composition has a negative value of dielectric anisotropy (Δε) and a value of Γ of 0.28 or less. The value of Γ is obtained from Equation (2) using a twist elastic constant (K₂₂) value obtained from Equation (1) using measured values of dielectric anisotropy (Δε), a threshold voltage (Vth), a bend elastic constant (K₃₃), vacuum permittivity (ε₀), a cell gap (d), and a helical pitch (P₀) and measured values of a splay elastic constant (K₁₁) and the bend elastic constant (K₃₃).

$$\begin{matrix}{V}_{th} = π \sqrt{\{ 1 - 4 {( \frac{{K}_{22}}{{K}_{33} } )}^{2} {( \frac{d}{{P}_{0}} )}^{2} \} \frac{{K}_{33}}{\vert {ɛ}_{0} Δ ɛ \vert}} & ( 1 ) \\ Γ = \frac{{K}_{22}}{{K}_{11} + {K}_{33}} & ( 2 )\end{matrix}$$

### TECHNICAL FIELD

The present invention relates to a liquid crystal composition, a liquid crystal display element using the liquid crystal composition, and a liquid crystal display including the liquid crystal display element.

### BACKGROUND ART

In the liquid crystal display element, a liquid crystal layer is sandwiched between a pair of substrates, and the liquid crystal layer contains a liquid crystal composition. Such liquid crystal display element is widely used in image display devices such as a liquid crystal television, a monitor for a computer, a mobile phone, an information terminal, and a game machine.

Representative examples of a display method of the liquid crystal display element include a twisted nematic (TN) type, a super twisted nematic (STN) type, an electrically controlled birefringence (ECB) type, and the like. Examples of an active matrix type liquid crystal display element using a thin-film transistor (TFT) include a VA type in which liquid crystal molecules are vertically aligned and an in-plane switching (IPS) type in which liquid crystal molecules are horizontally aligned or a fringe field switching (FFS) type, which is a kind of the in-plane switching (IPS) type.

In these liquid crystal display elements, a nematic liquid crystal is used, and a liquid crystal composition whose dielectric anisotropy (Δε) is positive or negative is used according to the kind of the element.

Meanwhile, investigation has been conducted on optimizing the liquid crystal composition by simulating the characteristics of the liquid crystal composition in a desired display mode using an elastic constant peculiar to the liquid crystal composition. It has been expected that, by adopting such method, an n-type liquid crystal composition can be developed with high efficiency. The behavior of the liquid crystal molecules can be described as three modes: splay, twist, and bend, depending on the external electric field. As for the elastic constant, there are a splay elastic constant (hereinafter, may be referred to as “K₁₁”), a twist elastic constant (hereinafter, may be referred to as “K₂₂”), and a bend elastic constant (hereinafter, may be referred to as “K₃₃”), corresponding to these modes.

As a method for optimizing the characteristics of the liquid crystal composition using K₁₁, K₂₂, and K₃₃, for example, a method of preventing disarray of the arrangement of liquid crystal molecules (disclination) in the center portion of a pixel electrode or between the pixel electrodes by selecting a liquid crystal composition satisfying relational expressions of K₃₃/K₁₁≥1.5 and 1.7≤(K₃₃/K₂₂−K₃₃/K₁₁)≤2.7 and having an average transmittance of equal to or greater than 0.6 as the liquid crystal composition to be used in an IPS type or an FFS type liquid crystal display element, thereby enabling high definition display in a liquid crystal display element has been disclosed (refer to PTL 1). It is disclosed that, according to this method, the average light transmittance of the liquid crystal composition is improved by preventing disclination.

However, in PTL 1, there is no description regarding an n-type liquid crystal composition, and the method described in PTL 1 is not intended for an n-type liquid crystal composition. Furthermore, description was not made regarding improving light transmittance in PTL 1, and a method for measuring K₁₁, K₂₂, and K₃₃ of the n-type liquid crystal composition is not disclosed in PTL 1 in the first place. Thus, validity of the measured values cannot be verified.

### CITATION LIST

### Patent Literature

[PTL 1] Japanese Patent 4556341

### SUMMARY OF INVENTION

### Technical Problem

The present invention has been made in view of the circumstances, and an object of the present invention is to provide a liquid crystal composition which is designed to improve light transmittance using an elastic constant and has a negative value of dielectric anisotropy (Δε), a liquid crystal display element using the liquid crystal composition, and a liquid crystal display including the liquid crystal display element.

### Solution to Problem

The present invention provides a liquid crystal composition which has a negative value of dielectric anisotropy (Δε) and a value of Γ of 0.28 or less, in which the value of Γ is obtained from the following Equation (2) using a twist elastic constant (K₂₂) value obtained from the following Equation (1) using measured values of dielectric anisotropy (Δε); a threshold voltage (Vth); a bend elastic constant (K₃₃); vacuum permittivity (ε₀); a cell gap (d); and a helical pitch (P₀), and measured values of a splay elastic constant (K₁₁) and the bend elastic constant (K₃₃).

$$\begin{matrix}[ Math . 1 ] & \\ {V}_{th} = π \sqrt{\{ 1 - 4 {( \frac{{K}_{22}}{{K}_{33} } )}^{2} {( \frac{d}{{P}_{0}} )}^{2} \} \frac{{K}_{33}}{\vert {ɛ}_{0} Δ ɛ \vert}} & ( 1 ) \\ Γ = \frac{{K}_{22}}{{K}_{11} + {K}_{33}} & ( 2 )\end{matrix}$$

In addition, the present invention provides a liquid crystal display element using the liquid crystal composition.

Furthermore, the present invention provides a liquid crystal display including the liquid crystal display element.

### Advantageous Effects of Invention

According to the present invention, a liquid crystal composition which is designed to improve light transmittance using an elastic constant and has a negative value of dielectric anisotropy (Δε), a liquid crystal display element using the liquid crystal composition, and a liquid crystal display including the liquid crystal display element are provided.

### BRIEF DESCRIPTION OF DRAWINGS

FIG. 1 is a cross-sectional view schematically showing main parts of one embodiment of a cell used in the present invention.

FIG. 2 is a schematic view showing one embodiment of an elastic constant measurement device in the present invention.

FIG. 3 is a cross-sectional view schematically showing main parts of one embodiment of a cell used in a liquid crystal display element of the present invention.

FIG. 4 is a cross-sectional view schematically showing main parts of another embodiment of the cell used in the liquid crystal display element of the present invention.

FIG. 5 is a schematic view showing one embodiment of the liquid crystal display element of the present invention.

FIG. 6 is an enlarged plan view of the liquid crystal display element shown in FIG. 5.

FIG. 7 is a cross-sectional view obtained by cutting the liquid crystal display element shown in FIG. 6.

### DESCRIPTION OF EMBODIMENTS

### <<Liquid Crystal Composition>>

A liquid crystal composition of the present invention is a liquid crystal composition having a negative value of dielectric anisotropy (Δε) and a value of Γ of 0.28 or less, in which the value of Γ is obtained from Equation (2) using a twist elastic constant (K₂₂) value obtained from Equation (1) using measured values of dielectric anisotropy (Δε); a threshold voltage (Vth); a bend elastic constant (K₃₃); vacuum permittivity (ε₀); a cell gap (d); and a helical pitch (P₀), and measured values of a splay elastic constant (K₁₁) and the bend elastic constant (K₃₃).

$$\begin{matrix}[ Math . 2 ] & \\ {V}_{th} = π \sqrt{\{ 1 - 4 {( \frac{{K}_{22}}{{K}_{33} } )}^{2} {( \frac{d}{{P}_{0}} )}^{2} \} \frac{{K}_{33}}{\vert {ɛ}_{0} Δ ɛ \vert}} & ( 1 ) \\ Γ = \frac{{K}_{22}}{{K}_{11} + {K}_{33}} & ( 2 )\end{matrix}$$

The liquid crystal composition satisfying the specific condition of the Γ value obtained from Equation (2) being 0.28 or less exhibits high light transmittance (hereinafter, may be simply referred to as “transmittance”) in a liquid crystal display element of a type which is driven by an electric field (horizontal electric field) having a component in a direction parallel to the surfaces of the substrates that interposes the liquid crystal composition therebetween, the element being driven in the same direction. The liquid crystal display element using such liquid crystal composition has excellent characteristics. Thus, the liquid crystal composition of the present invention is designed to have excellent transmittance by using the splay elastic constant (K₁₁), the twist elastic constant (K₂₂), and the bend elastic constant (K₃₃).

In Equation (2), K₂₂ of the liquid crystal composition having a negative value of dielectric anisotropy (Δε) is obtained from Equation (1) using the measured values of a threshold voltage (Vth), a bend elastic constant (K₃₃), a cell gap (d), and a helical pitch (P₀).

The liquid crystal composition of the present invention is an n-type liquid crystal composition.

A method for obtaining K₂₂ of an n-type liquid crystal composition by using Equation (1) (a method for measuring K₂₂) is a novel method that has not been known in the related art. A method for measuring K₂₂ of a p-type liquid crystal composition has been disclosed in U.S. Pat. No. 8,168,083 so far, however, this method cannot be directly applied to an n-type liquid crystal composition. Although a method for measuring K₂₂ of an n-type liquid crystal composition has been disclosed in JP-A-8-178883 so far, the method for measuring K₂₂ in the present invention is extremely excellent from the viewpoint that K₂₂ can be measured with higher accuracy than in the aforementioned method. First, the method for measuring K₂₂ in the present invention will be described below.

In a cell including electrodes and two (a pair of) substrates that face each other, a twist elastic constant (K₂₂) is obtained from Equation (1) by, for example, measuring an electrostatic capacity (C) of the cell filled with a liquid crystal composition serving as an object for measuring K₂₂, in a state in which the liquid crystal composition is interposed in the cell, and a voltage is applied between the electrodes, measuring a threshold voltage (Vth) from the electrostatic capacity (C), and using the threshold voltage (Vth), a helical pitch (P₀), a bend elastic constant (K₃₃), vacuum permittivity (ε₀), and dielectric anisotropy (Δε) of the liquid crystal composition, and cell gap (d) of the cell.

Among the parameters in Equation (1), the dielectric anisotropy (Δε) can be measured using a known method. That is, relative permittivity ε_{∥} in a long axis direction of a liquid crystal molecule is measured by enclosing the liquid crystal composition to be measured in a cell subjected to a vertical alignment treatment, and relative permittivity ε_{⊥} in a short axis direction of the liquid crystal molecule is measured by enclosing the liquid crystal composition to be measured in a cell subjected to a horizontal alignment treatment. Using the difference in these measured values, the dielectric anisotropy (Δε) can be obtained (Δε=|ε_{∥}−ε_{⊥}|). Among the parameters in Equation (1), ε₀ represents vacuum permittivity.

The parameters in Equation (1) other than the dielectric anisotropy (Δε) are obtained using a cell having a specific cell gap (d). Here, the cell used to obtain these parameters may be the same as or different from the cell included in the desired liquid crystal display element.

The cell which is used when obtaining K₂₂ using Equation (1) will be described below.

As the two substrates of the cell, substrates formed of glass or a transparent insulating material having flexibility such as plastic can be used, or substrates formed of a non-transparent insulating material such as silicon may also be used. A transparent substrate having a transparent electrode is obtained by, for example, sputtering indium tin oxide (ITO) on a transparent substrate such as a glass plate.

The substrates oppose each other such that the transparent electrode is disposed on the inner side. In this case, the space between the substrates may be adjusted through a spacer. At this time, it is preferable that a thickness of a light control layer (a liquid crystal layer containing the liquid crystal composition) thus obtained is adjusted to 1 to 100 μm, and it is more preferable that the thickness is adjusted to 1.5 to 10 μm. In the case of using a polarizing plate, it is preferable that the product of refractive index anisotropy (Δn) of a liquid crystal and a cell gap (d) is adjusted such that the contrast becomes maximum. Examples of the spacer include glass particles, plastic particles, alumina particles, a column spacer formed of a photoresist material, and the like. Thereafter, a sealing agent such as an epoxy-based thermally curable composition is screen printed on the substrate in a form in which a liquid crystal inlet is provided, and the substrates are bonded to each other and heated, so as to thermally cure the sealing agent.

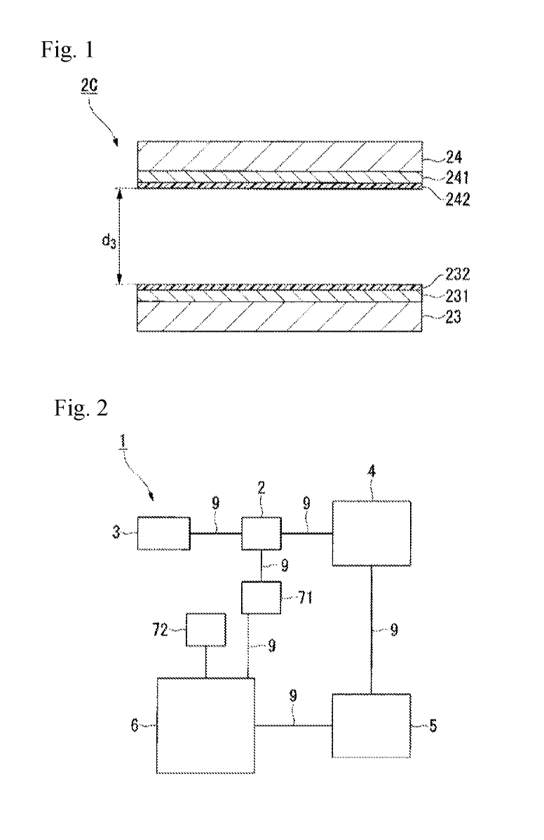

FIG. 1 is a cross-sectional view schematically showing main parts of one embodiment of the cell.

A cell 2C shown in the figure includes a pair of substrates: a first substrate 23 and a second substrate 24. On the surface of the first substrate 23 opposing (facing) the second substrate 24, a first electrode 231 and a first alignment film 232 are laminated in this order toward the second substrate 24. In addition, on the surface of the second substrate 24 opposing (facing) the first substrate 23, a second electrode 241 and a second alignment film 242 are laminated in this order toward the first substrate 23. The cell 2C is configured such that the liquid crystal composition is interposed between the first substrate 23 and the second substrate 24. The first alignment film 232 and the second alignment film 242 control the alignment state of the liquid crystal composition interposed between the substrates.

In FIG. 1, the reference sign d₃ represents a cell gap in the cell 2C.

The cell 2C is a cell used in a VA-type liquid crystal display element, and in the method for measuring an elastic constant in the present invention, such cell can be suitably used.

The cell shown in FIG. 1 is merely an example of a part of a cell that can be used in the present invention, and the cell that can be used in the present invention is not limited thereto. For example, in the present invention, the cell can be used by being modified in various ways within a scope that does not depart from the gist of the present invention.

Among the parameters in Equation (1), the threshold voltage (Vth) can be measured according to the following method.

That is, the electrostatic capacity (C) of the cell filled with the liquid crystal composition to be measured is measured in a state in which the liquid crystal composition is enclosed in the cell to interpose the liquid crystal composition between the electrodes, and an arbitrary voltage is applied between the electrodes. At this time, a relationship between the voltage and the electrostatic capacity (C) can be confirmed by changing the applied voltage and measuring the electrostatic capacities (C) at each voltage, and, in the course of increasing the voltage, there is a moment at which the electrostatic capacity (C) drastically increases in an almost or completely constant manner. The voltage at this moment is designated as the threshold voltage (Vth). A method for measuring the threshold voltage (Vth) is as described above.

Among the parameters in Equation (1), K₃₃ may be obtained by setting P₀ infinite, that is, by preparing a liquid crystal composition that does not contain a chiral compound as the liquid crystal composition to be measured and applying Equation (1) for the liquid crystal composition. The liquid crystal composition used for obtaining K₃₃ at this time may be a liquid crystal composition having the same composition as the liquid crystal composition to be measured for K₂₂ except that the composition does not contain a chiral compound. In the case where P₀ is infinite, Equation (1) is expressed as Vth=π(K₃₃/Δε)^{1/2}, since d/P₀ becomes 0. Since both Vth and Δε can be experimentally calculated as described above, K₃₃ is obtained by substituting these values in the approximate equation of Equation (1).

Therefore, the method for obtaining K₃₃ in the present invention is completely different from the method for obtaining K₃₃ described in JP-A-8-178883, in which K₃₃ is obtained by solving a binary simultaneous equation, and according to the method for obtaining K₃₃ in the present invention, K₃₃ is obtained with higher accuracy than in the case of obtaining K₃₃ according to the method in JP-A-8-178883.

Among the parameters in Equation (1), the helical pitch (P₀) and the cell gap (d) are known values. For example, d₃ in FIG. 1 is an example of the cell gap (d).

The dielectric anisotropy (Δε) of the liquid crystal composition in the present invention is negative, as described above, and is preferably −10 or more and less than −1.5, more preferably −8 or more and less than −1.5, even more preferably −6 to −1.8, and particularly preferably −5 to −2. In the case where the dielectric anisotropy (Δε) of the liquid crystal composition is smaller than the lower limit value, the liquid crystal composition responds to the change in the voltage applied for driving the liquid crystal composition with extreme sensitivity, and thus, gradation display becomes difficult. In the case where the dielectric anisotropy (Δε) of the liquid crystal composition is greater than the upper limit value, the driving voltage increases, and it becomes impossible to respond to the demand for power saving. In general, a driving voltage of the liquid crystal display element of 5 V to 6 V is suitable for the gradation display and the demand for power saving, however, the driving voltage is not limited to this range.

In the present invention, the liquid crystal composition to be measured is required to be subjected to twist alignment such that the composition has a specific helical pitch (P₀). It is preferable that the liquid crystal composition is subjected to twist alignment by, for example, adding a chiral compound to the liquid crystal composition and applying a voltage between the electrodes. The chiral compound will be described in detail later.

Through the procedures, among the parameters in Equation (1), Vth, Δε, and K₃₃ can be obtained. In addition, P₀ and d are known values. Therefore, K₂₂ becomes the only parameter in Equation (1) that is not defined. Thus, by substituting these five parameters in Equation (1), K₂₂ can be obtained.

Therefore, the method for obtaining K₂₂ according to the present invention is completely different from the method for obtaining K₂₂ as described in JP-A-8-178883, in which K₂₂ is obtained by solving a binary simultaneous equation, and according to the method for obtaining K₂₂ in the present invention, K₂₂ is obtained with higher accuracy than in the case of obtaining K₂₂ according to the method in JP-A-8-178883.

In the present invention, for example, threshold voltages (Vth) are measured by the method under the condition of varying d/P₀ values, and from the measured values of the obtained plurality of threshold voltages (Vth) and the corresponding plurality of d/P₀ values, a function can be derived, which uses Vth and d/P₀ as the variables, by performing regression calculation.

In order to cause the d/P₀ values to be varied, any one of d and P₀ may be varied, however, as will be described in Examples, in the case where the threshold voltage (Vth) is measured by varying P₀ while maintaining d constant, the accuracy of the function is higher than in the case where the threshold voltage (Vth) is measured by varying d while maintaining P₀ constant. In other words, error between the threshold voltage (Vth) calculated from the function derived by varying P₀ while maintaining d constant and the actual measurement value of the threshold voltage (Vth) is extremely small. Thus, when obtaining K₂₂ of the desired liquid crystal composition after obtaining K₃₃ from the threshold voltage (Vth) by the method, K₂₂ is obtained with high accuracy by setting d the same as in the case of obtaining K₃₃ and varying P₀ to obtain K₂₂.

In the present invention, the expression of the “cell gap (d) being constant” means that the cell gaps (d) are exactly the same as each other, or the difference in the cell gaps (d) is sufficiently negligibly small. For example, the difference in the cell gaps (d) is 0 to 1.2 μm.

In the present invention, the expression of the “helical pitch (P₀) being constant” means that the helical pitches (P₀) are exactly the same as each other, or the difference in the helical pitches (P₀) is sufficiently negligibly small. For example, the difference in the helical pitches (P₀) is 0 to 0.6 μm.

In order to measure the threshold voltage (Vth) by varying P₀, plural kinds of liquid crystal compositions having different P₀'s need to be used. As the plural kinds of liquid crystal compositions having different P₀'s, two or more kinds of liquid crystal compositions which contain one or two or more kinds of chiral compounds and which are different in the total contents of the chiral compounds or two or more kinds of liquid crystal compositions which contain chiral compounds having different helical twisting power are preferably used, and two or more kinds of liquid crystal compositions which contain chiral compounds having different helical twisting power and in which the contents of these chiral compounds are the same as each other are more preferably used. The accuracy in measuring K₂₂ is further improved by using such plural kinds of liquid crystal compositions. In general, in the case where the chiral compounds having different helical twisting power are used, different kinds of chiral compounds may be used. The helical twisting power will be described in detail later.

In the present invention, the cell gap (d) of the cell is preferably 3 to 200 μm, more preferably 3 to 150 μm, even more preferably 3.1 to 120 μm, still more preferably 3.2 to 100 μm, still more preferably 3.3 to 90 μm, still more preferably 3.4 to 80 μm, and still more preferably 3.5 to 70 μm when measuring K₂₂ and K₃₃. By setting the cell gap (d) to be equal to or greater than the lower limit value, the proportion of liquid crystal molecules farther away from the substrates becomes higher among the liquid crystal molecules interposed between the pair of substrates, and the proportion of liquid crystal molecules which receive a strong force that allows the molecules to be aligned in a direction vertical to the surface of the substrates, caused by the effect of the substrates subjected to an alignment treatment, becomes lower, thus further improving the accuracy in measuring K₂₂, which allows, for example, the threshold voltage (Vth) to be measured with higher accuracy. In addition, by setting the cell gap (d) to be equal to or less than the upper limit value, the effect of suppressing variation in the cell gaps (d) becomes higher in the entire regions of the substrates that determine the cell gap (d), thereby increasing uniformity in the cell gaps (d) of the cell.

The “cell gap (d)” in the present invention is obtained by the method described below.

The size of the cell gap (d) in the cell is preferably adjustable to a desired value. By using such cell and adjusting the size of the cell gap (d) to a desired size to perform measurement, it is not necessary to prepare plural kinds of cells. Furthermore, the measurement of an elastic constant such as K₂₂ and K₃₃ or the measurement of other parameters such as Vth required for the measurement of an elastic constant can be performed without replacing cells, and the method for measuring an elastic constant in the present invention can be simplified.

In the cell in which the size of the cell gap (d) can be adjusted, for example, only one substrate among the pair of (two) substrates may be adjustable to change the size of the cell gap (d), or both substrates may be adjustable to change the size of the cell gap (d) together.

Examples of a method for adjusting the substrate such that the size of the cell gap (d) changes include a method in which the position where one or both of the pair of substrates are disposed in the cell is changed in a direction orthogonal to the surfaces of these substrates. One method may be applied alone, or two or more methods may be used in combination.

In order to change the positions where the substrates are disposed in the cell, a cell including the substrates provided with an actuator including a piezoelectric element or the like may be used, and the substrates may be moved in the cell by driving the actuator.

Examples of a method for obtaining the cell gap (d) are not particularly limited, however, as shown below, from the viewpoint of conveniently obtaining the cell gap with high accuracy, a method for obtaining the cell gap by measuring an electrostatic capacity (C₀) of the cell when the cell filled with the liquid crystal composition is placed in the air, a method for obtaining the cell gap (d) by observing interfering light generated when the cell filled with the liquid crystal composition is irradiated with light, and the like can be used.

The method for obtaining the cell gap (d) by measuring the electrostatic capacity (C₀) is as follows.

The electrostatic capacity (C₀) is an electrostatic capacity of the cell in the case of applying a voltage sufficiently lower than the threshold voltage, when the cell filled with the liquid crystal composition is placed in the air. Here, the “voltage sufficiently lower than the threshold voltage” is, for example, approximately a voltage equal to or higher than the voltage (V) obtained by multiplying the threshold voltage by 0.1 and equal to or lower than the voltage (V) obtained by multiplying the threshold voltage by 0.9. As is well known, the cell gap (d) has a relationship represented by the following equation, along with the electrostatic capacity (C₀), the relative permittivity (ε_{∥}) of the liquid crystal composition in the cell, the vacuum permittivity (ε₀), and an electrode area (S) of the cell. Here, since ε_{∥}, ε₀, and S are known values, the cell gap (d) is obtained by measuring C₀.

C₀=ε_{∥}·ε₀·S/d

Meanwhile, examples of the method for obtaining the cell gap (d) by observing the interfering light include a method which is the same as the case of measurement by a rotating analyzer method using He—Ne laser light, based on the methods described in “T. J. Scheffer et. al., J. Appl. Phys. vol 48, p. 1783 (1977)” and “F. Nakano, et. al., JPN. J. Appl. Phys. vol. 19, p. 2013 (1980)”.

A method for measuring a twist elastic constant (K₂₂) for an n-type liquid crystal composition with good accuracy was not available in the related art; however, according to the method for measuring an elastic constant in the present invention, the twist elastic constant (K₂₂) can be measured with high accuracy, and through this measurement process, the bend elastic constant (K₃₃) and the threshold voltage (Vth) can also be measured with high accuracy.

Examples of a device for measuring an elastic constant of the liquid crystal composition (hereinafter, may be simply abbreviated as a “measurement device”) used when measuring the elastic constant of the liquid crystal composition include a device including a cell having electrodes and two facing substrates for interposing the liquid crystal composition serving as an object for measuring the twist elastic constant (K₂₂), a voltage application means for applying an arbitrary voltage between the electrodes, a measurement means for measuring an electrostatic capacity (C) of the cell filled with the liquid crystal composition in the state of applying a voltage between the electrodes, a means for measuring a threshold voltage (Vth) from the electrostatic capacity (C) measured by the measurement means, and an elastic constant determination means for determining the twist elastic constant (K₂₂) of the liquid crystal composition using Equation (1), by input of the helical pitch (P₀), the bend elastic constant (K₃₃), the vacuum permittivity (ε₀), and the dielectric anisotropy (Δε) of the liquid crystal composition and the cell gap (d) of the cell.

The cell in the elastic constant measurement device is the same as the cell described for the method for measuring an elastic constant.

The voltage application means may be a known means that applies a voltage between the electrodes in the cell in the liquid crystal display element.

The measurement means may be a known means that can measure an electrostatic capacity when applying a voltage between the electrodes.

The voltage application means and the measurement means are generally electrically connected to the cell.

Examples of the means for measuring a threshold voltage (Vth) from the electrostatic capacity (C) measured by the measurement means (hereinafter, may be abbreviated as a “threshold voltage measurement means”) include a means that can detect a change in the electrostatic capacity (C) when changing the voltage applied between the electrodes in the voltage application means, and it is preferable that an amount of change in the electrostatic capacity (C) which is equal to or higher than a certain value can be automatically detected. The threshold voltage measurement means may also serve as the measurement means.

The elastic constant determination means determines K₂₂ of the liquid crystal composition using Equation (I) based on the input values of the helical pitch (P₀), the bend elastic constant (K₃₃), the vacuum permittivity (ε₀), and the dielectric anisotropy (Δε) of the liquid crystal composition and the cell gap (d) of the cell, and as such means, for example, an arithmetic unit such as a computer can be used.

The elastic constant measurement device may include, as a means for measuring dielectric anisotropy (Δε) of the liquid crystal composition, a means for measuring relative permittivity ε_{∥} of the liquid crystal composition, a means for measuring relative permittivity ε_{⊥} of the liquid crystal composition, and a means for calculating dielectric anisotropy (Δε) based on the relative permittivity ε_{∥} and the relative permittivity ε_{⊥}.

Examples of the means for measuring relative permittivity ε_{∥} include a means which has a cell that has been subjected to a vertical alignment treatment and an LCR meter electrically connected to the cell.

Examples of the means for measuring relative permittivity ε_{⊥} include a means which has a cell that has been subjected to a horizontal alignment treatment and an LCR meter electrically connected to the cell.

The means for calculating dielectric anisotropy (Δε) is, for example, a means for calculating Δε of the liquid crystal composition by using the equation “Δε=|ε_{∥}−ε_{⊥}|”, based on the input values of the relative permittivity ε_{∥} and the relative permittivity ε_{⊥}, and as such means, for example, an arithmetic unit such as a computer can be used. Among the parameters in Equation (1), ε₀ represents vacuum permittivity.

The elastic constant measurement device may include a means for measuring a cell gap (d).

Examples of the means for measuring a cell gap (d) include a means having a light source causing light to be incident on the cell, a measuring instrument for measuring a pitch of interference fringe of interfering light, and a unit for calculating a cell gap (d) in consideration of wavelength dispersion of refractive index of the liquid crystal composition, based on the input measured value of the pitch of the interference fringe.

Examples of the means for measuring a cell gap (d) include a means including a unit for measuring an electrostatic capacity (C₀) of the cell, and a unit for calculating a cell gap (d) by using the equation “C₀=ε_{∥}·ε₀·S/d”, based on the input values of the relative permittivity (ε_{∥}) and the vacuum permittivity (ε₀) of the liquid crystal composition, the electrode area (S) of the cell, and the electrostatic capacity (C₀) of the cell.

As the unit for calculating a cell gap (d) based on the input measured value of the pitch of the interference fringe and the unit for calculating a cell gap (d) based on the input values of the relative permittivity (ε_{∥}) and the vacuum permittivity (ε₀) of the liquid crystal composition, the electrode area (S) of the cell, and the electrostatic capacity (C₀) of the cell, an arithmetic unit such as a computer can be used.

One embodiment of the elastic constant measurement device is schematically shown in FIG. 2. A measurement device 1 shown here includes a cell 2, a voltage application means 3, a measurement means 4, a threshold voltage measurement means 5, and an elastic constant determination means 6. In FIG. 2, a reference sign 9 represents a wiring.

As the cell 2 in the measurement device 1, for example, the cell 2C shown in FIG. 1 can be used.

In the measurement device 1, the voltage application means 3 and the measurement means 4 are electrically connected to the cell 2, and the threshold voltage measurement means 5 is electrically connected to the measurement means 4 and the elastic constant determination means 6. By having such configuration, for example, the device can set information regarding the electrostatic capacity (C) measured by the measurement means 4 to be automatically transmitted to the threshold voltage measurement means 5, and the threshold voltage (Vth) to be automatically obtained in the threshold voltage measurement means 5.

In the case where the measurement device 1 includes a means 71 for measuring a cell gap (d), it is preferable that the means 71 for measuring a cell gap (d) is electrically connected to the cell 2 and is set to be able to automatically measure the cell gap (d), and it is more preferable that the means 71 for measuring a cell gap (d) is electrically connected to the elastic constant determination means 6 and is set to be able to automatically input a measured value of the cell gap (d) to the elastic constant determination means 6.

In the case where the measurement device 1 includes a means 72 for calculating dielectric anisotropy (Δε), it is preferable that the means 72 for calculating dielectric anisotropy (Δε) is electrically connected to the elastic constant determination means 6 and is set to be able to automatically input a measured (calculated) value of the dielectric anisotropy (Δε) to the elastic constant determination means 6.

The measurement device 1 is merely an example of a measurement device that can be used in the present invention. The elastic constant measurement device used in the present invention is not limited to this example and can be modified in various ways within a scope that does not depart from the gist of the present invention.

K₁₁ is obtained using a measurement method known in the related art.

For example, in the case where a high voltage (V) is applied between the electrodes, K₁₁ is obtained from the electrostatic capacity (C) of the cell filled with the liquid crystal composition. In a liquid crystal cell in a state in which a voltage is not applied between the electrodes, liquid crystal molecules are vertically aligned. It is known that Equation (3) is established in the case of considering the fact that, in the case where a director tilt angle (ϕ) of the vertically aligned liquid crystal molecules with respect to the substrate is set to 0, and a high voltage (V) is applied between the electrodes, a director tilt angle (ϕm) of the liquid crystal molecules in the center of the cell in a thickness direction approaches π/2 rad, and in the case where the electrostatic capacity of the cell filled with the liquid crystal composition at the time of applying a voltage that is sufficiently lower than the threshold voltage (Vth) in particular is designated as C_{∥}. Here, a and γ in Equation (3) are respectively represented by Equations (31) and (33), and κ in Equation (31) is represented by Equation (32). Here, the “voltage that is sufficiently lower than the threshold voltage” is as described above.

$$\begin{matrix}[ Math . 3 ] & \\ \frac{C - {C}_{//}}{{C}_{//}} = γ \cdot \{ 1 - a \cdot \frac{Vth}{V} \} & ( 3 ) \\ a = \frac{2}{π} \cdot {( 1 + γ )}^{\frac{1}{2}} \cdot {\int }_{0}^{1} {\{ \frac{( 1 + κ \cdot {x}^{2} )}{( 1 + γ \cdot {x}^{2} )} \}}^{\frac{1}{2}} dx & ( 31 ) \\ κ = \frac{{K}_{11}}{{K}_{33}} - 1 & ( 32 ) \\ γ = \frac{{ɛ}_{⊥}}{{ɛ}_{//}} - 1 & ( 33 )\end{matrix}$$

Here, a and γ are constants, and, as has become clear in Equation (3), a linear relationship is established between these variables in the case of plotting on a graph by setting “(C−C_{∥})/C_{∥}” as the vertical axis and “Vth/V” as the horizontal axis. Then, by changing the applied voltage (V) and measuring the electrostatic capacity (C) and by plotting the actual “(C−C_{∥})/C_{∥}” and “Vth/V” on a graph, a linear slope (that is, a rate of an amount of change of “(C−C_{∥})/C_{∥}” with respect to an amount of change of “Vth/V”) can be obtained. Since the value of the slope thus obtained becomes equal to “a·γ” in Equation (3), a is obtained, κ is further obtained from Equation (31), and K₁₁ is obtained from Equation (32).

<Chiral Compound>

The chiral compound may be a known chiral compound, and, for example, may be any one of a compound having an asymmetric atom, a compound having axial asymmetry, a compound having plane asymmetry, and an atropisomer, however, a compound having an asymmetric atom or a compound having axial asymmetry is preferable. In the compound having an asymmetric atom, the asymmetric atom is preferably an asymmetric carbon atom, since an asymmetric carbon atom makes stereoinversion difficult to occur, and a heteroatom may also serve as an asymmetric atom. The asymmetric atom may be introduced into a part of a chain structure, or may be introduced into a part of a ring structure. In the case where a helix-inducing force is required to be particularly strong, a compound having axial asymmetry is preferable.

The chiral compound may or may not have a polymerizable group.

One kind of the chiral compound may be used alone, or two or more kinds thereof may be used in combination.

Examples of the compound having an asymmetric atom include a compound having an asymmetric carbon in a side chain moiety, a compound having an asymmetric carbon in a ring structure moiety, and a compound satisfying both of these cases. Specifically, Examples of the compound having an asymmetric atom include a compound represented by General Formula (Ch-I).

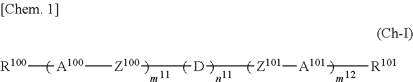

In General Formula (Ch-I), R¹⁰⁰ and R¹⁰¹ each independently represent a hydrogen atom, a cyano group, NO₂, halogen, OCN, SCN, SF₅, a chiral or achiral alkyl group having 1 to 30 carbon atoms, and a chiral group having a polymerizable group or a ring structure; one or two or more CH₂ groups that are not adjacent to each other in the alkyl group may each independently be substituted with —O—, —S—, —NH—, —N(CH₃)—, —CO—, —COO—, —OCO—, —OCO—O—, —S—CO—, —CO—S—, —CH═CH—, —CF₂—, —CF═CH—, —CH═CF—, —CF═CF—, or C≡C—; one or two or more hydrogen atoms in the alkyl group may each independently be substituted with halogen or a cyano group; and the alkyl group may be linear or branched or may have a ring structure.

As the chiral alkyl group substituted with a CH₂ group, Formulas (Ra) to (Rk) are preferable.

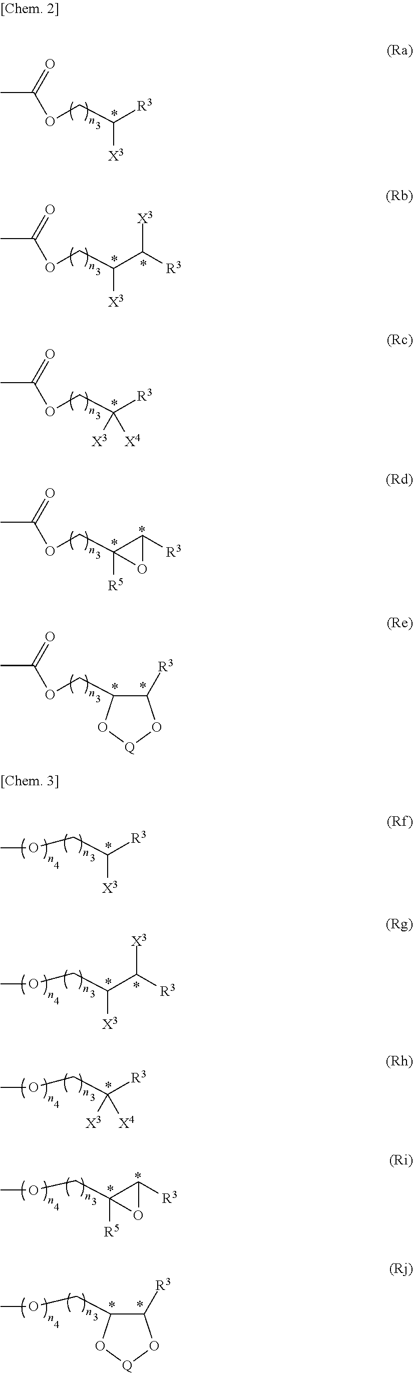

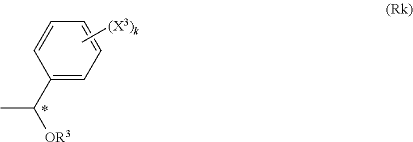

In the formulas, R³ and R⁵ each independently represent a linear or branched alkyl group having 1 to 10 carbon atoms or a hydrogen atom; one or two or more —CH₂— groups in the alkyl group may be substituted with a group in which oxygen atoms or sulfur atoms are not directly bonded to each other, such as —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropylene group, or —Si(CH₃)₂—; one or more hydrogen atoms in the alkyl group may be further substituted with a fluorine atom, a chlorine atom, a bromine atom, or a cyano group; and the alkyl group may have a polymerizable group. As the polymerizable group, structures represented by Formulas (R-1) to (R-15) are preferable.

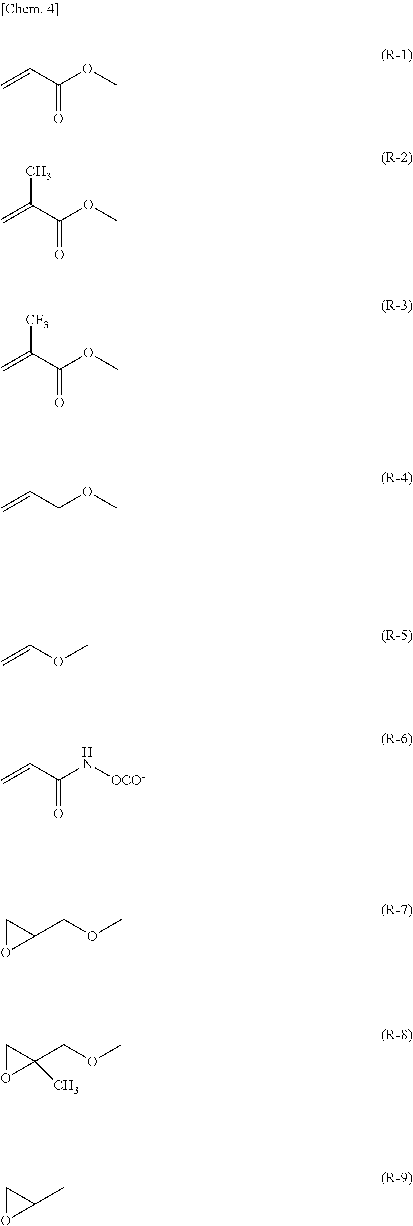

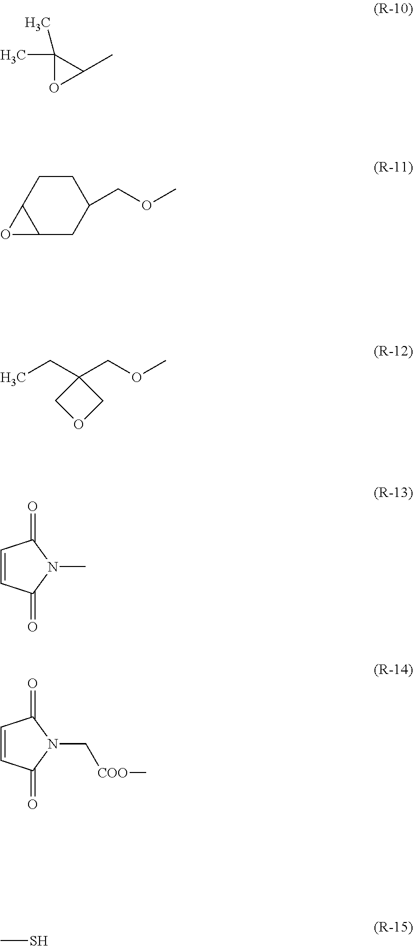

X³ and X⁴ are preferably a halogen atom (F, Cl, Br, or I), a cyano group, a phenyl group (any one or two or more hydrogen atoms in the phenyl group may be substituted with a halogen atom (F, Cl, Br, or I), a methyl group, a methoxy group, —CF₃, or —OCF₃), a methyl group, a methoxy group, —CF₃, or —OCF₃. Here, in order for the positions indicated by asterisks * in General Formulas (Rc) and (Rh) to be asymmetric atoms, different groups are selected as X⁴ and X³.

Furthermore, n₃ is an integer of 0 to 20, and n₄ is 0 or 1,

in General Formulas (Rd) and (Ri), R⁵ is preferably a hydrogen atom or a methyl group,

in General Formulas (Re) and (Rj), examples of Q include a divalent hydrocarbon group such as a methylene group, an isopropylidene group, and a cyclohexylidene group,

in General Formula (Rk), k is an integer of 0 to 5,

and R preferably represents a linear or branched alkyl group having 4 to 8 carbon atoms such as C₄H₉, C₆H₁₃, and C₈H₁₇. In addition, X³ is preferably F, CF₃, or CH₃.

Among these, as the chiral alkyl group substituted with a CH₂ group,

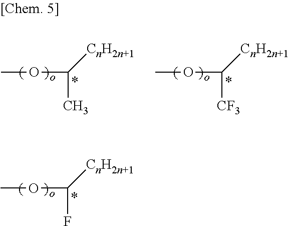

are particularly preferable (in the formulas, o is 0 or 1; n is an integer of 2 to 12, preferably 3 to 8, and more preferably 4, 5, or 6; and the asterisks * represent chiral carbon atoms).

In General Formula (Ch-I), Z¹⁰⁰ and Z¹⁰¹ each independently represent —O—, —S—, —CO—, —COO—, —OCO—, —O—COO—, —CO—N(R^{a})—, —N(R^{a})—CO—, —OCH₂—, —CH₂O—, —SCH—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—COO—, —OCO—CH═CH—, or a single bond; and R^{a} in —CO—N(R′)— or —N(R^{a})—CO— represents a hydrogen atom or a linear or branched alkyl group having 1 to 4 carbon atoms, and preferably represent —CF₂O—, —OCF₂—, —CF₂CF₂—, —CF═CF—, —COO—, —OCO—, —CH₂—CH₂—, —C≡C—, or a single bond.

In General Formula (Ch-I), A¹⁰⁰ and A¹⁰¹ each independently represent (a) a trans-1,4-cyclohexylene group (one —CH₂— or two or more —CH₂-'s that are not adjacent to each other present in the group may each independently be substituted with —O— or —S—), (b) a 1,4-phenylene group (one —CH═ or two or more —CH═'s that are not adjacent to each other present in the group may be substituted with a nitrogen atom), or (c) a group selected from the group consisting of a 1,4-cyclohexenylene group, a 1,4-bicyclo[2.2.2]octylene group, indane-2,5-diyl, a naphthalene-2,6-diyl group, a decahydronaphthalene-2,6-diyl group, and a 1,2,3,4-tetrahydronaphthalene-2,6-diyl group (one —CH₂— or two or more —CH₂-'s that are not adjacent to each other present in the groups of group (c) may each independently be substituted with —O— or —S—, and one —CH═ or two or more —CH═'s that are not adjacent to each other present in the groups of the group (c) may be substituted with a nitrogen atom). All of these groups may be unsubstituted, or may be monosubstituted or polysubstituted with halogen, a cyano group, NO₂, or an alkyl, alkoxy, alkylcarbonyl, or alkoxycarbonyl group having 1 to 7 carbon atoms, in which one or two or more hydrogen atoms may be substituted with F or Cl.

A¹⁰⁰ and A¹⁰¹ preferably represent 1,4-phenylene or trans-1,4-cyclohexylene, and these rings are preferably unsubstituted or substituted with F, Cl, CN, or alkyl, alkoxy, alkylcarbonyl, or alkoxycarbonyl having 1 to 4 carbon atoms at positions 1 to 4.

In General Formula (Ch-I), n¹¹ represents 0 or 1; when n¹¹ is 0, m¹² is 0, and m¹¹ is 0, 1, 2, 3, 4 or 5; when n¹¹ is 1, m¹¹ and m¹² each independently are 0, 1, 2, 3, 4, or 5; and when n¹¹ is 0, at least one of R¹⁰⁰ and R¹⁰¹ is a chiral alkyl group, a polymerizable group, or a chiral group having a ring structure.

When n¹¹ and m¹² are 0, m¹¹ are preferably 1, 2, or 3; and when n¹¹ is 1, m¹¹ and m¹² each independently preferably represent 1, 2, or 3.

D is a preferably a group represented by any one of Formulas (D1) to (D3)

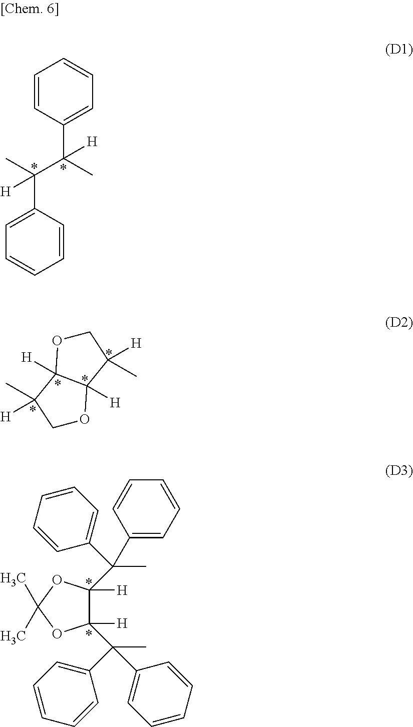

(in the formulas, any one or two or more hydrogen atoms in the benzene ring may be substituted with a halogen atom (F, Cl, Br, or I) or an alkyl group or an alkoxy group having 1 to 20 carbon atoms; any hydrogen atom in the alkyl group or the alkoxy group may be substituted with a fluorine atom; and a methylene group in the alkyl group or the alkoxy group may be substituted with —O—, —S—, —COO—, —OCO—, —CF₂—, —CF═CH—, —CH═CF—, —CF═CF—, or C≡C—, such that oxygen atoms or sulfur atoms are not directly bonded to each other).

In the case where n¹¹ in (A¹⁰⁰-Z¹⁰⁰)m¹¹-(D)n¹¹-(Z¹⁰¹-A¹⁰¹)m¹²-, which is a partial structure in General Formula (Ch-I), is 0, the partial structure is preferably any one of the following structures.

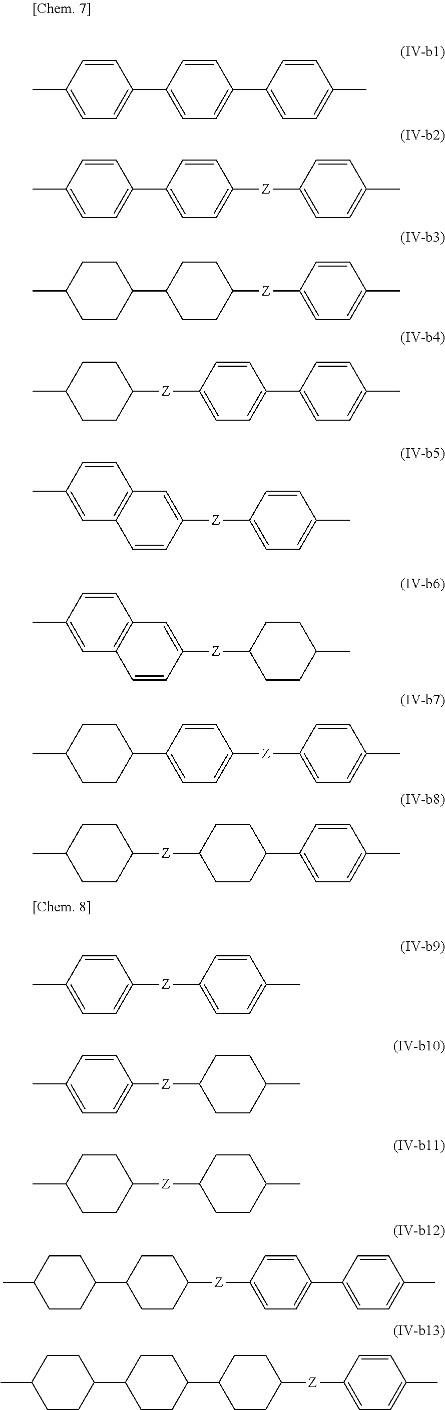

(Here, in these formulas, any one or two or more hydrogen atoms in the benzene ring may be substituted with a halogen atom (F, Cl, Br, or I), a methyl group, a methoxy group, —CF₃, or —OCF₃, any one or two or more carbon atoms in the benzene ring may be substituted with a nitrogen atom, and the introduction of these substituents and a nitrogen atom is preferable, since the introduction thereof controls degradation in crystallinity and direction and size of dielectric anisotropy; and Z has the same definition as those of Z¹⁰⁰ and Z¹⁰¹ in Formula (Ch-I)). In terms of reliability, a benzene ring or a cyclohexane ring is preferred over a hetero ring such as a pyridine ring and a pyrimidine ring. In terms of increasing dielectric anisotropy, a compound having a hetero ring such as a pyridine ring and a pyrimidine ring may be used, and in this case, polarizability of the compound is comparatively great, and crystallinity is decreased, whereby liquid crystallinity is stabilized, which is preferable. In the case of a hydrocarbon ring such as a benzene ring and a cyclohexane ring, the polarizability of the compound is low. Therefore, it is preferable to select an appropriate content in accordance with the polarizability of a chiral compound.

When n¹¹ and m¹² are 0, preferable forms of the compound represented by General Formula (Ch-I) are as follows.

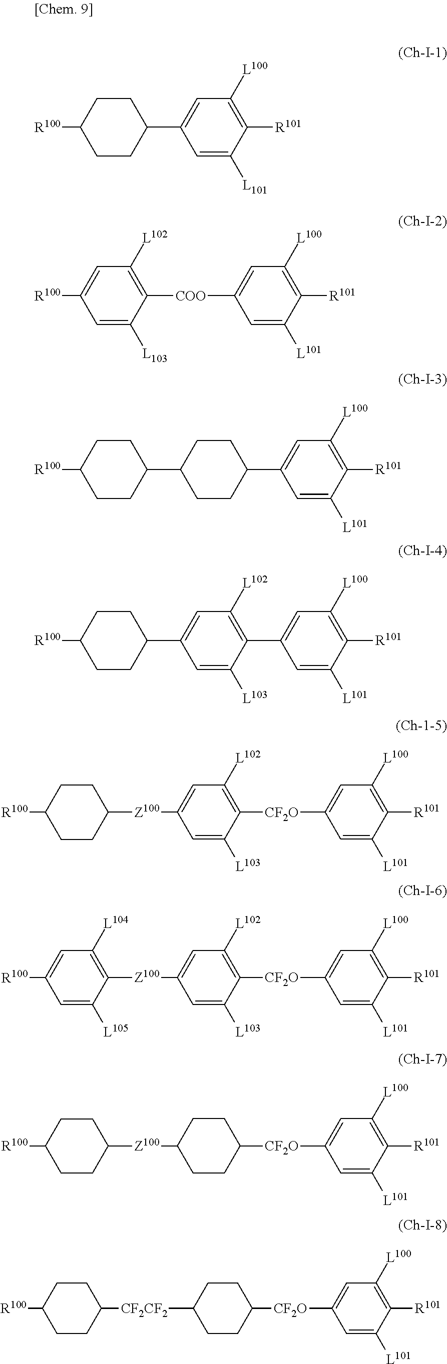

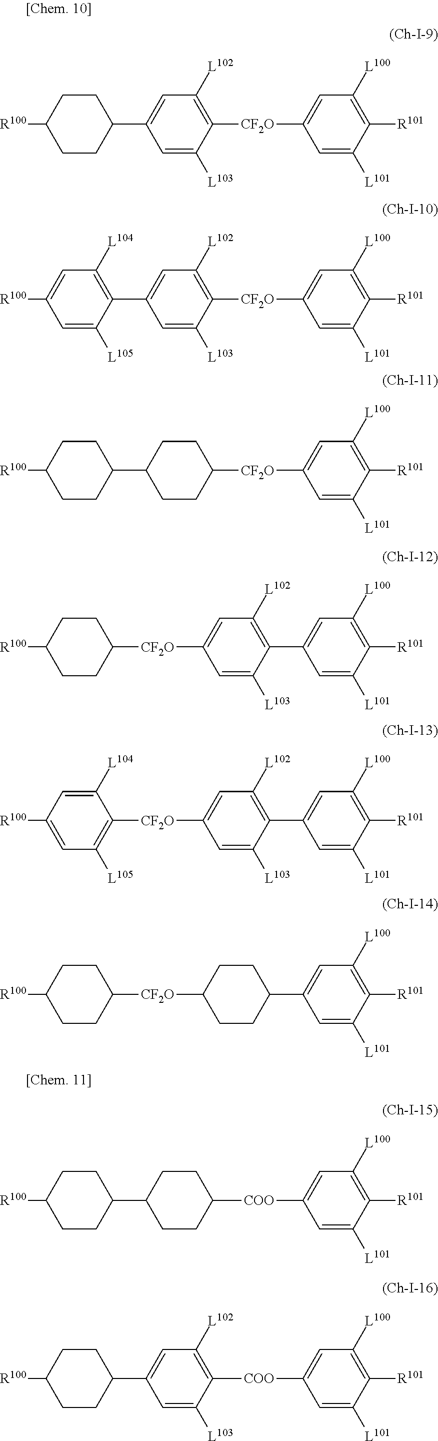

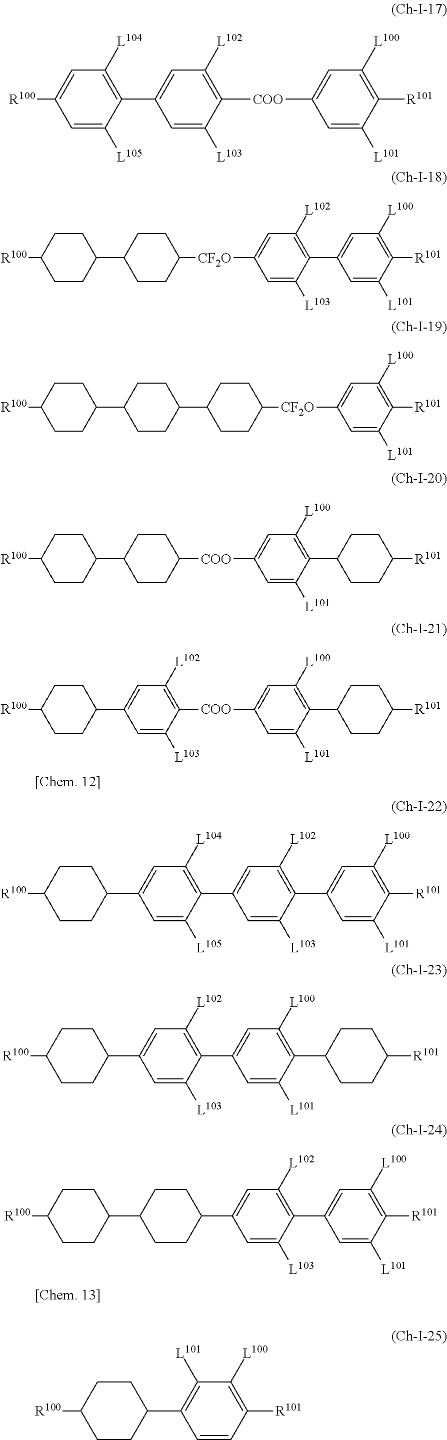

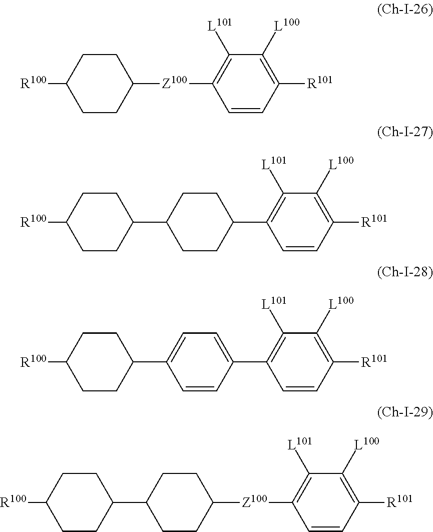

In the formulas, R¹⁰⁰, R¹⁰¹, and Z¹⁰⁰ have the same meaning as those of R¹⁰⁰, R¹⁰¹ and Z¹⁰⁰ in General Formula (Ch-I), at least one of R¹⁰⁰ and R¹⁰¹ represents a chiral group, and L¹⁰⁰ to L¹⁰⁵ each independently represent a hydrogen atom or a fluorine atom.

Among these, the compound represented by General Formula (Ch-I) is preferably a compound represented by the following formula.

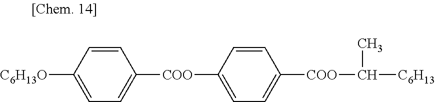

When n¹¹ represents 1, the compound represented by General Formula (Ch-I) has a structure in which the ring structure moiety includes an asymmetric carbon, and the chiral structure D is preferably Formula (D2).

In the case where D represents Formula (D2), the compound represented by General Formula (Ch-I) is specifically preferably a compound represented by any one of Formulas (2D-1) to (2D-8).

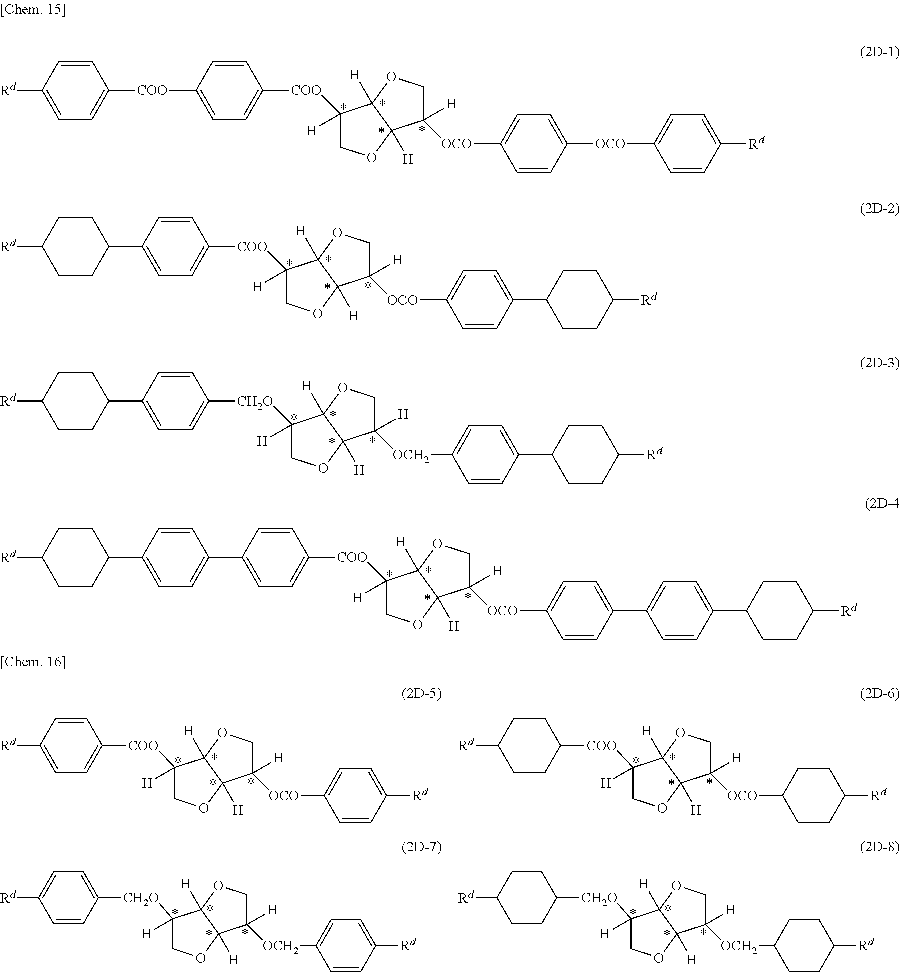

(in the formulas, R^{d}'s are each independently an alkyl having 3 to 10 carbon atoms; —CH₂— in the alkyl adjacent to a ring may be substituted with —O—; and any —CH₂— may be substituted with —CH═CH—).

As the axially asymmetric compound, compounds represented by General Formulas (IV-d4), (IV-d5), (IV-c1), and (IV-c2) are preferable. Here, in the case of General Formulas (IV-d4), (IV-d5), and (IV-c2), the axis of the axial asymmetry is a bond that connects the α positions of two naphthalene rings, and in the case of General Formula (IV-c1), the axis is a single bond that connects two benzene rings.

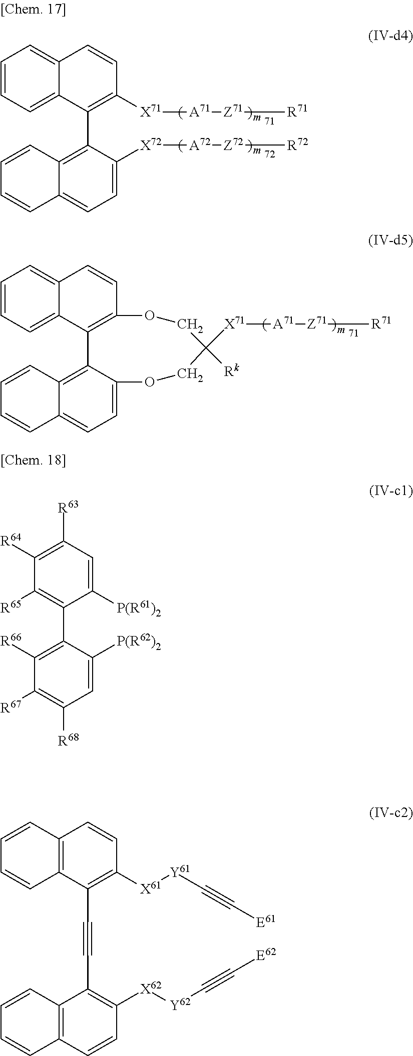

In General Formulas (IV-d4) and (IV-d5), R⁷¹ and R⁷² each independently represent a hydrogen atom, a halogen atom, a cyano (CN) group, an isocyanate (NCO) group, an isothiocynanate (NCS) group, or an alkyl group having 1 to 20 carbon atoms. Any one or two or more —CH₂-'s in the alkyl group may be substituted with —O—, —S—, —COO—, —OCO—, —CH═CH—, —CF═CF—, or —C≡C—, and any hydrogen in the alkyl may be substituted with a halogen atom.

In General Formulas (IV-d4) and (IV-d5), A⁷¹ and A⁷² each independently represent a 3- or 6- to 8-membered aromatic or non-aromatic ring or a fused ring having 9 or more carbon atoms. Any hydrogen atom in these rings may be substituted with a halogen atom or an alkyl group or a haloalkyl group having 1 to 3 carbon atoms, one or two or more —CH₂-'s in the rings may be substituted with —O—, —S—, or —NH—, and one or two or more —CH═'s in the rings may be substituted with —N═.

In General Formulas (IV-d4) and (IV-d5), Z⁷¹ and Z⁷² each independently represent a single bond or an alkylene group having 1 to 8 carbon atoms. Any —CH₂— may be substituted with —O—, —S—, —COO—, —OCO—, —CSO—, —OCS—, —N═N—, —CH═N—, —N═CH—, —N(O)═N—, —N═N(O)—, —CH═CH—, —CF═CF—, or —C≡C—, and any hydrogen atom may be substituted with a halogen atom.

In General Formulas (IV-d4) and (IV-d5), X⁷¹ and X⁷² each independently represent a single bond, —COO—, —OCO—, —CH₂O—, —OCH₂—, —CF₂O—, —OCF₂—, or —CH₂CH₂—.

In General Formulas (IV-d4) and (IV-d5), m₇₁ and m₇₂ each independently represent an integer of 1 to 4. Here, any one of m₇₁ and m₇₂ in General Formula (IV-d5) may be 0.

R^{k} represents a hydrogen atom, a halogen atom, or X⁷¹-(A⁷¹-Z⁷¹)—R⁷¹.

At least any one of X⁶¹ and Y⁶¹ and at least any one of X⁶² and Y⁶² are present in General Formulas (IV-c1) and (IV-c2), respectively, and X⁶¹, X⁶², Y⁶¹, and Y⁶² each independently represent any one of CH₂, C═O, O, N, S, P, B, and Si. In addition, in the case where X⁶¹, X⁶², Y⁶¹, and Y⁶² each independently represent any one of N, P, B, or Si, may be bonded to a substituent such as an alkyl group, an alkoxy group, and an acyl group, so as to satisfy a required valence.

In General Formulas (IV-c1) and (IV-c2), E⁶¹ and E⁶² each independently represent any one of a hydrogen atom, an alkyl group, an aryl group, an allyl group, a benzyl group, an alkenyl group, an alkynyl group, an alkyl ether group, an alkyl ester group, an alkyl ketone group, a hetero ring group, and a derivative thereof.

In General Formulas (IV-c1) and (IV-c2), R⁶¹ and R⁶² each independently represent an alkyl group, an alkoxyl group, a phenyl group which may be substituted with a halogen atom, a cyclopentyl group which may be substituted with a halogen atom, or a cyclohexyl group which may be substituted with a halogen atom.

In General Formula (IV-c1), R⁶³, R⁶⁴, R⁶⁵, R⁶⁶, R⁶⁷, and R⁶⁸ each independently represent a hydrogen atom, an alkyl group, an alkoxyl group, an acyloxy group, a halogen atom, a haloalkyl group, or a dialkylamino group. Two of R⁶³, R⁶⁴, and R⁶⁵ may form a methylene chain which may have a substituent, and two of R⁶³, R⁶⁴, and R⁶⁵ may form a mono or polymethylenedioxy group which may have a substituent or substituents. Two of R⁶⁶, R⁶⁷, and R⁶⁸ may form a methylene chain which may have a substituent, and two of R⁶⁶, R⁶⁷, and R⁶⁸ may form a mono or polymethylenedioxy group which may have a substituent or substituents. Here, the case where both R⁶⁵ and R⁶⁶ are hydrogen atoms is excluded.

In the case where strong helical twisting power is particularly required, compounds represented by General Formulas (IV-d4) and (IV-d5) are particularly preferable.

The helical pitch (P₀) of the liquid crystal composition becomes smaller as a concentration of a chiral compound in the liquid crystal composition becomes higher, however, it is known that, in the case where the concentration of the chiral compound in the liquid crystal composition is low, the product of the concentration of the chiral compound (c (% by mass)) and the helical pitch (P₀ (μm)) is constant, and using the reciprocal thereof, helical twisting power (HTP (μm⁻¹)) represented by Equation (4) is defined. The helical twisting power (HTP) represents a magnitude of the power that subjects the liquid crystal composition including the chiral compound to twist alignment (helical twisting power).

HTP=1/(P₀×0.01c) (4)

The helical twisting power (HTP) of the chiral compound in the present invention is preferably s 1.0 to 100.0 μm⁻¹, more preferably 2.0 to 70.0 μm⁻¹, and particularly preferably 3.0 to 20.0 μm⁻¹.

By setting the helical twisting power (HTP) of the chiral compound equal to or greater than the lower limit value, the physical properties of the liquid crystal composition are not affected by the content of the chiral compound, and sufficient twist alignment power is obtained. By setting the helical twisting power (HTP) of the chiral compound to be equal to or lower than the upper limit value, sufficient twist alignment power is obtained for the liquid crystal composition, even with a small content of the chiral compound.

In general, the higher the content of the chiral compound in the liquid crystal composition to be measured is, the lower the threshold voltage (Vth) becomes. In consideration of such effect, the content of the chiral compound in the liquid crystal composition to be measured is preferably 0.0001% by mass or more, more preferably 0.0005% by mass or more, even more preferably 0.001% by mass or more, still more preferably 0.0025% by mass or more, still more preferably 0.005% by mass or more, still more preferably 0.0075% by mass or more, still more preferably 0.01% by mass or more, still more preferably 0.025% by mass or more, still more preferably 0.05% by mass or more, and still more preferably 0.075% by mass or more. Furthermore, the content of the chiral compound in the liquid crystal composition to be measured is preferably 10% by mass or less, more preferably 7.5% by mass or less, even more preferably 5% by mass or less, still more preferably 3.5% by mass or less, still more preferably 2% by mass or less, still more preferably 1% by mass or less, still more preferably 0.8% by mass or less, still more preferably 0.6% by mass or less, and still more preferably 0.4% by mass or less.

Hereinafter, a preferable liquid crystal composition (n-type liquid crystal composition) serving as an object for measuring K₂₂ in the present invention will be described in detail.

In the present specification, in the case where the symbol “%” is simply used in the description regarding the liquid crystal composition, the symbol “%” indicates “% by mass”, unless otherwise particularly specified.

The n-type liquid crystal composition preferably includes one or two or more compounds selected from the group consisting of compounds represented by General Formulas (N-1), (N-2), and (N-3). These compounds correspond to dielectrically negative compounds (the sign of Δε is negative, and an absolute value thereof is greater than 2).

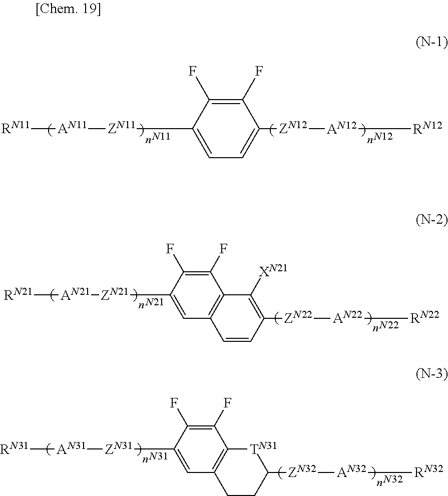

(In the formulas, R^{N11}, R^{N12}, R^{N21}, R^{N22}, R^{N31}, and R^{N32} each independently represent an alkyl group having 1 to 8 carbon atoms, and one or two or more —CH₂-'s which are not adjacent to each other in the alkyl group may each independently be substituted with —CH═CH—, —C≡C—, —O—, —CO—, —COO—, or —OCO—; A^{N11}, A^{N12}, A^{N21}, A^{N22}, A^{N31}, and A^{N32} each independently represent (a) a 1,4-cyclohexylene group (one —CH₂— or two or more —CH₂-'s which are not adjacent to each other that are present in the group may be substituted with —O—), (b) a 1,4-phenylene group (one —CH═ or two or more —CH═'s which are not adjacent to each other that are present in the group may be substituted with —N═), or (c) a group selected from the group consisting of a naphthalene-2,6-diyl group, a 1,2,3,4-tetrahydronaphthalene-2,6-diyl group, and a decahydronaphthalene-2,6-diyl group (one —CH═ or two or more —CH═'s which are not adjacent to each other that are present in the naphthalene-2,6-diyl group or the 1,2,3,4-tetrahydronaphthalene-2,6-diyl group may be substituted with —N═); and

the group (a), the group (b), and the group (c) may each independently be substituted with a cyano group, a fluorine atom, or a chlorine atom;

Z^{N11}, Z^{N12}, Z^{N21}, Z^{N22}, Z^{N31}, and Z^{N32} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—;

X^{N21} represents a hydrogen atom or a fluorine atom;

T^{N31} represents —CH₂— or an oxygen atom; and

n^{N11}, n^{N12}, n^{N21}, n^{N22}, n^{N31}, and n^{N32} each independently represent an integer of 0 to 3, provided that the sum of n^{N11}+n^{N12}, the sum of n^{N21}+n^{N22}, and the sum of n^{N31}+n^{N32} are each independently 1, 2, or 3, and when plural groups or bonds with respect to each of A^{N11} to A^{N32} and Z^{N11} to Z^{N32} are present, they may be the same or different.)

The compounds represented by General Formulas (N-1), (N-2), and (N-3) are preferably compounds whose Δε's are negative with the absolute values thereof being greater than 3.

In General Formulas (N-1), (N-2), and (N-3), R^{N11}, R^{N12}, R^{N21}, R^{N22}, R^{N31}, and R^{N32} are each independently preferably an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, even more preferably an alkyl group having 1 to 5 carbon atoms or an alkenyl group having 2 to 5 carbon atoms, still more preferably an alkyl group having 2 to 5 carbon atoms or an alkenyl group having 2 or 3 carbon atoms, and particularly preferably an alkenyl group having 3 carbon atoms (propenyl group).

In addition, in the case where a ring structure to which R^{N11}, R^{N12}, R^{N21}, R^{N22}, R^{N31}, or R^{N32} bonds is a phenyl group (aromatic), a linear alkyl group having 1 to 5 carbon atoms, a linear alkoxy group having 1 to 4 carbon atoms, and an alkenyl group having 4 or 5 carbon atoms are preferable, and in the case where a ring structure to which R^{N11}, R^{N12}, R^{N21}, R^{N22}, R^{N31}, or R^{N32} bonds is a saturated ring structure such as cyclohexane, pyran, and dioxane, a linear alkyl group having 1 to 5 carbon atoms, a linear alkoxy group having 1 to 4 carbon atoms, and a linear alkenyl group having 2 to 5 carbon atoms are preferable. In order to stabilize a nematic phase, it is preferable that the total number of carbon atoms and oxygen atoms (in the case where oxygen atoms are present) is 5 or less, and the groups are linear.

The alkenyl group is preferably selected from a group represented by any one of Formula (R1) to Formula (R5) (the black dot in each formula represents a carbon atom in the ring structure).

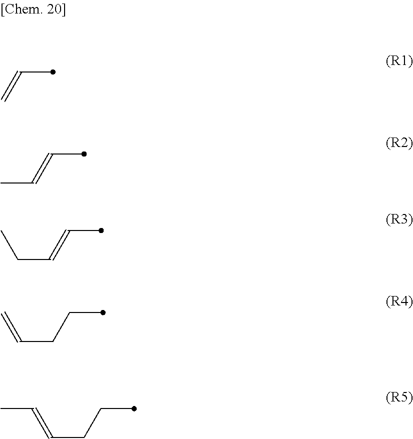

In the case where Δn is required to be increased, A^{N11}, A^{N12}, A^{N21}, A^{N22}, A^{N31}, and A^{N32} are each independently preferably aromatic, and in order to improve a response speed, it is preferable that A^{N11}, A^{N12}, A^{N21}, A^{N22}, A^{N31}, and A^{N32} are each independently aliphatic, and it is preferable that A^{N11}, A^{N12}, A^{N21}, A^{N22}, A^{N31}, and A^{N32} each independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group. It is more preferable that A^{N11}, A^{N12}, A^{N21}, A^{N22}, A^{N31}, and A^{N32} each independently represent the following structures,

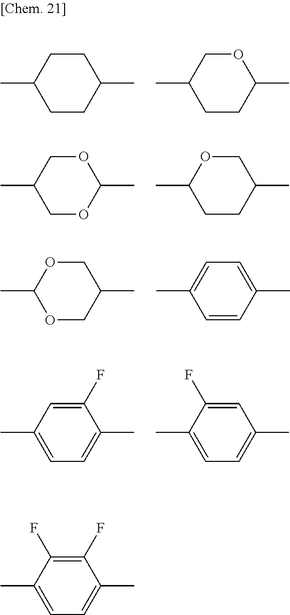

and it is even more preferable that they each independently represent a trans-1,4-cyclohexylene group or a 1,4-phenylene group.

Z^{N11}, Z^{N12}, Z^{N21}, Z^{N22}, Z^{N31}, and Z^{N32} each independently preferably represent —CH₂O—, —CF₂O—, —CH₂CH₂—, —CF₂CF₂—, or a single bond, more preferably represent —CH₂O—, —CH₂CH₂—, or a single bond, and particularly preferably represent —CH₂O— or a single bond.

X^{N21} is preferably a fluorine atom.

T^{N31} is preferably an oxygen atom.

The sum of n^{N11}+n^{N12}, n^{N21}+n^{N22}, or n^{N31}+n^{N32} is preferably 1 or 2, and a combination of n^{N11} being 1 and n^{N12} being 0, a combination of n^{N11} being 2 and n^{N12} being 0, a combination of n^{N11} being 1 and n^{N12} being 1, a combination of n^{N11} being 2 and n^{N12} being 1, a combination of n^{N21} being 1 and n^{N22} being 0, a combination of n^{N21} being 2 and n^{N22} being 0, a combination of n^{N31} being 1 and n^{N32} being 0, and a combination of n^{N31} being 2 and n^{N32} being 0 are preferable.

Lower limit values of preferable contents of the compound represented by Formula (N-1) are 1%, 10%, 20%, 30%, 40%, 50%, 55%, 60%, 65%, 70%, 75%, and 80%, with respect to the total amount of the liquid crystal composition. Upper limit values of the preferable contents are 95%, 85%, 75%, 65%, 55%, 45%, 35%, 25%, and 20%.

Lower limit values of preferable contents of the compound represented by Formula (N-2) are 1%, 10%, 20%, 30%, 40%, 50%, 55%, 60%, 65%, 70%, 75%, and 80%, with respect to the total amount of the liquid crystal composition. Upper limit values of the preferable contents are 95%, 85%, 75%, 65%, 55%, 45%, 35%, 25%, and 20%.

Lower limit values of preferable contents of the compound represented by Formula (N-3) are 1%, 10%, 20%, 30%, 40%, 50%, 55%, 60%, 65%, 70%, 75%, and 80%, with respect to the total amount of the liquid crystal composition. Upper limit values of the preferable contents are 95%, 85%, 75%, 65%, 55%, 45%, 35%, 25%, and 20%.

In the case where viscosity of the liquid crystal composition is maintained to be low, and a composition exhibiting a high response speed is required, it is preferable that the lower limit value and the upper limit value are low. In addition, in the case where Tni of the liquid crystal composition is maintained to be high, and a composition having good temperature stability is required, it is preferable that the lower limit value and the upper limit value are low. Furthermore, when dielectric anisotropy is desired to be increased in order to maintain a driving voltage to be low, it is preferable that the lower limit value and the upper limit value are high.

Examples of the compound represented by General Formula (N-1) include the group of compounds represented by General Formulas (N-1a) to (N-1d).

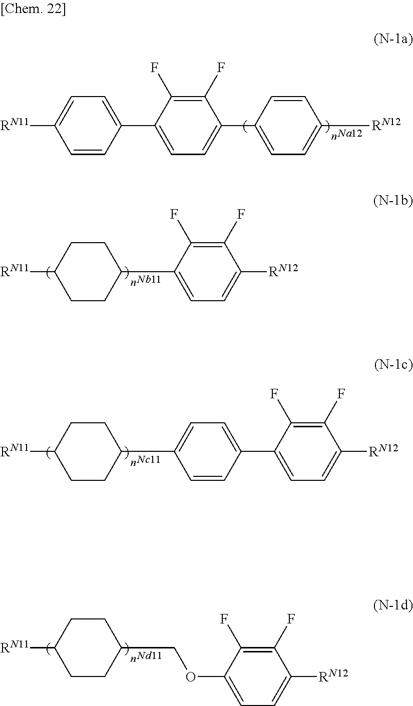

(In the formulas, R^{N11} and R^{N12} have the same definitions as those of R^{N11} and R^{N12} in General Formula (N-1); n^{Na11} represents 0 or 1; n^{Nb11} represents 0 or 1; n^{Nc11} represents 0 or 1; and n^{Nd11} represents 0 or 1.)

More specifically, the compound represented by General Formula (N-1) is preferably a compound selected from the group of compounds represented by General Formulas (N-1-1) to (N-1-21).

The compound represented by General Formula (N-1-1) is the following compound.

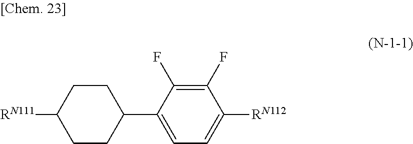

(In the formula, R^{N111} and R^{N112} each independently have the same definition as R^{N11} and R^{N12} in General Formula (N).)

R^{N111} is preferably an alkyl group having 1 to 5 carbon atoms or an alkenyl group having 2 to 5 carbon atoms, and preferably a propyl group or a pentyl group. R^{N112} is preferably an alkyl group having 1 to 5 carbon atoms, an alkenyl group having 4 or 5 carbon atoms, or an alkoxy group having 1 to 4 carbon atoms, and preferably an ethoxy group or a butoxy group.

The compound represented by General Formula (N-1-1) can be used alone, or two or more compounds can be used in combination. The kinds of the compounds that can be used in combination are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be low. Furthermore, in the case of improving drop marks and burn-in characteristics, it is preferable to set the content to be in an intermediate range.

Lower limit values of preferable contents of the compound represented by Formula (N-1-1) are 5%, 10%, 13%, 15%, 17%, 20%, 23%, 25%, 27%, 30%, 33%, and 35%, with respect to the total amount of the liquid crystal composition. Upper limit values of the preferable contents are 50%, 40%, 38%, 35%, 33%, 30%, 28%, 25%, 23%, 20%, 18%, 15%, 13%, 10%, 8%, 7%, 6%, 5%, and 3%, with respect to the total amount of the liquid crystal composition.

In addition, the compound represented by General Formula (N-1-1) is preferably a compound selected from the group of compounds represented by Formula (N-1-1.1) to Formula (N-1-1.14), preferably a compound represented by any one of Formulas (N-1-1.1) to (N-1-1.4), and preferably a compound represented by any one of Formula (N-1-1.1) and Formula (N-1-1.3).

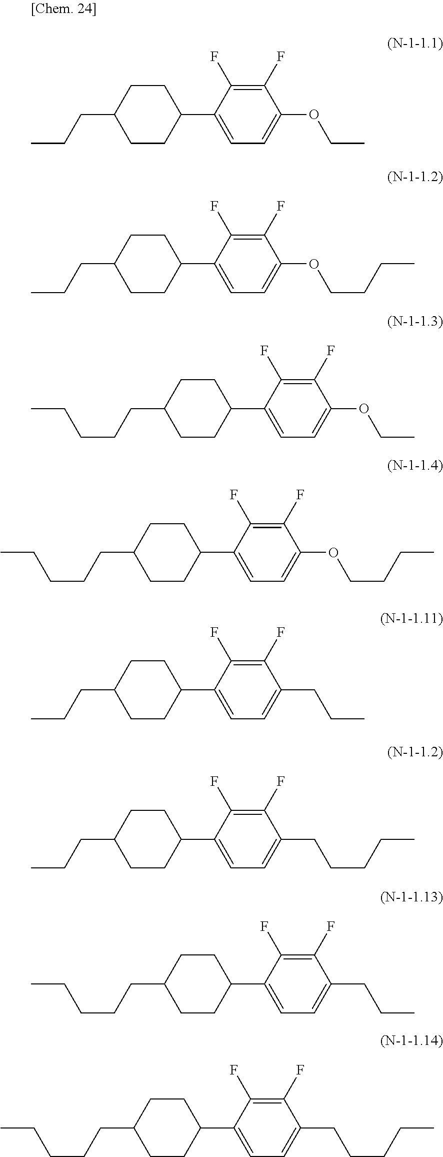

The compounds represented by Formulas (N-1-1.1) to (N-1-1.4) can be used alone or can be used in combination. Lower limit values of preferable contents of one compound alone or a combination of these compounds are 5%, 10%, 13%, 15%, 17%, 20%, 23%, 25%, 27%, 30%, 33%, and 35%, with respect to the total amount of the liquid crystal composition. Upper limit values of the preferable contents are 50%, 40%, 38%, 35%, 33%, 30%, 28%, 25%, 23%, 20%, 18%, 15%, 13%, 10%, 8%, 7%, 6%, 5%, and 3%, with respect to the total amount of the liquid crystal composition.

The compound represented by General Formula (N-1-2) is the following compound.

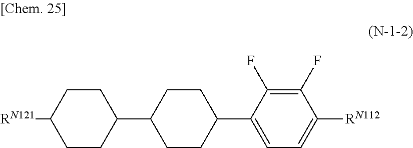

(In the formula, R^{N121} and R^{N122} each independently have the same definition as R^{N11} and R^{N12} in General Formula (N).)

R^{N121} is preferably an alkyl group having 1 to 5 carbon atoms or an alkenyl group having 2 to 5 carbon atoms and preferably an ethyl group, a propyl group, a butyl group, or a pentyl group. R^{N122} is preferably an alkyl group having 1 to 5 carbon atoms, an alkenyl group having 4 or 5 carbon atoms, or an alkoxy group having 1 to 4 carbon atoms and preferably a methyl group, a propyl group, a methoxy group, an ethoxy group, or a propoxy group.

The compound represented by General Formula (N-1-2) can be used alone, or two or more compounds can be used in combination. The kinds of the compounds that can be used in combination are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be low. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-2) are 5%, 7%, 10%, 13%, 15%, 17%, 20%, 23%, 25%, 27%, 30%, 33%, 35%, 37%, 40%, and 42%, with respect to the total amount of the liquid crystal composition. Upper limit values of the preferable contents are 50%, 48%, 45%, 43%, 40%, 38%, 35%, 33%, 30%, 28%, 25%, 23%, 20%, 18%, 15%, 13%, 10%, 8%, 7%, 6%, and 5%, with respect to the total amount of the liquid crystal composition.

Furthermore, the compound represented by General Formula (N-1-2) is preferably a compound selected from the group of compounds represented by Formula (N-1-2.1) to Formula (N-1-2.13) and preferably a compound represented by any one of Formula (N-1-2.3) to Formula (N-1-2.7), Formula (N-1-2.10), Formula (N-1-2.11), and Formula (N-1-2.13). In the case where improvement of Δε is regarded as being important, the compounds represented by Formula (N-1-2.3) to Formula (N-1-2.7) are preferable, and in the case where improvement of Tni is regarded as being important, the compounds represented by Formula (N-1-2.10), Formula (N-1-2.11), and Formula (N-1-2.13) are preferable.

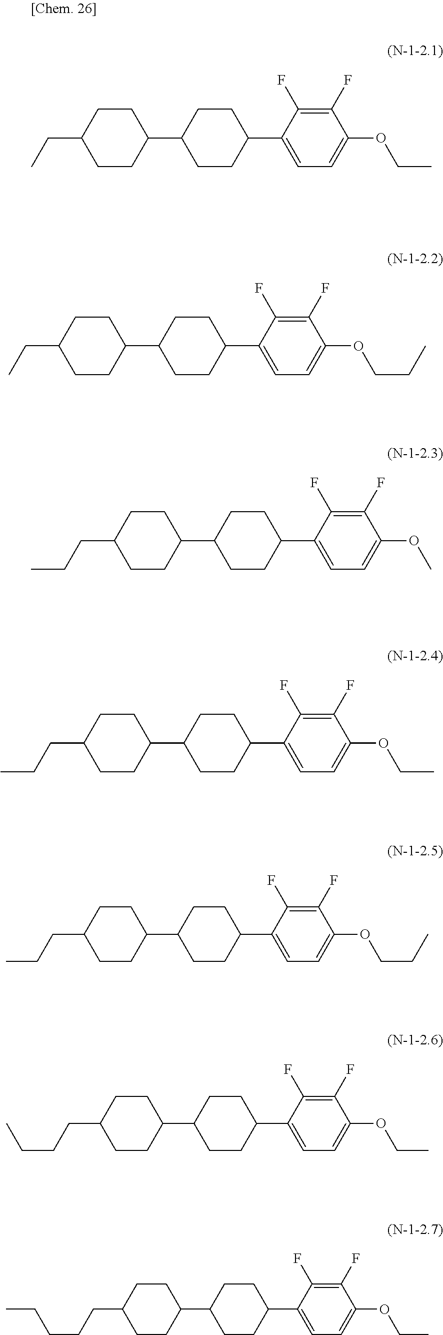

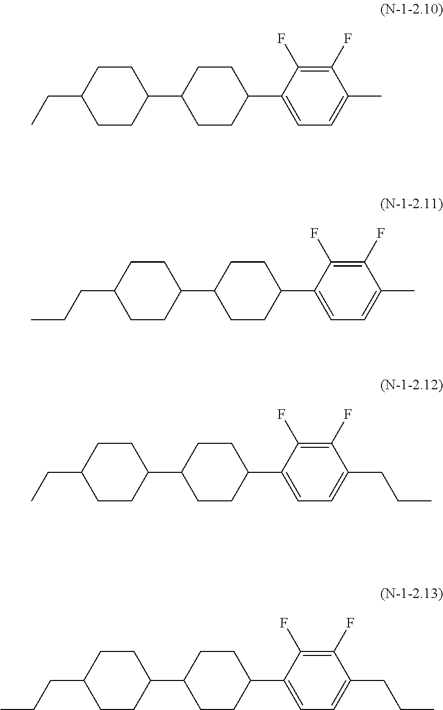

The compounds represented by Formula (N-1-2.1) to Formula (N-1-2.13) can be used alone or can be used in combination. Lower limit values of preferable contents of one compound alone or a combination of these compounds are 5%, 10%, 13%, 15%, 17%, 20%, 23%, 25%, 27%, 30%, 33%, and 35%, with respect to the total amount of the liquid crystal composition. Upper limit values of the preferable contents are 50%, 40%, 38%, 35%, 33%, 30%, 28%, 25%, 23%, 20%, 18%, 15%, 13%, 10%, 8%, 7%, 6%, 5%, and 3%, with respect to the total amount of the liquid crystal composition.

The compound represented by General Formula (N-1-3) is the following compound.

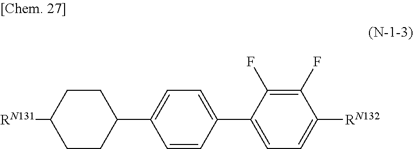

(In the formula, R^{N131} and R^{N132} each independently have the same definition as R^{N11} and R^{N21} in General Formula (N).)

R^{N131} is preferably an alkyl group having 1 to 5 carbon atoms or an alkenyl group having 2 to 5 carbon atoms and preferably an ethyl group, a propyl group, or a butyl group. R^{N132} is preferably an alkyl group having 1 to 5 carbon atoms, an alkenyl group having 4 or 5 carbon atoms, or an alkoxy group having 1 to 4 carbon atoms and preferably an ethoxy group, a propoxy group, or a butoxy group.

The compound represented by General Formula (N-1-3) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-3) are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

Furthermore, the compound represented by General Formula (N-1-3) is preferably a compound selected from the group of compounds represented by Formula (N-1-3.1) to Formula (N-1-3.11), preferably a compound represented by any one of Formula (N-1-3.1) to (N-1-3.7), and preferably a compound represented by any one of Formula (N-1-3.1), Formula (N-1-3.2), Formula (N-1-3.3), Formula (N-1-3.4), and Formula (N-1-3.6).

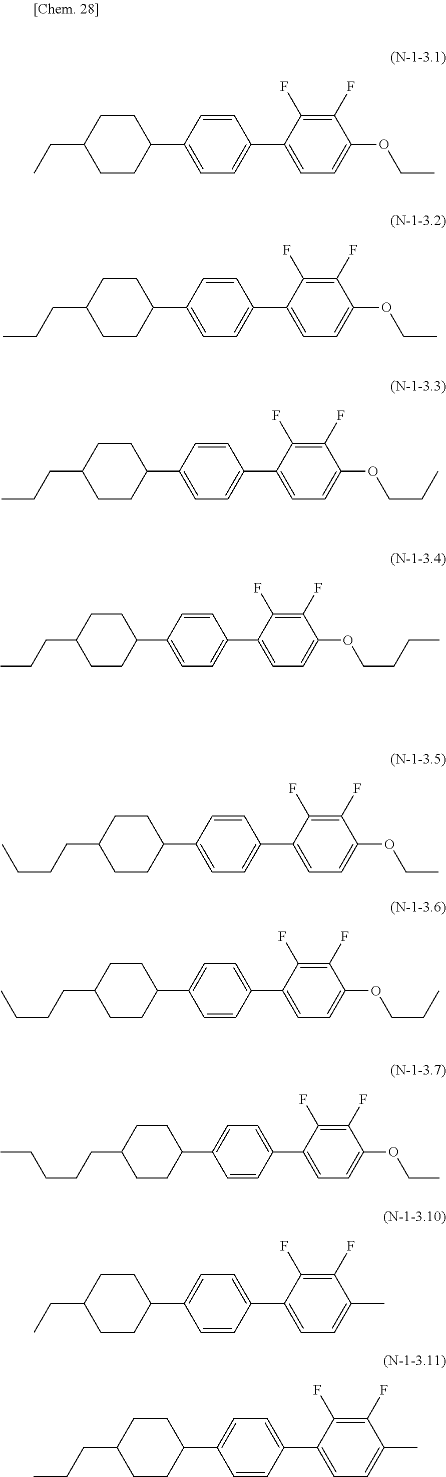

The compounds represented by Formula (N-1-3.1) to Formula (N-1-3.4) and Formula (N-1-3.6) can be used alone or can be used in combination. A combination of Formula (N-1-3.1) and Formula (N-1-3.2) and a combination of two or three selected from Formula (N-1-3.3), Formula (N-1-3.4), and Formula (N-1-3.6) are preferable. Lower limit values of preferable contents of a content of one compound alone or a combination of these compounds are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

The compound represented by General Formula (N-1-4) is the following compound.

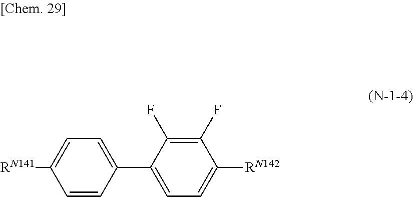

(In the formula, R^{N141} and R^{N142} each independently have the same definition as R^{N11} and R^{N12} in General Formula (N).)

R^{N141} and R^{N142} are each independently preferably an alkyl group having 1 to 5 carbon atoms, an alkenyl group having 4 or 5 carbon atoms, or an alkoxy group having 1 to 4 carbon atoms and preferably a methyl group, a propyl group, an ethoxy group, or a butoxy group.

The compound represented by General Formula (N-1-4) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be low. Furthermore, in the case of improving drop marks and burn-in characteristics, it is preferable to set the content to be in an intermediate range.

Lower limit values of preferable contents of the compound represented by Formula (N-1-4) are 3%, 5%, 7%, 10%, 13%, 15%, 17%, and 20%, with respect to the total amount of the liquid crystal composition. Upper limit values of the preferable contents are 35%, 30%, 28%, 25%, 23%, 20%, 18%, 15%, 13%, 11%, 10%, and 8%, with respect to the total amount of the liquid crystal composition.

Furthermore, the compound represented by General Formula (N-1-4) is preferably a compound selected from the group of compounds represented by Formula (N-1-4.1) to Formula (N-1-4.14), preferably a compound represented by any one of Formula (N-1-4.1) to (N-1-4.4), and preferably a compound represented by any one of Formula (N-1-4.1) and Formula (N-1-4.2).

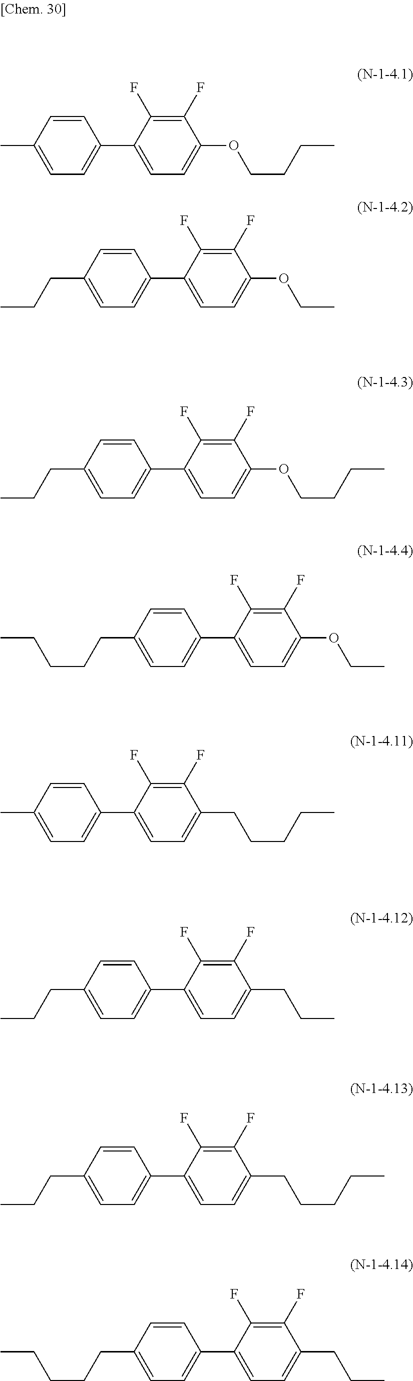

The compounds represented by Formula (N-1-4.1) to (N-1-4.4) can be used alone or can be used in combination. Lower limit values of preferable contents of one compound alone or a combination of these compounds are 3%, 5%, 7%, 10%, 13%, 15%, 17%, and 20%, with respect to the total amount of the liquid crystal composition. Upper limit values of the preferable contents are 35%, 30%, 28%, 25%, 23%, 20%, 18%, 15%, 13%, 11%, 10%, and 8%, with respect to the total amount of the liquid crystal composition.

The compound represented by General Formula (N-1-5) is the following compound.

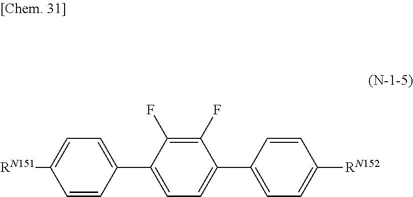

(In the formula, R^{N151} and R^{N152} each independently have the same definition as R^{N11} and R^{N12} in General Formula (N).)

R^{N151} and R^{N152} are each independently preferably an alkyl group having 1 to 5 carbon atoms, an alkenyl group having 4 or 5 carbon atoms, or an alkoxy group having 1 to 4 carbon atoms, and preferably an ethyl group, a propyl group, or a butyl group.

The compound represented by General Formula (N-1-5) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be low. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-5) are 5%, 8%, 10%, 13%, 15%, 17%, and 20%, with respect to the total amount of the liquid crystal composition. Upper limit values of the preferable contents are 35%, 33%, 30%, 28%, 25%, 23%, 20%, 18%, 15%, and 13%, with respect to the total amount of the liquid crystal composition.

Furthermore, the compound represented by General Formula (N-1-5) is preferably a compound selected from the group of compounds represented by Formula (N-1-5.1) to Formula (N-1-5.6) and preferably a compound represented by any one of Formula (N-1-3.2) and Formula (N-1-3.4).

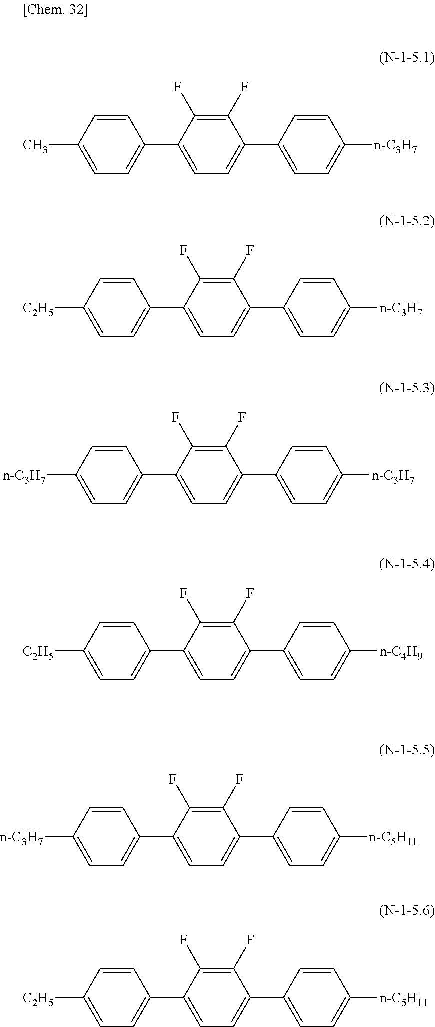

The compound represented by Formula (N-1-3.2) and Formula (N-1-3.4) can be used alone or can be used in combination. Lower limit values of preferable contents of one compound alone or a combination of these compounds are 5%, 8%, 10%, 13%, 15%, 17%, and 20%, with respect to the total amount of the liquid crystal composition. Upper limit values of the preferable contents are 35%, 33%, 30%, 28%, 25%, 23%, 20%, 18%, 15%, and 13%, with respect to the total amount of the liquid crystal composition.

The compound represented by General Formula (N-1-10) is the following compound.

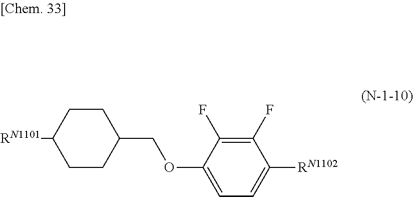

(In the formula, R^{N1101} and R^{N1102} each independently have the same definition as R^{N11} and R^{N12} in General Formula (N).)

R^{N1101} is preferably an alkyl group having 1 to 5 carbon atoms or an alkenyl group having 2 to 5 carbon atoms and preferably an ethyl group, a propyl group, or a butyl group. R^{N1102} is preferably an alkyl group having 1 to 5 carbon atoms, an alkenyl group having 4 or 5 carbon atoms, or an alkoxy group having 1 to 4 carbon atoms and preferably an ethoxy group, a propoxy group, or a butoxy group.

The compound represented by General Formula (N-1-10) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-10) are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

Furthermore, the compound represented by General Formula (N-1-10) is preferably a compound selected from the group of compounds represented by Formula (N-1-10.1) to Formula (N-1-10.11), preferably a compound represented by any one of Formula (N-1-10.1) to (N-1-10.5), and preferably a compound represented by any one of Formula (N-1-10.1) and Formula (N-1-10.2).

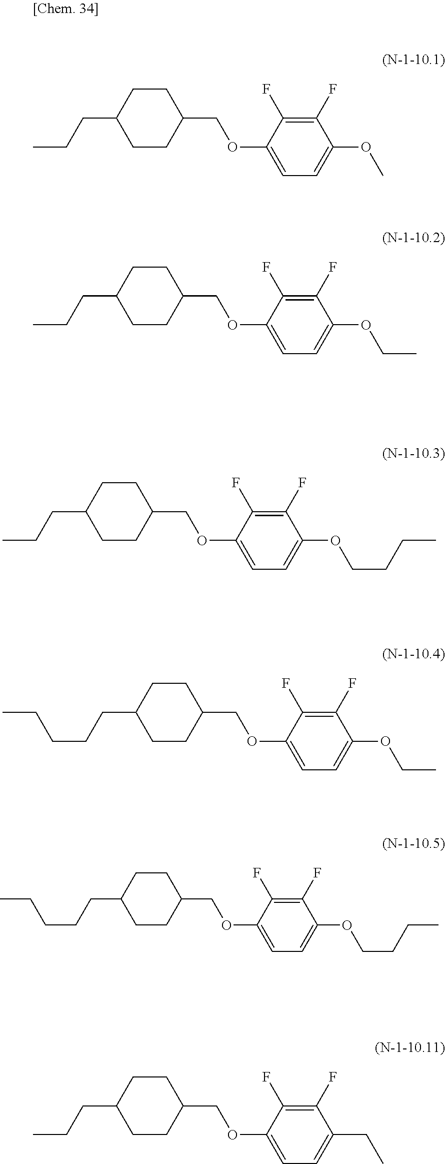

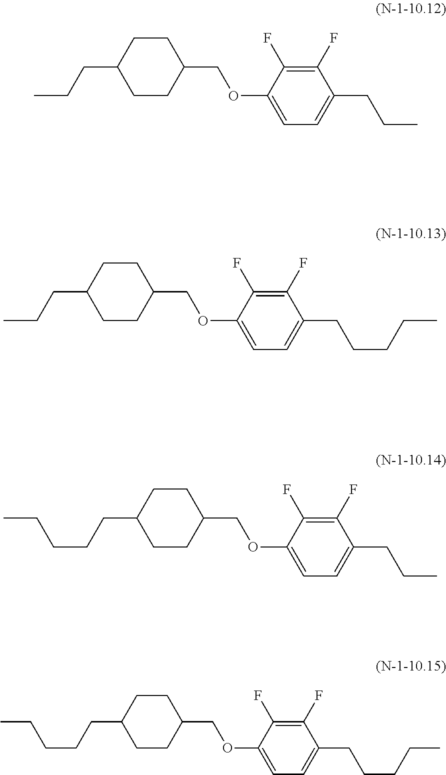

The compounds represented by Formula (N-1-10.1) and Formula (N-1-10.2) can be used alone or can be used in combination. Lower limit values of preferable contents of one compound alone or a combination of these compounds are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

The compound represented by General Formula (N-1-11) is the following compound.

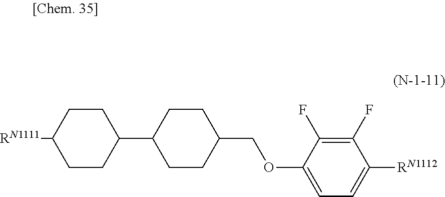

(In the formula, R^{N1111} and R^{N1112} each independently have the same definition as R^{N11} and R^{N12} in General Formula (N).)

R^{N1111} is preferably an alkyl group having 1 to 5 carbon atoms or an alkenyl group having 2 to 5 carbon atoms and preferably an ethyl group, a propyl group, or a butyl group. R^{N1112} is an alkyl group having 1 to 5 carbon atoms, an alkenyl group having 4 or 5 carbon atoms, or an alkoxy group having 1 to 4 carbon atoms and preferably an ethoxy group, a propoxy group, or a butoxy group.

The compound represented by General Formula (N-1-11) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-11) are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

Furthermore, the compound represented by General Formula (N-1-11) is preferably a compound selected from the group of compounds represented by Formula (N-1-11.1) to Formula (N-1-11.15), preferably a compound represented by any one of Formulas (N-1-11.1) to (N-1-11.15), and preferably a compound represented by any one of Formula (N-1-11.2) and Formula (N-1-11.4).

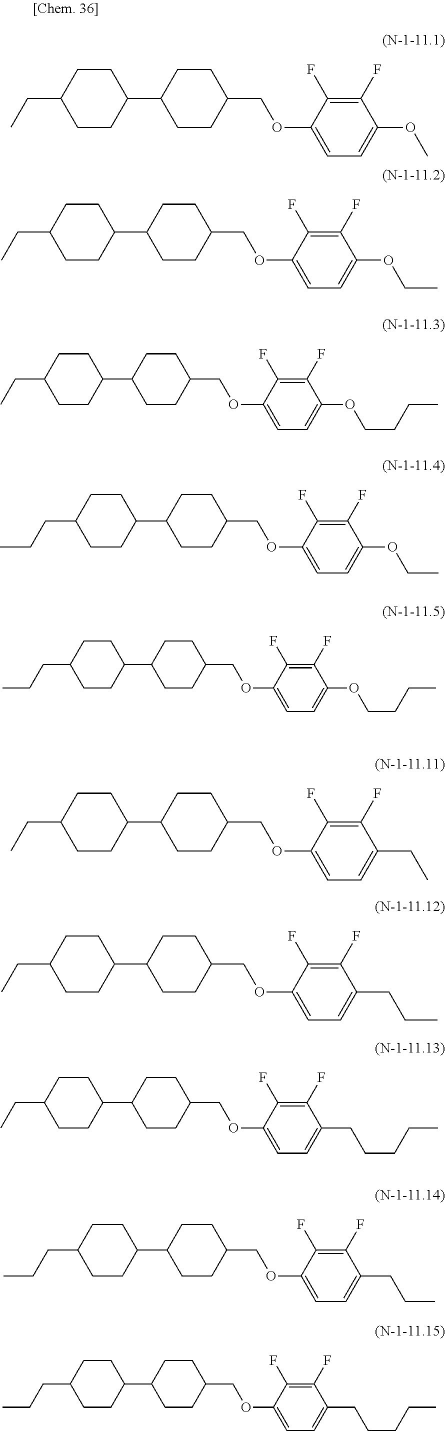

The compounds represented by Formula (N-1-11.2) and Formula (N-1-11.4) can be used alone or can be used in combination. Lower limit values of preferable contents of one compound alone or a combination of these compounds are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

The compound represented by General Formula (N-1-12) is the following compound.

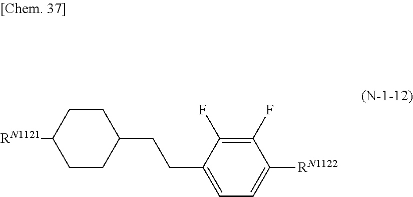

(In the formula, R^{N1121} and R^{N1122} each independently have the same definition as R^{N11} and R^{N12} in General Formula (N).)

R^{N1121} is preferably an alkyl group having 1 to 5 carbon atoms or an alkenyl group having 2 to 5 carbon atoms and preferably an ethyl group, a propyl group, or a butyl group. R^{N1122} is preferably an alkyl group having 1 to 5 carbon atoms, an alkenyl group having 4 or 5 carbon atoms, or an alkoxy group having 1 to 4 carbon atoms and preferably an ethoxy group, a propoxy group, or a butoxy group.

The compound represented by General Formula (N-1-12) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-12) are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

The compound represented by General Formula (N-1-13) is the following compound.

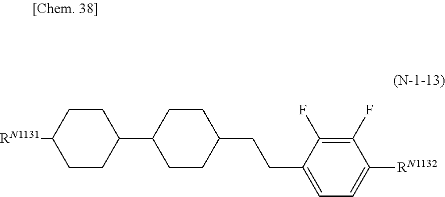

(In the formula, R^{N1131} and R^{N1132} each independently have the same definition as R^{N11} and R^{N12} in General Formula (N).)

R^{N1131} is preferably an alkyl group having 1 to 5 carbon atoms or an alkenyl group having 2 to 5 carbon atoms and preferably an ethyl group, a propyl group, or a butyl group. R^{N132} is preferably an alkyl group having 1 to 5 carbon atoms, an alkenyl group having 4 or 5 carbon atoms, or an alkoxy group having 1 to 4 carbon atoms and preferably an ethoxy group, a propoxy group, or a butoxy group.

The compound represented by General Formula (N-1-13) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-13) are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

The compound represented by General Formula (N-1-14) is the following compound.

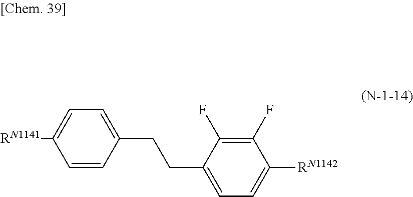

(In the formula, R^{N1141} and R^{N1142} each independently have the same definition as R^{N11} and R^{N12} in General Formula (N).)

R^{N1141} is preferably an alkyl group having 1 to 5 carbon atoms or an alkenyl group having 2 to 5 carbon atoms and preferably an ethyl group, a propyl group, or a butyl group. R^{N1142} is preferably an alkyl group having 1 to 5 carbon atoms, an alkenyl group having 4 or 5 carbon atoms, or an alkoxy group having 1 to 4 carbon atoms and preferably an ethoxy group, a propoxy group, or a butoxy group.

The compound represented by General Formula (N-1-14) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-14) are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

The compound represented by General Formula (N-1-15) is the following compound.

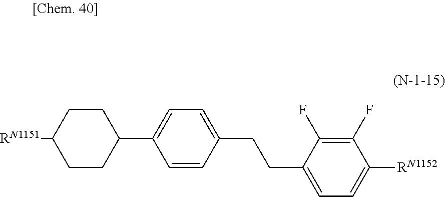

(In the formula, R^{N1151} and R^{N1152} each independently have the same definition as R^{N11} and R^{N12} in General Formula (N).)

R^{N1151} is preferably an alkyl group having 1 to 5 carbon atoms or an alkenyl group having 2 to 5 carbon atoms and preferably an ethyl group, a propyl group, or a butyl group. R^{N1152} is preferably an alkyl group having 1 to 5 carbon atoms, an alkenyl group having 4 or 5 carbon atoms, or an alkoxy group having 1 to 4 carbon atoms and preferably an ethoxy group, a propoxy group, or a butoxy group.

The compound represented by General Formula (N-1-15) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-15) are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

The compound represented by General Formula (N-1-16) is the following compound.

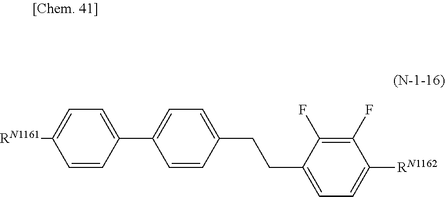

(In the formula, R^{N1161} and R^{N1162} each independently have the same definition as R^{N11} and R^{N12} in General Formula (N).)

R^{N1161} is preferably an alkyl group having 1 to 5 carbon atoms or an alkenyl group having 2 to 5 carbon atoms and preferably an ethyl group, a propyl group, or a butyl group. R^{N1162} is preferably an alkyl group having 1 to 5 carbon atoms, an alkenyl group having 4 or 5 carbon atoms, or an alkoxy group having 1 to 4 carbon atoms and preferably an ethoxy group, a propoxy group, or a butoxy group.

The compound represented by General Formula (N-1-16) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-16) are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

The compound represented by General Formula (N-1-17) is the following compound.

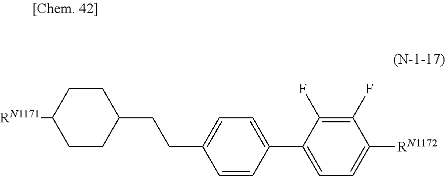

(In the formula, R^{N1171} and R^{N1172} each independently have the same definition as R^{N11} and R^{N12} in General Formula (N).)

R^{N1171} is preferably an alkyl group having 1 to 5 carbon atoms or an alkenyl group having 2 to 5 carbon atoms and preferably an ethyl group, a propyl group, or a butyl group. R^{N1172} is preferably an alkyl group having 1 to 5 carbon atoms, an alkenyl group having 4 or 5 carbon atoms, or an alkoxy group having 1 to 4 carbon atoms and preferably an ethoxy group, a propoxy group, or a butoxy group.

The compound represented by General Formula (N-1-17) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-17) are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

The compound represented by General Formula (N-1-18) is the following compound.

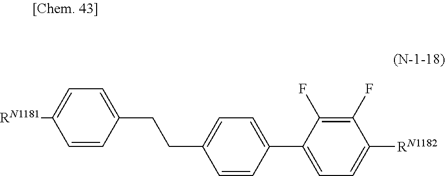

(In the formula, R^{N1181} and R^{N1182} each independently have the same definition as R^{N11} and R^{N12} in General Formula (N).)

R^{N1181} is preferably an alkyl group having 1 to 5 carbon atoms or an alkenyl group having 2 to 5 carbon atoms and preferably an ethyl group, a propyl group, or a butyl group. R^{N1182} is preferably an alkyl group having 1 to 5 carbon atoms, an alkenyl group having 4 or 5 carbon atoms, or an alkoxy group having 1 to 4 carbon atoms and preferably an ethoxy group, a propoxy group, or a butoxy group.

The compound represented by General Formula (N-1-18) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where improvement of Δε is regarded as being important, it is preferable to set a content of the compound to be high. In the case where solubility at a low temperature is regarded as being important, the effect of having increased solubility at a low temperature is high when the content is set to be high. In the case where Tni is regarded as being important, the effect of having increased Tni is high when the content is set to be high. Furthermore, in the case of improving drop marks and burn-in characteristics, it is preferable to set the content to be in an intermediate range.

Lower limit values of preferable contents of the compound represented by Formula (N-1-18) are 5%, 10%, 13%, 15%, 17%, and 20%, with respect to the total amount of the liquid crystal composition. Upper limit values of the preferable contents are 35%, 30%, 28%, 25%, 23%, 20%, 18%, 15%, and 13%, with respect to the total amount of the liquid crystal composition.

The compound represented by General Formula (N-1-20) is the following compound.

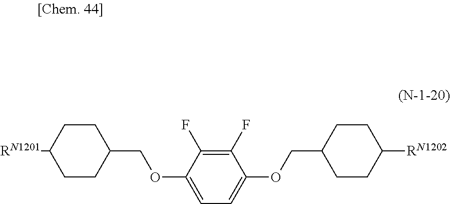

(In the formula, R^{N1201} and R^{N1202} each independently have the same definition as R^{N11} and R^{N12} in General Formula (N).)

The compound represented by General Formula (N-1-21) is the following compound.

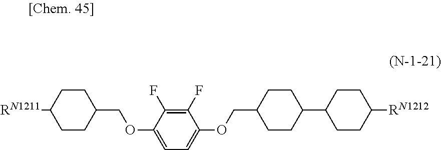

(In the formula, R^{N1211} and R^{N1212} each independently have the same definition as R^{N11} and R^{N12} in General Formula (N).)

The compound represented by General Formula (N-2) is preferably a compound selected from the group of compounds represented by General Formulas (N-2-1) to (N-2-3).

The compound represented by General Formula (N-2-1) is the following compound.

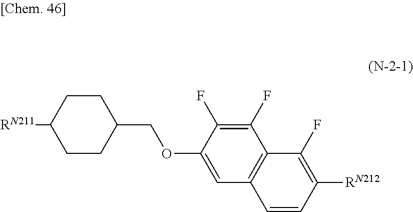

(In the formula, R^{N211} and R^{N212} each independently have the same definition as R^{N11} and R^{N12} in General Formula (N).)

The compound represented by General Formula (N-2-2) is the following compound.

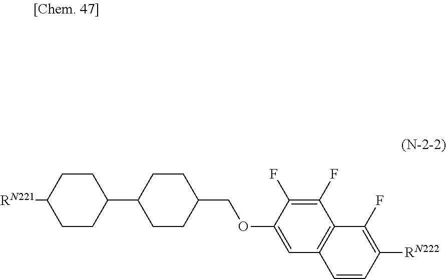

(In the formula, R^{N221} and R^{N222} each independently have the same definition as R^{N11} and R^{N12} in General Formula (N).)

The compound represented by General Formula (N-2-3) is the following compound.

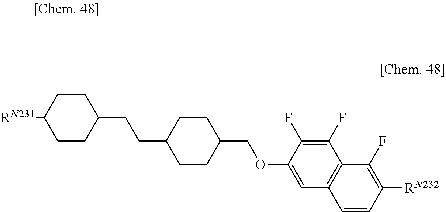

(In the formula, R^{N31} and R^{N32} each independently have the same definition as R^{N11} and R^{N12} in General Formula (N).)

The compound represented by General Formula (N-3) is preferably a compound selected from the group of compounds represented by General Formulas (N-3-1) and (N-3-2).

The compound represented by General Formula (N-3-1) is the following compound.

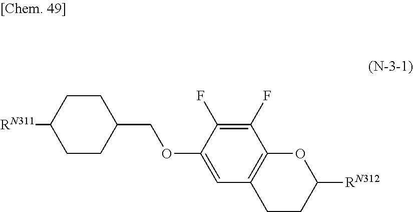

(In the formula, R^{N311} and R^{N312} each independently have the same definition as R^{N11} and R^{N12} in General Formula (N).)

The compound represented by General Formula (N-3-2) is the following compound.

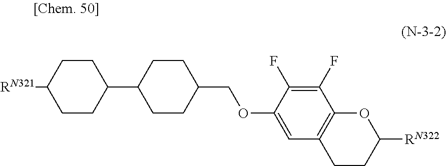

(In the formula, R^{N321} and R^{N322} each independently have the same definition as R^{N11} and R^{N12} in General Formula (N).)

A compound represented by General Formula (ii) is preferably a compound represented by General Formula (ii-1A), General Formula (ii-1B), or General Formula (ii-1C).

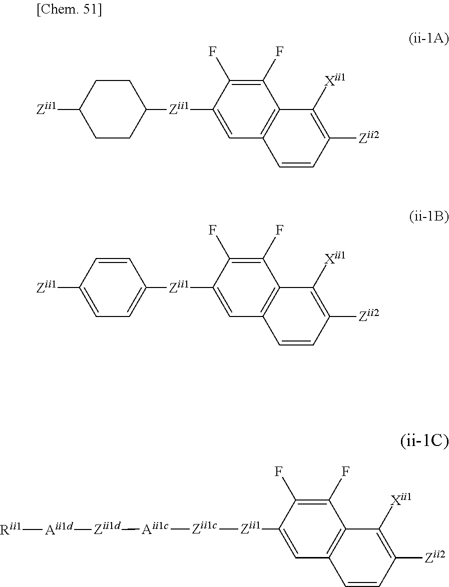

(In the formulas, Rⁱⁱ¹, Rⁱⁱ², Zⁱⁱ¹, and Xⁱⁱ¹ each independently have the same definition as Rⁱⁱ¹, Rⁱⁱ², Zⁱⁱ¹, and Xⁱⁱ¹ in General Formula (ii); A^{ii1c} and A^{ii1d} each independently represent a 1,4-cyclohexylene group or a 1,4-phenylene group, one —CH₂— or two or more —CH₂-'s which are not adjacent to each other that are present in the 1,4-cyclohexylene group may be substituted with —O— or —S—, and one hydrogen atom that is present in the 1,4-phenylene group may each independently be substituted with a fluorine atom or a chlorine atom; and Z^{ii1c} and Z^{ii1d} each independently represent a single bond, —OCH₂—, —CH₂O—, —OCF₂—, —CF₂O—, —CH₂CH₂—, or —CF₂CF₂—.)

In the compound represented by General Formula (ii-1A) or General Formula (ii-1B), Zⁱⁱ¹ preferably represents a single bond, —OCH₂—, —CH₂O—, or —CH₂CH₂.

The compound represented by General Formula (ii-1C) is preferably a compound represented by any one of General Formula (ii-1C-1) to General Formula (ii-1C-4).

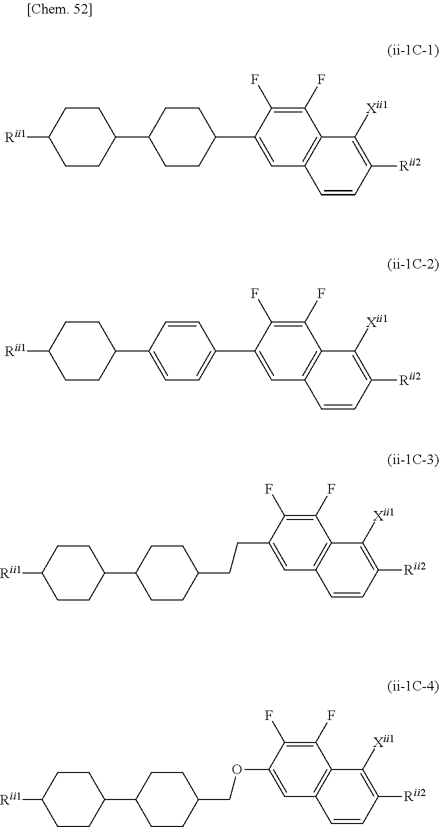

(In the formulas, Rⁱⁱ¹ and Rⁱⁱ² each independently have the same definition as Rⁱⁱ¹ and Rⁱⁱ² in General Formula (ii).)

A compound represented by General Formula (iii) is preferably a compound represented by General Formula (iii-1A), General Formula (iii-1B), or General Formula (iii-1C).

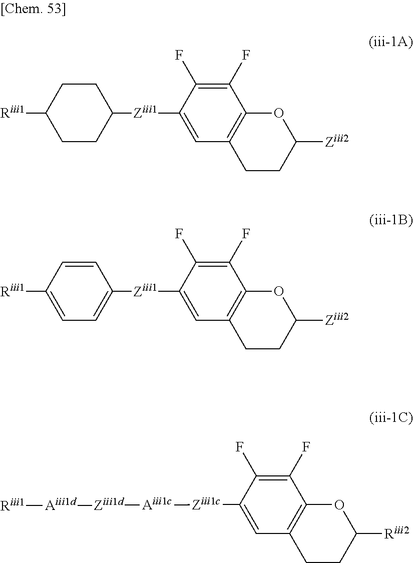

(In the formulas, Rⁱⁱⁱ¹, Rⁱⁱⁱ² and Zⁱⁱⁱ¹ each independently have the same definition as Rⁱⁱⁱ¹, Rⁱⁱⁱ², and Zⁱⁱⁱ¹ in General Formula (iii); A^{iii1c} and A^{iii1d} each independently represent a 1,4-cyclohexylene group or a 1,4-phenylene group, one —CH₂— or two or more —CH₂-'s which are not adjacent to each other that are present in the 1,4-cyclohexylene group may be substituted with —O— or —S—, and one hydrogen atom that is present in the 1,4-phenylene group may each independently be substituted with a fluorine atom or a chlorine atom; and Z^{iii1c} and Z^{iii1d} each independently represent a single bond, —OCH₂—, —CH₂O—, —OCF₂—, —CF₂O—, —CH₂CH₂—, or —CF₂CF₂—.)

In the compound represented by General Formula (iii-1A) or General Formula (iii-1B), Zⁱⁱⁱ¹ preferably represents a single bond, —OCH₂—, —CH₂O—, or —CH₂CH₂.

The compound represented by General Formula (iii-1C) is preferably a compound represented by any one of General Formula (iii-1C-1) to General Formula (iii-1C-3).

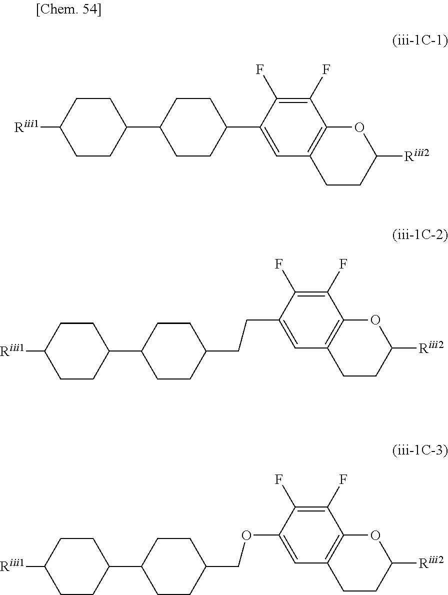

(In the formulas, Rⁱⁱⁱ¹ and Rⁱⁱⁱ² each independently have the same definition as Rⁱⁱⁱ¹ and Rⁱⁱⁱ² in General Formula (iii).)

In the case where the liquid crystal composition includes two or more compounds represented by General Formulas (i) to (iii), the composition may include two or more of the compounds selected from only one formula among the compounds represented by General Formulas (i) to (iii) and may include two or more of the compounds selected from two or more formulas selected from the compounds represented by General Formulas (i) to (iii).

The liquid crystal composition preferably includes one or two or more compounds represented by General Formula (i) and preferably includes one or two or more compounds represented by General Formula (i-1A), General Formula (i-1B), or General Formula (i-1C), and more preferably includes 2 to 10 compounds represented by General Formula (i-1A), General Formula (i-1B), or General Formula (i-1C).

To be more specific, General Formula (i-1A), General Formula (i-1B), and General Formula (i-1C) preferably include one or two or more compounds selected from the group of compounds represented by General Formula (i-1A-1), General Formula (i-1B-1), and General Formula (i-1C-1) and more preferably are a combination of the compound represented by General Formula (i-1A-1) and the compound represented by General Formula (i-1B-1).

The total amount of the contents of the compounds represented by General Formula (i), General Formula (ii), and General Formula (iii) is preferably 10% to 90% by mass, more preferably 20% to 80% by mass, even more preferably 20% to 70% by mass, still more preferably 20% to 60% by mass, still more preferably 20% to 55% by mass, still more preferably 25% to 55% by mass, and particularly preferably 30% to 55% by mass.

More specifically, the total amount of the contents of the compounds represented by General Formula (i), General Formula (ii), and General Formula (iii) is, as the lower limit value in the composition, preferably 1% by mass or more (hereinafter, % used for the composition indicates % by mass), preferably 5% or more, preferably 10% or more, preferably 13% or more, preferably 15% or more, preferably 18% or more, preferably 20% or more, preferably 23% or more, preferably 25% or more, preferably 28% or more, preferably 30% or more, preferably 33% or more, preferably 35% or more, preferably 38% or more, and preferably 40% or more. In addition, the total amount of the contents of the compounds is, as the upper limit value, preferably 95% or less, preferably 90% or less, preferably 88% or less, preferably 85% or less, preferably 83% or less, preferably 80% or less, preferably 78% or less, preferably 75% or less, preferably 73% or less, preferably 70% or less, preferably 68% or less, preferably 65% or less, preferably 63% or less, preferably 60% or less, preferably 55% or less, preferably 50% or less, and preferably 40% or less.

The liquid crystal composition preferably includes one or two or more compounds represented by General Formula (L). The compound represented by General Formula (L) corresponds to a compound which is substantially dielectrically neutral (Δε value is −2 to 2).

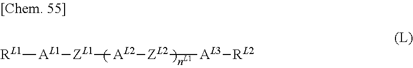

(In the formula, R^{L1} and R^{L2} each independently represent an alkyl group having 1 to 8 carbon atoms, and one or two or more —CH₂-'s which are not adjacent to each other in the alkyl group may each independently be substituted with —CH═CH—, —C≡C—, —O—, —CO—, —COO—, or —OCO—;

n^{L1} represents 0, 1, 2, or 3;

A^{L1}, A^{L2}, and A^{L3} each independently represent

(a) a 1,4-cyclohexylene group (one —CH₂— or two or more —CH₂-'s which are not adjacent to each other that are present in the group may be substituted with —O—),

(b) a 1,4-phenylene group (one —CH═ or two or more —CH═'s which are not adjacent to each other that are present in the group may be substituted with —N═), or

(c) a group selected from the group consisting of a naphthalene-2,6-diyl group, a 1,2,3,4-tetrahydronaphthalene-2,6-diyl group, or a decahydronaphthalene-2,6-diyl group (one —CH═ or two or more —CH═'s which are not adjacent to each other that are present in the naphthalene-2,6-diyl group or the 1,2,3,4-tetrahydronaphthalene-2,6-diyl group may be substituted with —N═);

the group (a), the group (b), and the group (c) may each independently be substituted with a cyano group, a fluorine atom, or a chlorine atom;

Z^{L1} and Z^{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—; and

in the case where n^{L1} is 2 or 3, and plural A^{L2}'s are present, the plurality of A^{L2}'s may be the same or different, and in the case where n^{L1} is 2 or 3, and plural Z^{L3}'s are present, the plurality of Z^{L3}'s may be the same or different, provided that the compounds represented by General Formula (i), General Formula (ii), General Formula (N-1), General Formula (N-2), and General Formula (N-3) are excluded.)

The compound represented by General Formula (L) can be used alone or can be used in combination. The kinds of the compounds that can be combined are not particularly limited, and the compounds are used by being suitably combined according to desired performances, such as solubility at a low temperature, a transition temperature, electrical reliability, and birefringence index. The number of the kinds of the compound that is used is, for example, one kind, as one embodiment of the present invention. Alternatively, two kinds, three kinds, four kinds, five kinds, six kinds, seven kinds, eight kinds, nine kinds, or ten or more kinds of the compound can be used in another embodiment of the present invention.

A content of the compound represented by General Formula (L) in the liquid crystal composition needs to be suitably adjusted according to required performances, such as solubility at a low temperature, a transition temperature, electrical reliability, birefringence index, process adaptability, drop marks, burn-in, and dielectric anisotropy.

Lower limit values of preferable contents of the compound represented by Formula (L) are 1%, 10%, 20%, 30%, 40%, 50%, 55%, 60%, 65%, 70%, 75%, and 80%, with respect to the total amount of the liquid crystal composition. Upper limit values of the preferable contents are 95%, 85%, 75%, 65%, 55%, 45%, 35%, and 25%.

In the case where viscosity of the liquid crystal composition is maintained to be low, and a composition exhibiting a high response speed is required, it is preferable that the lower limit value and the upper limit value are high. In addition, in the case where Tni of the liquid crystal composition is maintained to be high, and a composition having good temperature stability is required, it is preferable that the lower limit value and the upper limit value are high. Furthermore, when dielectric anisotropy is desired to be increased in order to maintain a driving voltage to be low, it is preferable that the lower limit value and the upper limit value are low.

In the case where reliability is regarded as being important, it is preferable that both R^{L1} and R^{L2} are alkyl groups. In the case where decreasing volatility of the compound is regarded as being important, it is preferable that both R^{L1} and R^{L2} are alkoxy groups. In the case where decreasing viscosity is regarded as being important, it is preferable that at least one of R^{L1} and R^{L2} is an alkenyl group.

In the case where a ring structure to which R^{L1} or R^{L2} bonds is a phenyl group (aromatic), a linear alkyl group having 1 to 5 carbon atoms, a linear alkoxy group having 1 to 4 carbon atoms, and an alkenyl group having 4 or 5 carbon atoms are preferable, and in the case where a ring structure to which R^{L1} or R^{L2} bonds is a saturated ring structure such as cyclohexane, pyran, and dioxane, a linear alkyl group having 1 to 5 carbon atoms, a linear alkoxy group having 1 to 4 carbon atoms, and a linear alkenyl group having 2 to 5 carbon atoms are preferable. In order to stabilize a nematic phase, it is preferable that the total number of carbon atoms and oxygen atoms (in the case where oxygen atoms are present) is 5 or less, and the groups are preferably linear.

The alkenyl group is preferably selected from a group represented by any one of Formula (R1) to Formula (R5) (the black dot in each formula represents a carbon atom in the ring structure).

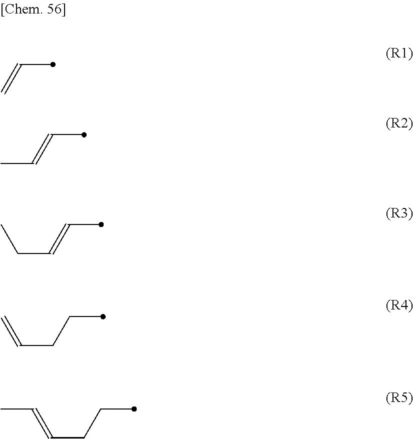

In the case where a response speed is regarded as being important, it is preferable that n^{L1} is 0. In order to improve the upper limit temperature of the nematic phase, it is preferable that n^{L1} is 2 or 3. In order to obtain balance between the response speed and the upper limit temperature of the nematic phase, it is preferable that n^{L1} is 1. In addition, in order to satisfy the characteristics required for the composition, it is preferable to combine compounds having different values.

In the case where Δn is required to be increased, it is preferable that A^{L1}, A^{L2}, and A^{L3} are aromatic. In order to improve a response speed, it is preferable that A^{L1}, A^{L2}, and A^{L3} are aliphatic, and A^{L1}, A^{L2}, and A^{L3} each independently preferably represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, more preferably represent the following structure,

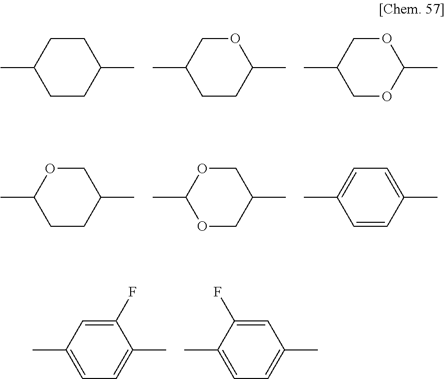

and even more preferably represent a trans-1,4-cyclohexylene group or a 1,4-phenylene group.

In the case where a response speed is regarded as being important, it is preferable that Z^{L1} and Z^{L2} are single bonds.

It is preferable that the number of halogen atoms that are present in a molecule of the compound represented by General Formula (L) is 0 or 1.

It is preferable that the compound represented by General Formula (L) is a compound selected from the group of compounds represented by General Formulas (L-1) to (L-7).

The compound represented by General Formula (L-1) is the following compound.

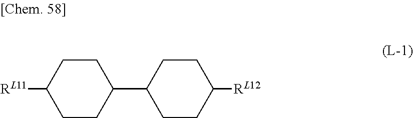

(In the formula, R^{L11} and R^{L12} each independently have the same definition as R^{L1} and R^{L2} in General Formula (L).)

R^{L11} and R^{L12} are preferably linear alkyl groups having 1 to 5 carbon atoms, linear alkoxy groups having 1 to 4 carbon atoms, and linear alkenyl groups having 2 to 5 carbon atoms.

The compound represented by General Formula (L-1) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

Lower limit values of preferable contents of the compound are 1%, 2%, 3%, 5%, 7%, 10%, 15%, 20%, 25%, 30%, 35%, 40%, 45%, 50%, and 55%, with respect to the total amount of the liquid crystal composition. Upper limit values of the preferable contents are 95%, 90%, 85%, 80%, 75%, 70%, 65%, 60%, 55%, 50%, 45%, 40%, 35%, 30%, and 25%, with respect to the total amount of the liquid crystal composition.

In the case where viscosity of the liquid crystal composition is maintained to be low, and a composition exhibiting a high response speed is required, it is preferable that the lower limit value and the upper limit value are high. In addition, in the case where Tni of the liquid crystal composition is maintained to be high, and a composition having good temperature stability is required, it is preferable that the lower limit value and the upper limit value are medium values. Furthermore, when dielectric anisotropy is desired to be increased in order to maintain a driving voltage to be low, it is preferable that the lower limit value and the upper limit value are low.

The compound represented by General Formula (L-1) is preferably a compound selected from the group of compounds represented by General Formula (L-1-1).

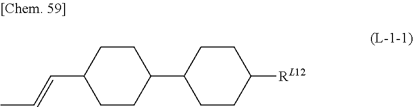

(In the formula, R^{L12} has the same definition as in General Formula (L-1).)

The compound represented by General Formula (L-1-1) is preferably a compound selected from the group of compounds represented by Formula (L-1-1.1) to Formula (L-1-1.3), preferably a compound represented by Formula (L-1-1.2) or Formula (L-1-1.3), and particularly preferably a compound represented by Formula (L-1-1.3).

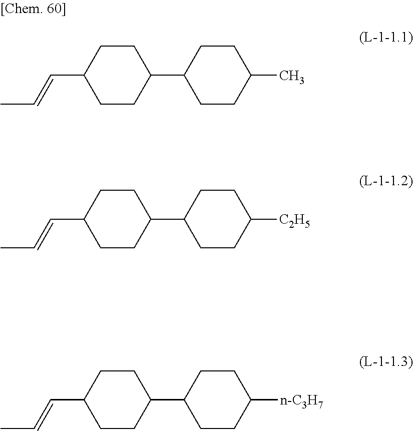

Lower limit values of preferable contents of the compound represented by Formula (L-1-1.3) are 1%, 2%, 3%, 5%, 7%, and 10%, with respect to the total amount of the liquid crystal composition. Upper limit values of the preferable contents are 20%, 15%, 13%, 10%, 8%, 7%, 6%, 5%, and 3%, with respect to the total amount of the liquid crystal composition.

The compound represented by General Formula (L-1) is preferably a compound selected from the group of compounds represented by General Formula (L-1-2).

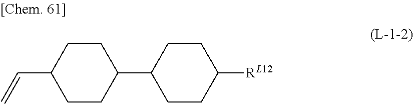

(In the formula, R^{L12} has the same definition as in General Formula (L-1).)

Lower limit values of preferable contents of the compound represented by Formula (L-1-2) are 1%, 5%, 10%, 15%, 17%, 20%, 23%, 25%, 27%, 30%, and 35%, with respect to the total amount of the liquid crystal composition. Upper limit values of the preferable contents are 60%, 55%, 50%, 45%, 42%, 40%, 38%, 35%, 33%, and 30%, with respect to the total amount of the liquid crystal composition.

The compound represented by General Formula (L-1-2) is preferably a compound selected from the group of compounds represented by Formula (L-1-2.1) to Formula (L-1-2.4) and preferably a compound represented by any one of Formula (L-1-2.2) to Formula (L-1-2.4). The compound represented by Formula (L-1-2.2) is particularly preferable, since the compound improves, in particular, the response speed of the liquid crystal composition. Furthermore, when Tni is required to be higher than the response speed, it is preferable to use a compound represented by Formula (L-1-2.3) or Formula (L-1-2.4). It is preferable that the contents of the compounds represented by Formula (L-1-2.3) and Formula (L-1-2.4) are not set to be 30% or more, in order to allow the solubility at a low temperature to be good.

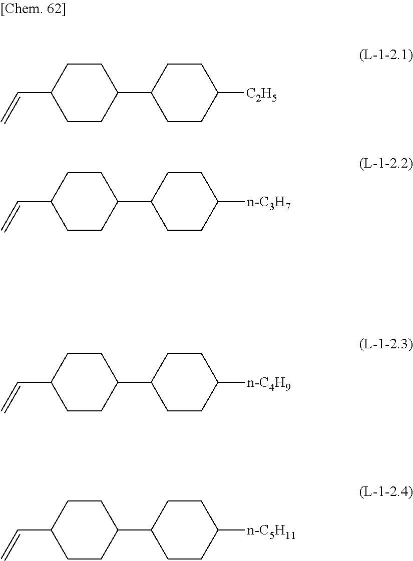

Lower limit values of preferable contents of the compound represented by Formula (L-1-2.2) are 10%, 15%, 18%, 20%, 23%, 25%, 27%, 30%, 33%, 35%, 38%, and 40%, with respect to the total amount of the liquid crystal composition. Upper limit values of the preferable contents are 60%, 55%, 50%, 45%, 43%, 40%, 38%, 35%, 32%, 30%, 27%, 25%, and 22%, with respect to the total amount of the liquid crystal composition.

Lower limit values of preferable total contents of the compound represented by Formula (L-1-1.3) and the compound represented by Formula (L-1-2.2) are 10%, 15%, 20%, 25%, 27%, 30%, 35%, and 40%, with respect to the total amount of the liquid crystal composition. Upper limit values of the preferable contents are 60%, 55%, 50%, 45%, 43%, 40%, 38%, 35%, 32%, 30%, 27%, 25%, and 22%, with respect to the total amount of the liquid crystal composition.

The compound represented by General Formula (L-1) is preferably a compound selected from the group of compounds represented by General Formula (L-1-3).

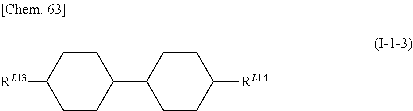

(In the formula, R^{L13} and R^{L14} each independently represent an alkyl group having 1 to 8 carbon atoms or an alkoxy group having 1 to 8 carbon atoms.)

R^{L13} and R^{L14} are preferably linear alkyl groups having 1 to 5 carbon atoms, linear alkoxy groups having 1 to 4 carbon atoms, and linear alkenyl groups having 2 to 5 carbon atoms.

Lower limit values of preferable contents of the compound represented by Formula (L-1-3) are 1%, 5%, 10%, 13%, 15%, 17%, 20%, 23%, 25%, and 30%, with respect to the total amount of the liquid crystal composition. Upper limit values of the preferable contents are 60%, 55%, 50%, 45%, 40%, 37%, 35%, 33%, 30%, 27%, 25%, 23%, 20%, 17%, 15%, 13%, and 10%, with respect to the total amount of the liquid crystal composition.

Furthermore, the compound represented by General Formula (L-1-3) is preferably a compound selected from the group of compounds represented by any one of Formula (L-1-3.1) to Formula (L-1-3.12) and preferably a compound represented by Formula (L-1-3.1), Formula (L-1-3.3), or Formula (L-1-3.4). The compound represented by Formula (L-1-3.1) is particularly preferable, since the compound improves, in particular, the response speed of the liquid crystal composition. Furthermore, when Tni is required to be higher than the response speed, it is preferable to use compounds represented by Formula (L-1-3.3), Formula (L-1-3.4), Formula (L-1-3.11), and Formula (L-1-3.12). It is preferable that the total content of the compounds represented by Formula (L-1-3.3), Formula (L-1-3.4), Formula (L-1-3.11), and Formula (L-1-3.12) is not set to be 20% or more, in order to allow the solubility at a low temperature to be good.

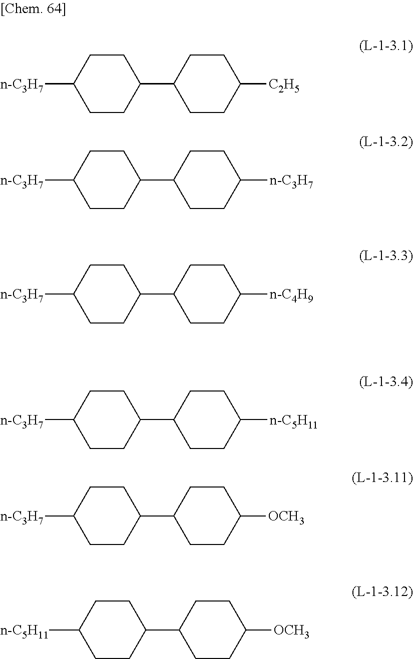

Lower limit values of preferable contents of the compound represented by Formula (L-1-3.1) are 1%, 2%, 3%, 5%, 7%, 10%, 13%, 15%, 18%, and 20%, with respect to the total amount of the liquid crystal composition. Upper limit values of the preferable contents are 20%, 17%, 15%, 13%, 10%, 8%, 7%, and 6%, with respect to the total amount of the liquid crystal composition.

The compound represented by General Formula (L-1) is preferably a compound selected from the group of compounds represented by General Formula (L-1-4) and/or (L-1-5).

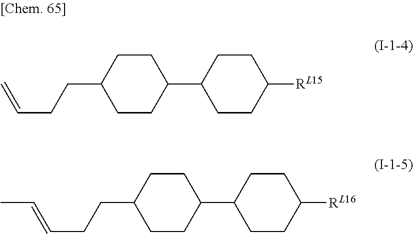

(In the formulas, R^{L15} and R^{L16} each independently represent an alkyl group having 1 to 8 carbon atoms or an alkoxy group having 1 to 8 carbon atoms.)

R^{L15} and R^{L16} are preferably linear alkyl groups having 1 to 5 carbon atoms, linear alkoxy groups having 1 to 4 carbon atoms, and linear alkenyl groups having 2 to 5 carbon atoms.

Lower limit values of preferable contents of the compound represented by Formula (L-1-4) are 1%, 5%, 10%, 13%, 15%, 17%, and 20%, with respect to the total amount of the liquid crystal composition. Upper limit values of the preferable contents are 25%, 23%, 20%, 17%, 15%, 13%, and 10%, with respect to the total amount of the liquid crystal composition.

Lower limit values of preferable contents of the compound represented by Formula (L-1-5) are 1%, 5%, 10%, 13%, 15%, 17%, and 20%, with respect to the total amount of the liquid crystal composition. Upper limit values of the preferable contents are 25%, 23%, 20%, 17%, 15%, 13%, and 10%, with respect to the total amount of the liquid crystal composition.

Furthermore, the compounds represented by General Formulas (L-1-4) and (L-1-5) are preferably compounds selected from the group of compounds represented by Formula (L-1-4.1) to Formula (L-1-5.3) and preferably compounds represented by Formula (L-1-4.2) or Formula (L-1-5.2).

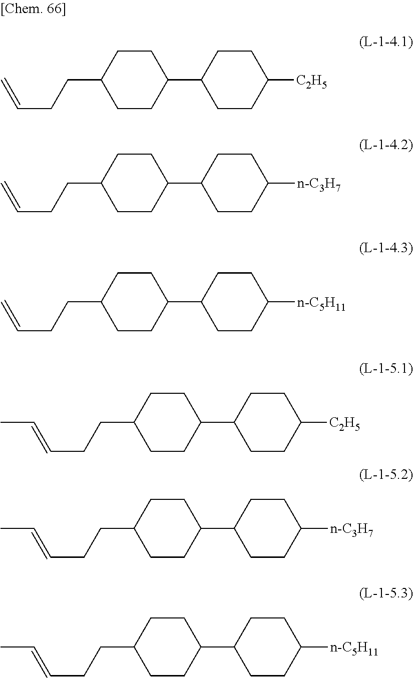

Lower limit values of preferable contents of the compound represented by Formula (L-1-4.2) are 1%, 2%, 3%, 5%, 7%, 10%, 13%, 15%, 18%, and 20%, with respect to the total amount of the liquid crystal composition. Upper limit values of the preferable contents are 20%, 17%, 15%, 13%, 10%, 8%, 7%, and 6%, with respect to the total amount of the liquid crystal composition.

A combination of two or more compounds selected from the compounds represented by Formula (L-1-1.3), Formula (L-1-2.2), Formula (L-1-3.1), Formula (L-1-3.3), Formula (L-1-3.4), Formula (L-1-3.11), and Formula (L-1-3.12) is preferable, and a combination of two or more compounds selected from the compounds represented by Formula (L-1-1.3), Formula (L-1-2.2), Formula (L-1-3.1), Formula (L-1-3.3), Formula (L-1-3.4), and Formula (L-1-4.2) is preferable. Lower limit values of preferable total contents of these compounds are 1%, 2%, 3%, 5%, 7%, 10%, 13%, 15%, 18%, 20%, 23%, 25%, 27%, 30%, 33%, and 35%, with respect to the total amount of the liquid crystal composition, and preferable upper limit values are 80%, 70%, 60%, 50%, 45%, 40%, 37%, 35%, 33%, 30%, 28%, 25%, 23%, and 20%, with respect to the total amount of the liquid crystal composition. In the case where reliability of the composition is regarded as being important, a combination of two or more compounds selected from the compounds represented by Formula (L-1-3.1), Formula (L-1-3.3), and Formula (L-1-3.4) is preferable, and in the case where a response speed of the composition is regarded as being important, a combination of two or more compounds selected from the compounds represented by Formula (L-1-1.3) and Formula (L-1-2.2) is preferable.

The compound represented by General Formula (L-2) is the following compound.

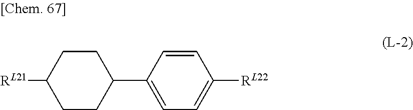

(In the formula, R^{L21} and R^{L22} each independently have the same definition as R^{L1} and R^{L2} in General Formula (L).)

R^{L21} is preferably an alkyl group having 1 to 5 carbon atoms or an alkenyl group having 2 to 5 carbon atoms, and R^{L22} is preferably an alkyl group having 1 to 5 carbon atoms, an alkenyl group having 4 or 5 carbon atoms, or an alkoxy group having 1 to 4 carbon atoms.

The compound represented by General Formula (L-1) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

In the case where the solubility at a low temperature is regarded as being important, the effect of having increased solubility at a low temperature is high when a content of the compound is set to be high. On the other hand, in the case where a response speed is regarded as being important, the effect of increasing the response speed is high when the content is set to be low. Furthermore, in the case of improving drop marks and burn-in characteristics, it is preferable to set the content to be in an intermediate range.

Lower limit values of preferable contents of the compound represented by Formula (L-2) are 1%, 2%, 3%, 5%, 7%, and 10%, with respect to the total amount of the liquid crystal composition. Upper limit values of the preferable contents are 20%, 15%, 13%, 10%, 8%, 7%, 6%, 5%, and 3%, with respect to the total amount of the liquid crystal composition.

Furthermore, the compound represented by General Formula (L-2) is preferably a compound selected from the group of compounds represented by Formula (L-2.1) to Formula (L-2.6) and preferably a compound represented by any one of Formula (L-2.1), Formula (L-2.3), Formula (L-2.4), and Formula (L-2.6).

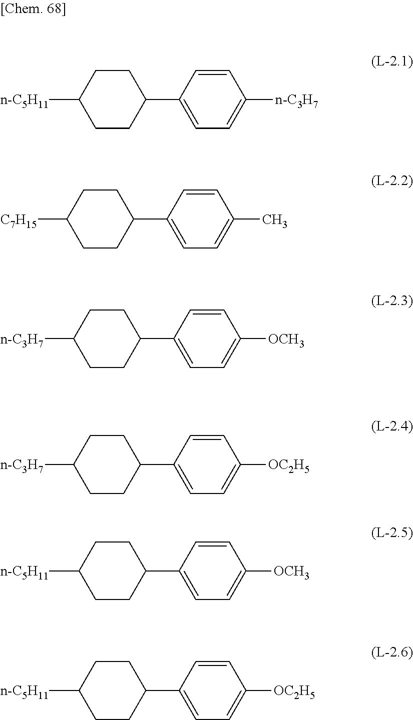

The compound represented by General Formula (L-3) is the following compound.

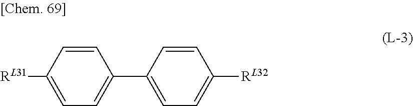

(In the formula, R^{L31} and R^{L32} each independently have the same definition as R^{L1} and R^{L2} in General Formula (L).)

R^{L31} and R^{L32} are each independently preferably an alkyl group having 1 to 5 carbon atoms, an alkenyl group having 4 or 5 carbon atoms, or an alkoxy group having 1 to 4 carbon atoms.

The compound represented by General Formula (L-3) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

Lower limit values of preferable contents of the compound represented by Formula (L-3) are 1%, 2%, 3%, 5%, 7%, and 10%, with respect to the total amount of the liquid crystal composition. Upper limit values of the preferable contents are 20%, 15%, 13%, 10%, 8%, 7%, 6%, 5%, and 3%, with respect to the total amount of the liquid crystal composition.

In the case of obtaining high birefringence index, the effect of obtaining high birefringence index is high when the content of the compound is set to be high. On the other hand, in the case where high Tni is regarded as being important, the effect of having increased Tni is high when the content is set to be low. Furthermore, in the case of improving drop marks and burn-in characteristics, it is preferable to set the content to be in an intermediate range.

Furthermore, the compound represented by General Formula (L-3) is preferably a compound selected from the group of compounds represented by Formula (L-3.1) to Formula (L-3.4) and is preferably a compound represented by any one of Formula (L-3.2) to Formula (L-3.7).

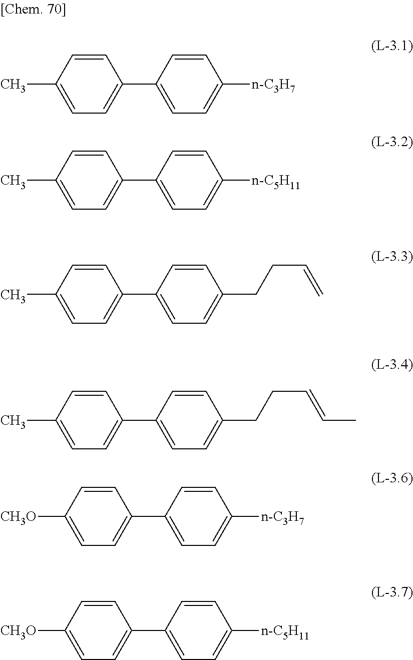

The compound represented by General Formula (L-4) is the following compound.

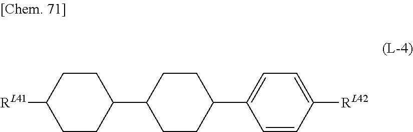

(In the formula, R^{L41} and R^{L42} each independently have the same definition as R^{L1} and R^{L2} in General Formula (L).)

R^{L41} is preferably an alkyl group having 1 to 5 carbon atoms or an alkenyl group having 2 to 5 carbon atoms, and R^{L42} is preferably an alkyl group having 1 to 5 carbon atoms, an alkenyl group having 4 or 5 carbon atoms, or an alkoxy group having 1 to 4 carbon atoms.

The compound represented by General Formula (L-4) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

A content of the compound represented by General Formula (L-4) in the liquid crystal composition needs to be suitably adjusted according to required performances, such as solubility at a low temperature, a transition temperature, electrical reliability, birefringence index, process adaptability, drop marks, burn-in, and dielectric anisotropy.

Lower limit values of preferable contents of the compound represented by Formula (L-4) are 1%, 2%, 3%, 5%, 7%, 10%, 14%, 16%, 20%, 23%, 26%, 30%, 35%, and 40%, with respect to the total amount of the liquid crystal composition. Upper limit values of the preferable contents of the compound represented by Formula (L-4) are 50%, 40%, 35%, 30%, 20%, 15%, 10%, and 5%, with respect to the total amount of the liquid crystal composition.

The compound represented by General Formula (L-4) is, for example, preferably a compound represented by any one of Formula (L-4.1) to Formula (L-4.3).

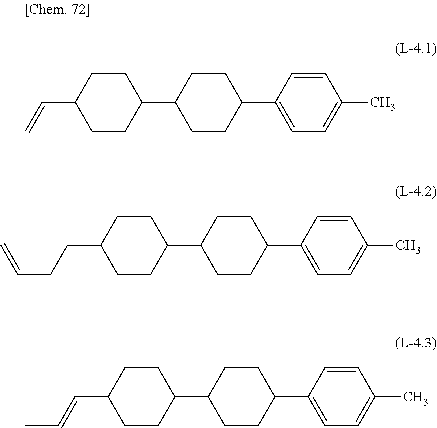

According to required performances such as solubility at a low temperature, a transition temperature, electrical reliability, and birefringence index, the composition may include the compound represented by Formula (L-4.1), may include the compound represented by Formula (L-4.2), may include both of the compound represented by Formula (L-4.1) and the compound represented by Formula (L-4.2), and may include all of the compounds represented by Formula (L-4.1) to Formula (L-4.3). Lower limit values of preferable contents of the compound represented by Formula (L-4.1) or Formula (L-4.2) are 3%, 5%, 7%, 9%, 11%, 12%, 13%, 18%, and 21%, with respect to the total amount of the liquid crystal composition, and preferable upper limit values are 45, 40%, 35%, 30%, 25%, 23%, 20%, 18%, 15%, 13%, 10%, and 8%.

In the case where the composition includes both of the compound represented by Formula (L-4.1) and the compound represented by Formula (L-4.2), lower limit values of preferable contents of both of the compounds are 15%, 19%, 24%, and 30%, with respect to the total amount of the liquid crystal composition, and preferable upper limit values are 45, 40%, 35%, 30%, 25%, 23%, 20%, 18%, 15%, and 13%.

The compound represented by General Formula (L-4) is, for example, preferably a compound represented by any one of Formula (L-4.4) to Formula (L-4.6) and preferably a compound represented by Formula (L-4.4).

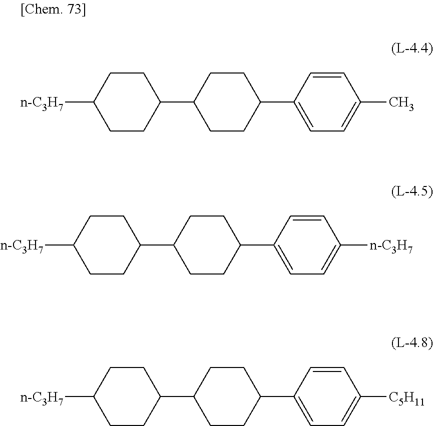

According to required performances such as solubility at a low temperature, a transition temperature, electrical reliability, and birefringence index, the composition may include the compound represented by Formula (L-4.4), may include the compound represented by Formula (L-4.5), and may include both of the compound represented by Formula (L-4.4) and the compound represented by Formula (L-4.5).

Lower limit values of preferable contents of the compound represented by Formula (L-4.4) or Formula (L-4.5) are 3%, 5%, 7%, 9%, 11%, 12%, 13%, 18%, and 21%, with respect to the total amount of the liquid crystal composition. Preferable upper limit values are 45, 40%, 35%, 30%, 25%, 23%, 20%, 18%, 15%, 13%, 10%, and 8%.

In the case where the composition includes both of the compound represented by Formula (L-4.4) and the compound represented by Formula (L-4.5), lower limit values of preferable contents of both of the compounds are 15%, 19%, 24%, and 30%, with respect to the total amount of the liquid crystal composition, and preferable upper limit values are 45, 40%, 35%, 30%, 25%, 23%, 20%, 18%, 15%, and 13%.

The compound represented by General Formula (L-4) is preferably a compound represented by any one of Formula (L-4.7) to Formula (L-4.10) and particularly preferably a compound represented by Formula (L-4.9).

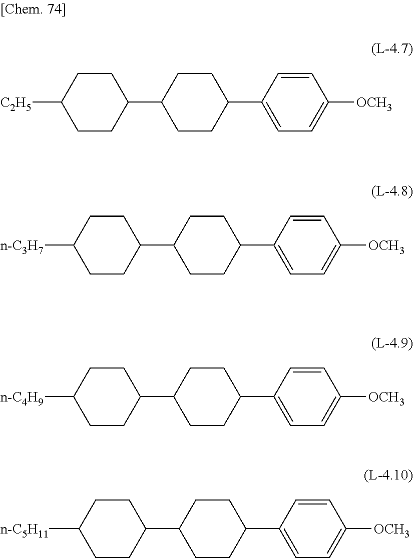

The compound represented by General Formula (L-5) is the following compound.

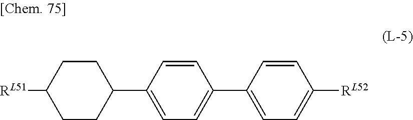

(In the formula, R^{L51} and R^{L52} each independently have the same definition as R^{L1} and R^{L2} in General Formula (L).)

R^{L51} is preferably an alkyl group having 1 to 5 carbon atoms or an alkenyl group having 2 to 5 carbon atoms, and R^{L52} is preferably an alkyl group having 1 to 5 carbon atoms, an alkenyl group having 4 or 5 carbon atoms, or an alkoxy group having 1 to 4 carbon atoms.

The compound represented by General Formula (L-5) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

A content of the compound represented by General Formula (L-5) in the liquid crystal composition needs to be suitably adjusted according to required performances, such as solubility at a low temperature, a transition temperature, electrical reliability, birefringence index, process adaptability, drop marks, burn-in, and dielectric anisotropy.

Lower limit values of preferable contents of the compound represented by Formula (L-5) are 1%, 2%, 3%, 5%, 7%, 10%, 14%, 16%, 20%, 23%, 26%, 30%, 35%, and 40%, with respect to the total amount of the liquid crystal composition. Upper limit values of the preferable contents of the compound represented by Formula (L-5) are 50%, 40%, 35%, 30%, 20%, 15%, 10%, and 5%, with respect to the total amount of the liquid crystal composition.

The compound represented by General Formula (L-5) is preferably a compound represented by Formula (L-5.1) or Formula (L-5.2) and particularly preferably a compound represented by Formula (L-5.1).

Lower limit values of preferable contents of these compounds are 1%, 2%, 3%, 5%, and 7%, with respect to the total amount of the liquid crystal composition. Upper limit values of the preferable contents of these compounds are 20%, 15%, 13%, 10%, and 9%.

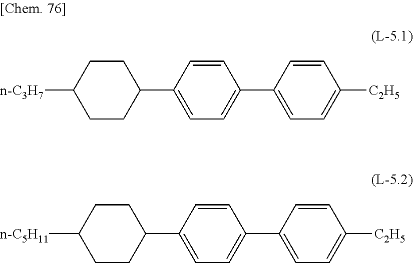

The compound represented by General Formula (L-5) is preferably a compound represented by Formula (L-5.3) or Formula (L-5.4).

Lower limit values of preferable contents of these compounds are 1%, 2%, 3%, 5%, and 7%, with respect to the total amount of the liquid crystal composition. Upper limit values of the preferable contents of these compounds are 20%, 15%, 13%, 10%, and 9%.

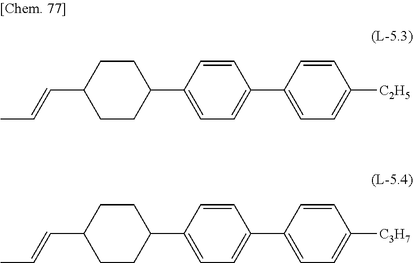

The compound represented by General Formula (L-5) is preferably a compound selected from the group of compounds represented by Formula (L-5.5) to Formula (L-5.7) and particularly preferably a compound represented by Formula (L-5.7).

Lower limit values of preferable contents of these compounds are 1%, 2%, 3%, 5%, and 7%, with respect to the total amount of the liquid crystal composition. Upper limit values of the preferable contents of these compounds are 20%, 15%, 13%, 10%, and 9%.

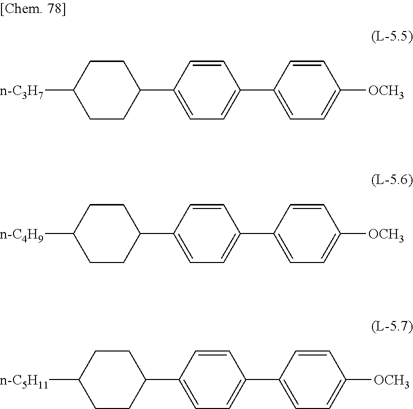

The compound represented by General Formula (L-6) is the following compound.

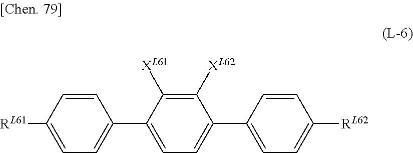

(In the formula, R^{L61} and R^{L62} Z each independently have the same definition as R^{L1} and R^{L2} in General Formula (L); and X^{L61} and X^{L62} each independently represent a hydrogen atom or a fluorine atom.)

R^{L61} and R^{L62} are each independently preferably an alkyl group having 1 to 5 carbon atoms or an alkenyl group having 2 to 5 carbon atoms, and it is preferable that one of X^{L61} and X^{L62} is a fluorine atom, and the other one is a hydrogen atom.

The compound represented by General Formula (L-6) can be used alone, or two or more compounds can be used in combination. The kinds of the compounds that can be combined are not particularly limited, and the compounds are used by being suitably combined according to required performances, such as solubility at a low temperature, a transition temperature, electrical reliability, and birefringence index. The number of the kinds of the compound that is used is, for example, one kind, two kinds, three kinds, four kinds, or five or more kinds, as one embodiment of the present invention.

Lower limit values of preferable contents of the compound represented by Formula (L-6) are 1%, 2%, 3%, 5%, 7%, 10%, 14%, 16%, 20%, 23%, 26%, 30%, 35%, and 40%, with respect to the total amount of the liquid crystal composition. Upper limit values of the preferable contents of the compound represented by Formula (L-6) are 50%, 40%, 35%, 30%, 20%, 15%, 10%, and 5%, with respect to the total amount of the liquid crystal composition. In the case of focusing on increasing Δn, it is preferable that the content of the compound is high, and in the case of focusing on precipitating at a low temperature, it is preferable that the content of the compound is low.

The compound represented by General Formula (L-6) preferably a compound represented by any one of Formula (L-6.1) to Formula (L-6.9).

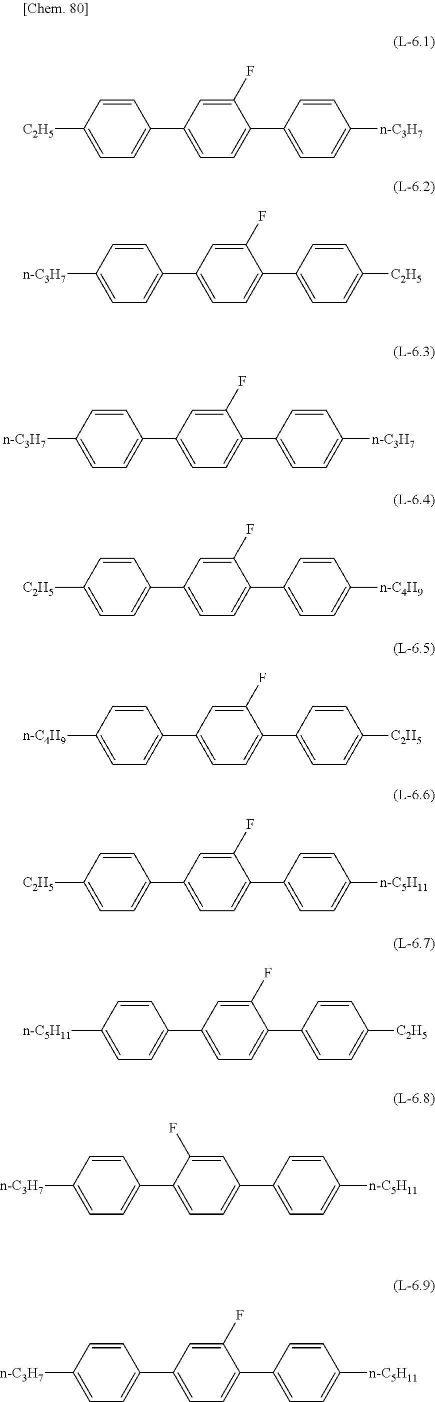

The kinds of the compounds that can be combined are not particularly limited, and it is preferable that the composition includes one to three kinds of these compounds and more preferably includes one to four kinds of these compounds. In addition, since wide molecular weight distribution of the selected compounds also has an effect on solubility, it is preferable to select, for example, one compound from the compounds represented by Formula (L-6.1) and (L-6.2), one compound from the compounds represented by Formula (L-6.4) and (L-6.5), one compound from the compounds represented by Formula (L-6.6) and (L-6.7), and one compound from the compounds represented by Formula (L-6.8) and (L-6.9) and suitably combine these compounds. Among these, the composition preferably includes the compounds represented by Formula (L-6.1), Formula (L-6.3), Formula (L-6.4), Formula (L-6.6), and Formula (L-6.9).

Furthermore, the compound represented by General Formula (L-6) is, for example, preferably a compound represented by any one of Formula (L-6.10) to Formula (L-6.17), and among these, a compound represented by Formula (L-6.11) is preferable.

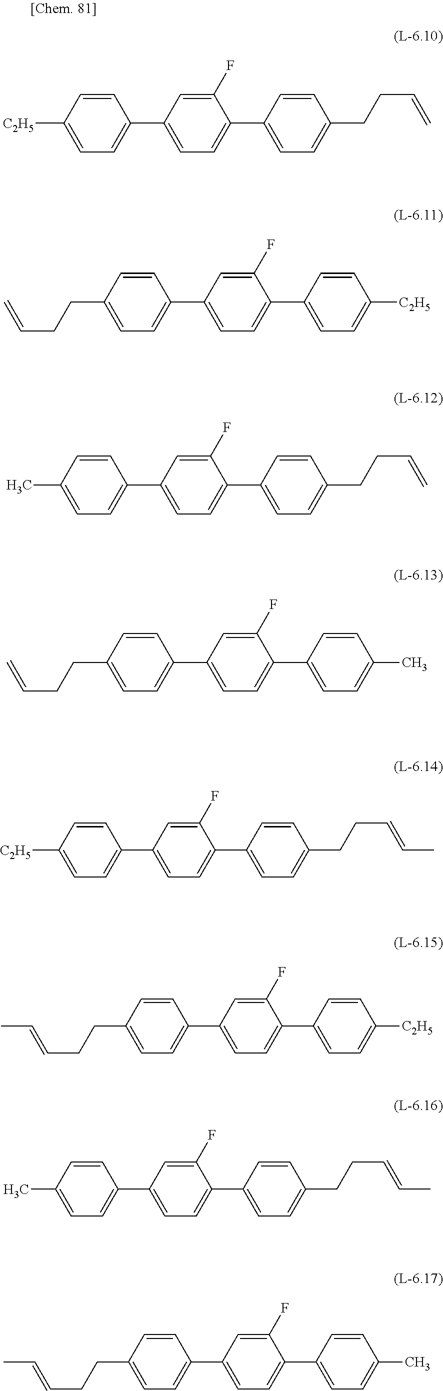

Lower limit values of preferable contents of these compounds are 1%, 2%, 3%, 5%, and 7%, with respect to the total amount of the liquid crystal composition. Upper limit values of the preferable contents of these compounds are 20%, 15%, 13%, 10%, and 9%.

The compound represented by General Formula (L-7) is the following compound.

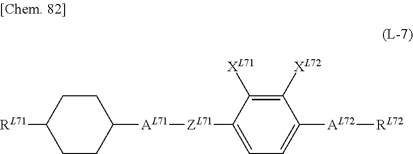

(In the formula, R^{L71} and R^{L72} each independently have the same definition as R^{L1} and R^{L2} in General Formula (L); A^{L71} and A^{L72} each independently have the same definition as A^{L2} and A^{L3} in General Formula (L), and hydrogen atoms on A^{L71} and A^{L72} may each independently be substituted with a fluorine atom; Z^{L71} have the same definition as Z^{L2} in General Formula (L); and X^{L71} and X^{L72} each independently represent a fluorine atom or a hydrogen atom.)

In the formula, R^{L71} and R^{L72} are each independently preferably an alkyl group having 1 to 5 carbon atoms, an alkenyl group having 2 to 5 carbon atoms, or an alkoxy group having 1 to 4 carbon atoms. A^{L71} and A^{L72} are each independently preferably a 1,4-cyclohexylene group or a 1,4-phenylene group, and hydrogen atoms on A^{L71} and A^{L72} may each independently be substituted with a fluorine atom. Q^{L71} is preferably a single bond or COO— and preferably a single bond. X^{L71} and X^{L72} are preferably hydrogen atoms.

The kinds of the compounds that can be combined are not particularly limited, and the compounds are combined according to required performances, such as solubility at a low temperature, a transition temperature, electrical reliability, and birefringence index. The number of the kinds of the compound that is used is, for example, one kind, two kinds, three kinds, or four kinds, as one embodiment of the present invention.

A content of the compound represented by General Formula (L-7) in the liquid crystal composition needs to be suitably adjusted according to required performances, such as solubility at a low temperature, a transition temperature, electrical reliability, birefringence index, process adaptability, drop marks, burn-in, and dielectric anisotropy.

Lower limit values of preferable contents of the compound represented by Formula (L-7) are 1%, 2%, 3%, 5%, 7%, 10%, 14%, 16%, and 20%, with respect to the total amount of the liquid crystal composition. Upper limit values of the preferable contents of the compound represented by Formula (L-7) are 30%, 25%, 23%, 20%, 18%, 15%, 10%, and 5%, with respect to the total amount of the liquid crystal composition.

In the case where an embodiment in which Tni of the liquid crystal composition is high is desired, it is preferable that the content of the compound represented by Formula (L-7) is high, and in the case where an embodiment in which viscosity is low is desired, it is preferable that the content of the compound is low.

Furthermore, the compound represented by General Formula (L-7) is preferably a compound represented by any one of Formula (L-7.1) to Formula (L-7.4) and preferably a compound represented by Formula (L-7.2).

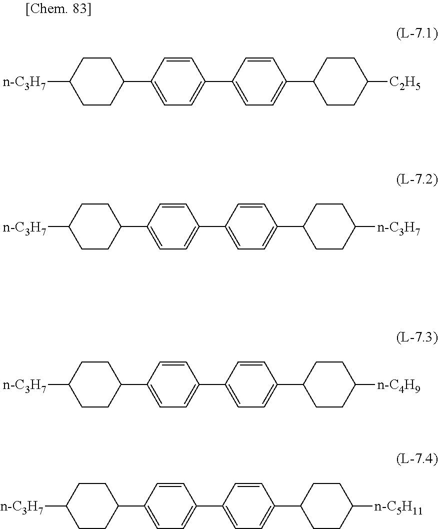

Furthermore, the compound represented by General Formula (L-7) is preferably a compound represented by any one of Formula (L-7.11) to Formula (L-7.13) and preferably a compound represented by Formula (L-7.11).

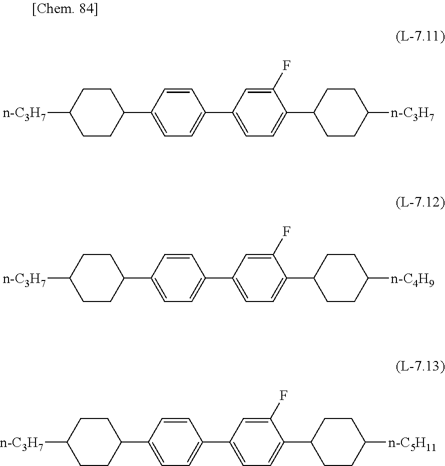

In addition, the compound represented by General Formula (L-7) is a compound represented by any one of Formula (L-7.21) to Formula (L-7.23). The compound is preferably a compound represented by Formula (L-7.21).

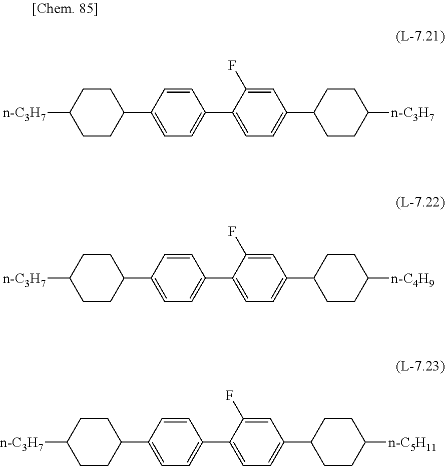

Furthermore, the compound represented by General Formula (L-7) is preferably a compound represented by any one of Formula (L-7.31) to Formula (L-7.34) and preferably a compound represented by Formula (L-7.31) or/and Formula (L-7.32).

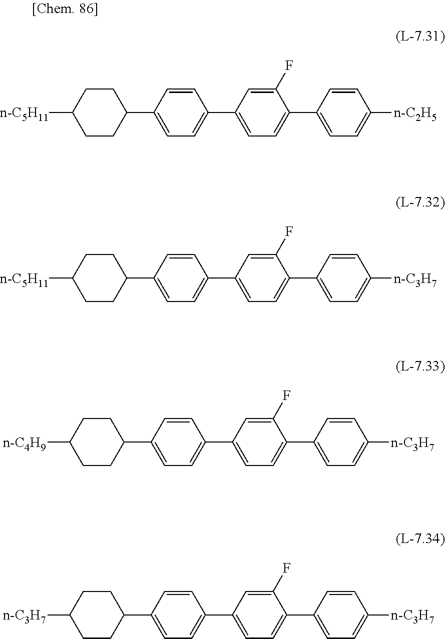

Furthermore, the compound represented by General Formula (L-7) is preferably a compound represented by any one of Formula (L-7.41) to Formula (L-7.44) and preferably a compound represented by Formula (L-7.41) or/and Formula (L-7.42).

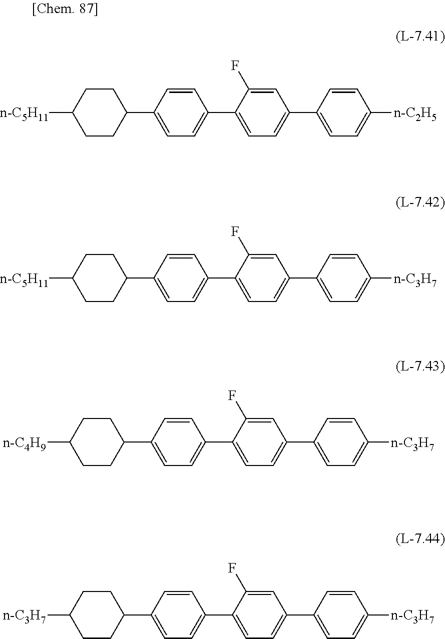

Lower limit values of preferable total contents of the compounds represented by General Formula (i), General Formula (ii), and General Formulas (L) and (N) are 80%, 85%, 88%, 90%, 92%, 93%, 94%, 95%, 96%, 97%, 98%, 99%, and 100%, with respect to the total amount of the liquid crystal composition. Upper limit values of the preferable contents of the compounds are 100%, 99%, 98%, and 95%.

Lower limit values of preferable total contents of the compounds represented by General Formula (i), General Formula (ii), and General Formulas (L-1) to (L-7) are 80%, 85%, 88%, 90%, 92%, 93%, 94%, 95%, 96%, 97%, 98%, 99%, and 100%, with respect to the total amount of the liquid crystal composition. Upper limit values of the preferable total contents are 100%, 99%, 98%, and 95%.

It is preferable that the liquid crystal composition does not include a compound having a structure in which oxygen atoms are bonded to each other, such as a peracid (—CO—OO—) structure, in the molecule thereof.

In the case where reliability and long-term stability of the liquid crystal composition are regarded as being important, a content of a compound having a carbonyl group is preferably 5% or less, more preferably 3% or less, and even more preferably 1% or less, with respect to the total mass of the composition, and it is most preferable that the composition substantially does not include the compound.

In the case where stability against UV irradiation is regarded as being important, a content of a chlorine atom-substituted compound is preferably 15% or less, preferably 10% or less, preferably 8% or less, more preferably 5% or less, and preferably 3% or less, with respect to the total mass of the composition, and it is even more preferable that the composition substantially does not include the compound.

It is preferable that a content of a compound in which all of the ring structures in the molecule thereof are 6-membered rings is high. The content of the compound in which all of the ring structures in the molecule thereof are 6-membered rings is preferably 80% or more, more preferably 90% or more, and even more preferably 95% or more, with respect to the total mass of the composition, and it is most preferable that the composition is substantially only constituted of the compound in which all of the ring structures in the molecule thereof are 6-membered rings.

In order to suppress degradation of the liquid crystal composition by oxidation, it is preferable that a content of a compound having a cyclohexenylene group as a ring structure is low. The content of the compound having a cyclohexenylene group is preferably 10% or less, preferably 8% or less, more preferably 5% or less, and preferably 3% or less, with respect to the total mass of the composition, and it is even more preferable that the composition substantially does not include the compound.

In the case where improvement of viscosity and improvement of Tni are regarded as being important, it is preferable that a content of a compound having a 2-methylbenzene-1,4-diyl group, in which an arbitrary hydrogen atom may be substituted with halogen, in the molecule thereof is low. The content of the compound having the 2-methylbenzene-1,4-diyl group in the molecule thereof is preferably 10% or less, preferably 8% or less, more preferably 5% or less, and preferably 3% or less, with respect to the total mass of the composition, and it is even more preferable that the composition substantially does not include the compound.

In the present specification, the expression that a substance “is substantially not included” means that the substance is not included, except for the substance that is unintentionally included.

In the case where a compound contained in the liquid crystal composition has an alkenyl group as a side chain, it is preferable that the alkenyl group has 2 to 5 carbon atoms, in the case where the alkenyl group is bonded to cyclohexane, it is preferable that the alkenyl group has 4 or 5 carbon atoms, in the case where the alkenyl group is bonded to benzene, and it is preferable that an unsaturated bond of the alkenyl group is not directly bonded to benzene.

A preferable liquid crystal composition (n-type liquid crystal composition), which serves as an object for measuring K₂₂ in the present invention has been described so far.

The liquid crystal composition of the present invention is preferably a liquid crystal composition which has a negative value of dielectric anisotropy (Δε) and is designed using a method for measuring an elastic constant of the liquid crystal composition and a device for measuring an elastic constant of the liquid crystal composition. Examples of the liquid crystal composition of the present invention include the same composition as an n-type liquid crystal composition to which the method for measuring an elastic constant of the liquid crystal composition is applied.

The liquid crystal composition of the present invention is an n-type liquid crystal composition serving as an object for applying the elastic constant measurement method, and the composition may further include a polymerizable compound.

Examples of the polymerizable compound that can be used include a photopolymerizable monomer which proceeds polymerization by an energy ray such as light. Examples of the structure of the polymerizable compound include a polymerizable compound having a liquid crystal skeleton in which a plurality of six-membered rings are linked, such as a biphenyl derivative and a terphenyl derivative. More specifically, the compound is preferably a bifunctional monomer represented by General Formula (XX)

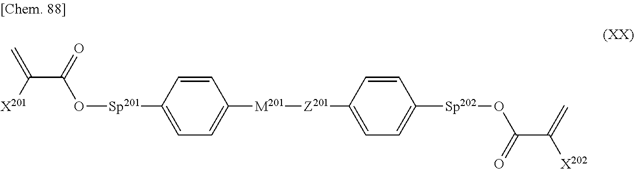

(in the formula, X²⁰¹ and X²⁰² each independently represent a hydrogen atom or a methyl group; Sp²⁰¹ and Sp²⁰² are each independently preferably a single bond, an alkylene group having 1 to 8 carbon atoms, or —O—(CH₂)ₛ— (in the formula, s represents an integer of 2 to 7, and the oxygen atom is bonded to an aromatic ring); Z²⁰¹ represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH═CH₂—COO—, —CH₂CH₂—OCO—, —COO—CH₂—, —OCO—CH₂—, —CH₂—COO—, —CH₂—OCO—, —CY¹═CY²— (in the formula, Y¹ and Y² each independently represent a fluorine atom or a hydrogen atom), —C≡C—, or a single bond; M²⁰¹ represents a 1,4-phenylene group, a trans-1,4-cyclohexylene group, or a single bond; and any hydrogen atom of all of the 1,4-phenylene groups in the formula may be substituted with a fluorine atom).

The bifunctional monomer represented by General Formula (XX) can be used alone or can be used by being mixed. A content of the monomer is preferably 0.001% to 5%, preferably 0.01% to 3%, preferably 0.05% to 2%, preferably 0.08% to 1%, and particularly preferably 0.1% to 0.5%.

A diacrylate derivative in which both of X²⁰¹ and X²⁰² represent hydrogen atoms and a dimethacrylate derivative in which both of X²⁰¹ and X²⁰² have methyl groups are preferable. A compound in which one of X²⁰¹ and X²⁰² represents a hydrogen atom, and the other one represents a methyl group is also preferable. Regarding polymerization rates of these compounds, the polymerization rate of a diacrylate derivative is highest, the polymerization rate of a dimethacrylate derivative is lower, and the polymerization rate of an asymmetric compound is intermediate. It is possible to use a form that is preferred according to the purpose. In a PSA display element, a dimethacrylate derivative is particularly preferable.

Sp²⁰¹ and Sp²⁰² each independently represent a single bond, an alkylene group having 1 to 8 carbon atoms, or —O—(CH₂)ₛ—, and in a PSA display element, it is preferable that at least one of Sp²⁰¹ and Sp²⁰² is a single bond, and a compound in which both of Sp²⁰¹ and Sp²⁰² represents single bonds or a form in which one of Sp²⁰¹ and Sp²⁰² represents a single bond and the other one represents an alkylene group having 1 to 8 carbon atoms or —O—(CH₂)ₛ— is preferable. In this case, 1 to 4 alkyl groups are preferable, and s is preferably 1 to 4.

Z²⁰¹ is preferably —OCH₂—, —CH₂O—, —COO—, —OCO—, —CF₂O—, —OCF₂—, —CH₂CH₂—, —CF₂CF₂—, or a single bond, more preferably —COO—, —OCO—, or a single bond, and particularly preferably a single bond.

M²⁰¹ represents a 1,4-phenylene group in which an arbitrary hydrogen atom may be substituted with a fluorine atom, a trans-1,4-cyclohexylene group in which an arbitrary hydrogen atom may be substituted with a fluorine atom, or a single bond, and a 1,4-phenylene group or a single bond is preferable. In the case where C represents a ring structure other than a single bond, Z²⁰¹ is preferably a linking group other than a single bond, and in the case where M²⁰¹ is a single bond, Z²⁰¹ is preferably a single bond.

In view of these points, the ring structure between Sp²⁰¹ and Sp²⁰² in General Formula (XX) is specifically preferably the structure described below.

In General Formula (XX), in the case where M²⁰¹ represents a single bond, and the ring structure is formed by two rings, the ring structure is preferably represented by Formula (XXa-1) to Formula (XXa-5), more preferably represented by Formula (XXa-1) to Formula (XXa-3), and particularly preferably represented by Formula (XXa-1).

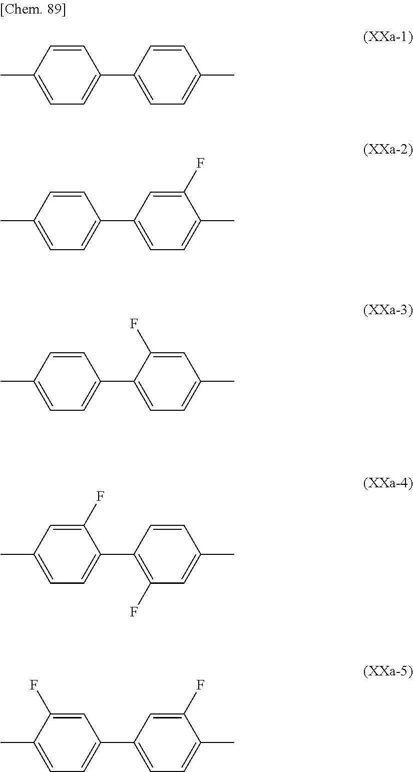

(In the formulas, both terminals are bonded to Sp²⁰¹ or Sp²⁰².)

After the polymerizable compound having such skeleton is polymerized, alignment restraining force becomes optimal in the liquid crystal display element, and a favorable alignment state is obtained. Thus, display unevenness is suppressed or is not generated at all.

For the above reasons, as the polymerizable monomer, General Formula (XX-1) to General Formula (XX-4) are particularly preferable, and among these, General Formula (XX-2) is most preferable.

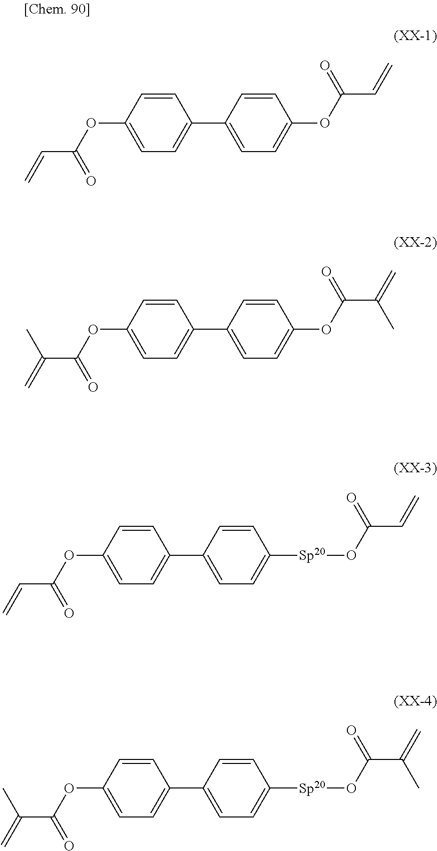

(In the formulas, Sp²⁰ represents an alkylene group having 2 to 5 carbon atoms.)

In the case where a monomer is added to the liquid crystal composition, the polymerization proceeds even in the absence of a polymerization initiator, however, the composition may contain a polymerization initiator in order to promote the polymerization. Examples of the polymerization initiator include benzoin ethers, benzophenones, acetophenones, benzyl ketals, acylphosphine oxides, and the like.

As a method for polymerizing the polymerizable compound, a method of polymerizing by irradiation of the compound with an active energy ray such as an ultraviolet ray and an electron beam alone, in combination, or in series is preferable, since a moderate polymerization rate is desired in order to obtain a favorable alignment performance of a liquid crystal. In the case of using an ultraviolet ray, a polarized light source may be used, or a non-polarized light source may be used. In the case where polymerization is performed in a state in which a polymerizable compound-containing composition is interposed between two substrates, transparency adequate for the active energy ray has to be imparted at least on the substrate on the irradiation side. Furthermore, means for polymerizing only a specific part using a mask during light irradiation, then changing the alignment state of the non-polymerized portion by changing conditions such as an electric field or a magnetic field or a temperature, and further carrying out polymerization by irradiation with an active energy ray may also be used. In particular, when exposing to an ultraviolet ray, it is preferable to expose the polymerizable compound-containing composition to the ultraviolet ray while applying an AC electric field. The applied AC electric field is preferably an alternating current having a frequency of 10 Hz to 10 kHz and more preferably having a frequency of 60 Hz to 10 kHz. Voltage is selected according to a desired pretilt angle of the liquid crystal display element. That is, the pretilt angle of the liquid crystal display element can be controlled by the applied voltage. In a PSA liquid crystal display element, from the viewpoints of alignment stability and contrast, the pretilt angle is preferably controlled to be 80 degrees to 89.9 degrees.

The temperature during the irradiation is preferably within a temperature range at which the liquid crystal state of the liquid crystal composition is maintained. The polymerization is preferably performed at a temperature near room temperature, that is, typically at 15° C. to 35° C. As a lamp that generates an ultraviolet ray, a metal halide lamp, a high-pressure mercury lamp, an ultra high-pressure mercury lamp, and the like can be used. Regarding the wavelength of the ultraviolet ray that is radiated, it is preferable that an ultraviolet ray in a wavelength region outside an absorption wavelength region of the composition is radiated, and the ultraviolet ray is preferably used by being cut, as necessary. Strength of the ultraviolet ray that is radiated is preferably 0.1 mW/cm² to 100 W/cm² and more preferably 2 mW/cm² to 50 W/cm². An amount of energy of the ultraviolet ray that is radiated can be suitably adjusted, and the amount of energy is preferably 10 mJ/cm² to 500 J/cm² and more preferably 100 mJ/cm² to 200 J/cm². The strength may be changed during the irradiation with an ultraviolet ray. The duration of the irradiation with an ultraviolet ray is suitably selected according to the strength of the ultraviolet ray that is radiated, and the duration is preferably 10 seconds to 3600 seconds and more preferably 10 seconds to 600 seconds.

The liquid crystal composition of the present invention may further include a compound represented by General Formula (Q).

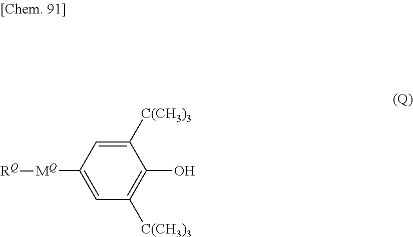

(In the formula, R^{Q} represents a linear alkyl group or a branched alkyl group having 1 to 22 carbon atoms, and one or two or more CH₂ groups in the alkyl group may be substituted with —O—, —CH═CH—, —CO—, —OCO—, —COO—, —C≡C—, —CF₂O—, or —OCF₂—, such that oxygen atoms are not directly adjacent to each other; and M^{Q} represents a trans-1,4-cyclohexylene group, a 1,4-phenylene group, or a single bond.)

R^{Q} represents a linear alkyl group or a branched alkyl group having 1 to 22 carbon atoms, and one or two or more CH₂ groups in the alkyl group may be substituted with —O—, —CH═CH—, —CO—, —OCO—, —COO—, —C≡C—, —CF₂O—, or —OCF₂—, such that oxygen atoms are not directly adjacent to each other. A linear alkyl group having 1 to 10 carbon atoms, a linear alkoxy group, a linear alkyl group whose one CH₂ group is substituted with —OCO— or —COO—, a branched alkyl group, a branched alkoxy group, and a branched alkyl group whose one CH₂ group is substituted with —OCO— or —COO— are preferable, and a linear alkyl group having 1 to 20 carbon atoms, a linear alkyl group whose one CH₂ group is substituted with —OCO— or —COO—, a branched alkyl group, a branched alkoxy group, and a branched alkyl group whose one CH₂ group is substituted with —OCO— or —COO— are more preferable. M^{Q} represents a trans-1,4-cyclohexylene group, a 1,4-phenylene group, or a single bond, and a trans-1,4-cyclohexylene group or a 1,4-phenylene group is preferable.

More specifically, the compound represented by General Formula (Q) is preferably a compound represented by any one of General Formula (Q-a) to General Formula (Q-d).

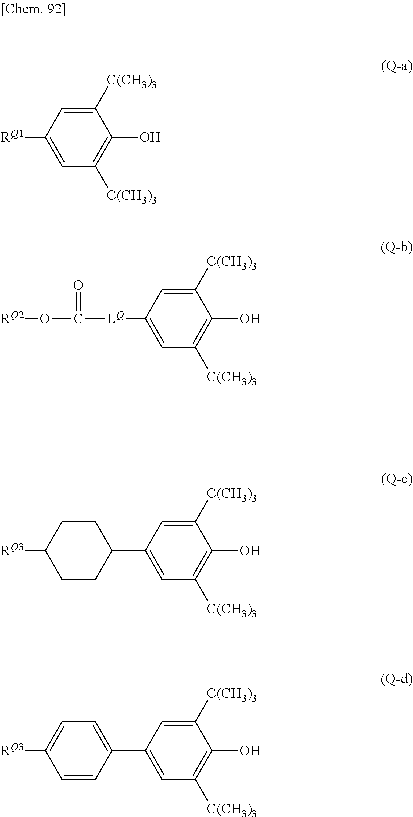

In the formulas, R^{Q1} is preferably a linear alkyl group or a branched alkyl group having 1 to 10 carbon atoms, R^{Q2} is preferably a linear alkyl group or a branched alkyl group having 1 to 20 carbon atoms, R^{a3} is preferably a linear alkyl group, a branched alkyl group, a linear alkoxy group, or a branched alkoxy group having 1 to 8 carbon atoms, and L is preferably a linear alkylene group or a branched alkylene group having 1 to 8 carbon atoms. Among the compounds represented by General Formula (Q-a) to General Formula (Q-d), the compounds represented by General Formula (Q-c) and General Formula (Q-d) are more preferable.

The liquid crystal composition preferably includes one or two compounds represented by General Formula (Q) and more preferably includes one to five compounds represented by General Formula (Q). A content of the compound represented by General Formula (Q) is preferably 0.001% to 1%, more preferably 0.001% to 0.1%, and particularly preferably 0.001% to 0.05%.

The Γ value of the liquid crystal composition of the present invention obtained from Equation (2) defined using K₁₁, K₂₂, and K₃₃ is 0.28 or less. Light transmittance of the liquid crystal composition of the present invention can be improved by causing the K₂₂ value to be relatively small by using the values of K₁₁ and K₃₃, in addition to simply decreasing the value (absolute value) of K₂₂. The Γ value being 0.28 or less will be specified in Examples described below.

In general, as the Γ value of the liquid crystal composition becomes smaller, light transmittance tends to be improved, and the driving voltage (V₁₀₀ voltage) tends to be lowered. On the contrary, as the Γ value becomes greater, the light transmittance tends to be lowered, and the driving voltage (V₁₀₀ voltage) tends to be increased.

Accordingly, in the liquid crystal composition, the Γ value is preferably 0.01 or more, more preferably 0.05 or more, even more preferably 0.1 or more, and particularly preferably 0.2 or more. By setting the Γ value to be equal to or greater than the lower limit value, the driving voltage of the liquid crystal display element is not significantly lowered, and the light transmittance is further improved.

As the Γ value of the liquid crystal composition becomes greater, response time can also be improved. From the viewpoint of improving the response time, the Γ value is preferably 0.01 or more, more preferably 0.05 or more, even more preferably 0.1 or more, and particularly preferably 0.2 or more, similarly to the case of the transmittance.

Meanwhile, the Γ value of the liquid crystal composition may be 0.28 or less. For example, the Γ value can be 0.27 or less, 0.26 or less, and the like.

By performing simulation using the elastic constants (K₁₁, K₂₂, and K₃₃) characteristic to a liquid crystal composition, whether the composition has the desired characteristic or not can be predicted. Such method is extremely useful in designing a liquid crystal composition.

However, when driving the n-type liquid crystal composition, depending on the position at which the molecules are present in the cell, the magnitude and direction of the force applied on liquid crystal molecules vary, and the size and direction of interaction between adjacent liquid crystal molecules vary. Therefore, in the case where only some of the elastic constants (K₁₁, K₂₂, and K₃₃) are considered, or an elastic constant (particularly K₂₂) with a large error is used, the characteristics of the liquid crystal composition cannot be predicted with high accuracy. From this viewpoint, methods of the related art were inadequate.

On the other hand, the liquid crystal composition of the present invention is designed based on highly accurate elastic constants including K₂₂, the predicted characteristics are highly accurate, and design accuracy is extremely high.

<<Liquid Crystal Display Element>>

A liquid crystal display element of the present invention uses the liquid crystal composition of the present invention, and examples thereof include a VA type liquid crystal display element including a cell that is the same as the cell shown in FIG. 1.

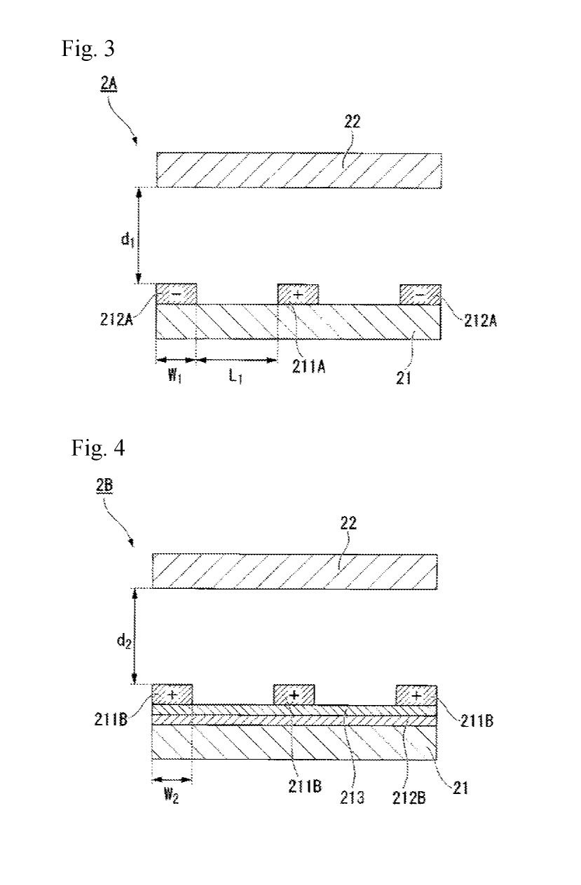

The examples of the liquid crystal display element of the present invention also include an in-plane switching (IPS) type or a fringe field switching (FFS) type liquid crystal display element including the cell shown in FIG. 3 or 4.

The liquid crystal display element of the present invention can have the same configuration as that of a known liquid crystal display element, except for including the liquid crystal composition of the present invention as a liquid crystal composition.

Hereinafter, the cells shown in FIGS. 3 and 4 will be described in detail.

FIG. 3 is a cross-sectional view schematically showing main parts of one embodiment of the cell used in the liquid crystal display element of the present invention.

A cell 2A shown here includes a pair of substrates: a first substrate 21 and a second substrate 22. A first electrode 211A and a second electrode 212A are alternately disposed on the surface of the first substrate 21 that opposes (faces) the second substrate 22. Here, the case where the first electrode 211A is an anode and the second electrode 212A is a cathode is shown. In the cell 2A, the liquid crystal composition is interposed between the first substrate 21 and the second substrate 22.

A cell gap d₁, an electrode width W₁ of the first electrode 211A and the second electrode 212A, and a distance L₁ between the first electrode 211A and the second electrode 212A in the cell 2A satisfy the conditions of L₁/d₁>1 and L₁/W₁>1. The distance L₁ between the electrodes is greater than the cell gap d₁ and the electrode width W₁, and the cell does not have a structure in which the first electrode 211A and the second electrode 212A are close to each other. The cell has an electrode configuration used in an IPS type liquid crystal display element.

FIG. 4 is a cross-sectional view schematically showing main parts of another embodiment of the cell used in the liquid crystal display element of the present invention. Among the constitutional elements shown in FIG. 4, the same constitutional elements shown in FIG. 3 are given the same reference signs as in the case of FIG. 3, and detailed description thereof will be omitted.

A cell 2B shown here includes the pair of substrates: the first substrate 21 and the second substrate 22. A second electrode 212B and an insulation layer 213 are laminated in this order on the surface of the first substrate 21 that opposes the second substrate 22 toward the second substrate 22 side. In addition, a plurality of first electrodes 211B are disposed at a predetermined interval on the surface of the insulation layer 213 that opposes the second substrate 22. Here, the case where the first electrode 211B is an anode, and the second electrode 212B is a cathode is shown. In the cell 2B, the liquid crystal composition is interposed between the first substrate 21 and the second substrate 22.

In the cell 2B, a cell gap d₂ and an electrode width W₂ of the first electrode 211B can have, for example, the same definitions as those of d₁ and W₁ in the cell 2A, respectively. Since in the cell 2B, the distance L₁ between the electrodes in the cell 2A becomes 0 (zero), the cell 2B has a structure in which the first electrode 211B and the second electrode 212B are laminated by sandwiching the insulation layer 213 therebetween and has an electrode configuration used in an FFS type liquid crystal display element.

In particular, in the cell 2B which is an FFS type, an electric field is generated in a direction parallel to the surfaces of the first substrate 21 and the second substrate 22 (horizontal direction), as well as in a direction vertical to the surfaces of the first substrate 21 and the second substrate 22 (longitudinal direction). Specifically, a strong electric field is generated in the longitudinal direction, in a region near the side surface of the first electrode 211B. In this case, in addition to the liquid crystal molecules located between the electrodes (between the first electrode 211B and the second electrode 212B), the liquid crystal molecules located on the electrodes (on the first electrode 211B and on the second electrode 212B) are also more strongly driven, unlike in the cell used in an IPS type liquid crystal display element. Therefore, in the cell 2B, by using transparent electrodes as the first electrode 211B and the second electrode 212B, respectively, a display function can be manifested in these electrode portions as well. In a liquid crystal display element including such cell, numerical aperture can be increased.

The cells shown in FIGS. 1, 3, and 4 are merely examples of a part of a cell that can be used in the liquid crystal display element of the present invention, and a cell that can be used in the liquid crystal display element is not limited thereto. For example, the cells shown in FIGS. 1, 3, and 4 can be used by being modified in various ways.

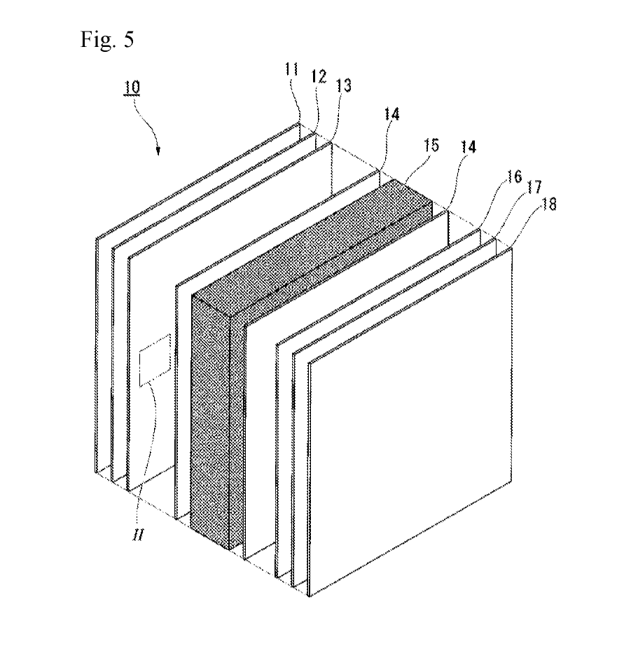

FIG. 5 is a schematic view showing one embodiment of the liquid crystal display element of the present invention. Note that in FIG. 5, each constitutional element is depicted as being separated from each other, for convenience of description. A liquid crystal display element 10 shown here includes a first transparent insulating substrate (hereinafter, may be abbreviated as a “first substrate”) 12 having an alignment film 14 formed on the surface thereof, a second transparent insulating substrate (hereinafter, may be abbreviated as a “second substrate”) 17 provided to be separated from the first substrate and having the alignment film 14 formed on the surface thereof, a liquid crystal layer 15 that fills the space between the first substrate 12 and the second substrate 17 and abuts against a pair of the alignment films, and an electrode layer 13 having a thin-film transistor as an active element, a common electrode 122, and a pixel electrode 121, between the alignment film 14 and the first substrate 12.

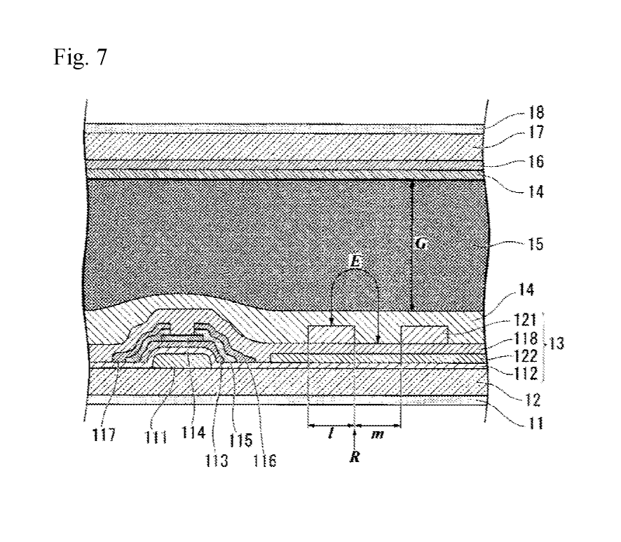

As shown in FIG. 5, the liquid crystal display element 10 is an in-plane switching system (here, as an example, an FFS type which is one form of an IPS type) liquid crystal display element which includes the first substrate 12 and the second substrate 17 disposed to oppose each other and sandwiches the liquid crystal layer 15 containing the liquid crystal composition therebetween. The electrode layer 13 is formed on the surface of the first substrate 12 on the liquid crystal layer 15 side. In addition, the liquid crystal display element includes the pair of alignment films 14 and 14 which induces homogeneous alignment by directly abutting against the liquid crystal composition constituting the liquid crystal layer 15, between the liquid crystal layer 15 and the first substrate 12 and between the liquid crystal layer 15 and the second substrate 17, respectively. Both of the alignment directions of the alignment films 14 are substantially parallel to the surface of the first substrate 12 or the second substrate 17. That is, liquid crystal molecules in the liquid crystal composition are aligned to be substantially parallel to the surface of the first substrate 12 or the second substrate 17, when voltage is not applied. As shown in FIGS. 5 and 7, the first substrate 12 and the second substrate 17 may be sandwiched between a pair of polarizing plates 11 and 18. Furthermore, as shown in FIGS. 5 and 7, a color filter 16 is provided between the second substrate 17 and the alignment film 14. The liquid crystal display element of the present invention may be a so-called color filter on array (COA), may be provided with a color filter between an electrode layer including a thin-film transistor and a liquid crystal layer, and may be provided with a color filter between the electrode layer including a thin-film transistor and a second substrate.

The liquid crystal display element 10 shown here has a configuration in which the first polarizing plate 11, the first substrate 12, the electrode layer 13 including the thin-film transistor, the alignment film 14, the liquid crystal layer 15 containing the liquid crystal composition, the alignment film 14, the color filter 16, the second substrate 17, and a second polarizing plate 18 are laminated in this order.

As the first substrate 12 and the second substrate 17, substrates formed of glass or a transparent insulating material having flexibility such as plastic can be used, or substrates formed of a non-transparent insulating material such as silicon may be used. The first substrate 12 and the second substrate 17 are bonded together by a sealant such as an epoxy-based thermally curable composition and a sealing material disposed in the peripheral region, and a particulate spacer such as glass particles, plastic particles, and alumina particles or a spacer column formed of a resin formed by a photolithography method may be disposed therebetween in order to maintain the distance between the substrates.

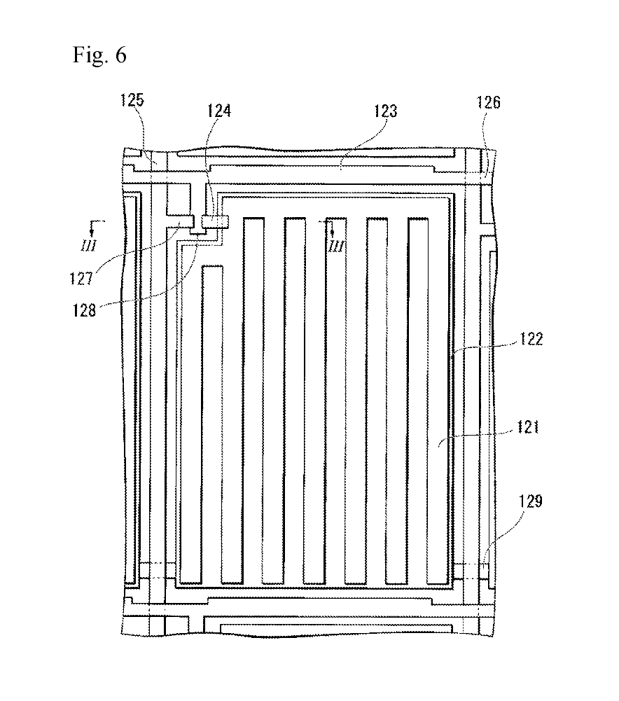

FIG. 6 is an enlarged plan view of the area surrounded by the line II on the electrode layer 13 formed on the first substrate 12 in FIG. 5. FIG. 7 is a cross-sectional view obtained by cutting the liquid crystal display element shown in FIG. 3 in the direction of the line III-III in FIG. 6. As shown in FIG. 6, in the electrode layer 13 including the thin-film transistor, which is formed on the surface of the first substrate 12, a plurality of gate wirings 124 for supplying a scanning signal and a plurality of data wirings 125 for supplying a display signal are disposed to cross each other in a matrix form. In FIG. 6, only a pair of the gate wirings 124 and a pair of the data wirings 125 are shown.

A unit pixel of the liquid crystal display device is formed by each of the areas surrounded by the plurality of gate wirings 124 and the plurality of data wirings 125, and the pixel electrode 121 and the common electrode 122 are formed in the unit pixel. A thin-film transistor including a source electrode 127, a drain electrode 126, and a gate electrode 128 is provided in the vicinity of the crossing portion of the gate wiring 124 and the data wiring 125. The thin-film transistor is connected to the pixel electrode 121 and drives the pixel electrode 121, serving as a switch element that supplies a display signal to the pixel electrode 121. Furthermore, a common line 129 is provided to be parallel to the gate wiring 124. The common line 129 is connected to the common electrode 122 in order to supply a common signal to the common electrode 122.

As shown in FIG. 7, one preferable aspect of a structure of the thin-film transistor includes a gate electrode 111 which is formed on the surface of the first substrate 12, a gate insulation layer 112 which is provided to cover the gate electrode 111 and to cover substantially the entire surface of the first substrate 12, a semiconductor layer 113 which is formed on the surface of the gate insulation layer 112 so as to oppose the gate electrode 111, a protective layer 114 which is provided to cover a portion of the surface of the semiconductor layer 113, a drain electrode 116 which is provided to cover one side end portions of the protective layer 114 and the semiconductor layer 113 and to contact the gate insulation layer 112 formed on the surface of the first substrate 12, a source electrode 117 which is provided to cover the other side end portions of the protective layer 114 and the semiconductor layer 113 and to contact the gate insulation layer 112 formed on the surface of the first substrate 12, and an insulation protective layer 118 which is provided to cover the drain electrode 116 and the source electrode 117. In the thin-film transistor, an anodic oxide coating (not shown in the drawing) may be formed on the surface of the gate electrode 111 for the purpose of eliminating a step generated by the gate electrode, and the like.

Although amorphous silicon, polycrystalline polysilicon, and the like can be used as the semiconductor layer 113, it is preferable to use a transparent semiconductor film such as ZnO, In—Ga—Zn—O (IGZO), ITO, and the like, from the viewpoint of preventing adverse effects of a photocarrier generated by light absorption and increasing numerical aperture of an element.

For the purpose of decreasing a width or a height of a Schottky barrier, an ohmic contact layer 115 may be provided between the semiconductor layer 113 and the drain electrode 116 or the source electrode 117. A material to which an impurity such as phosphorus is added at a high concentration, such as n-type amorphous silicon, n-type polycrystalline polysilicon, and the like can be used as the ohmic contact layer 115.

A gate wiring 126, the data wiring 125, and the common line 129 are preferably metals, more preferably Al, Cu, Au, Ag, Cr, Ta, Ti, Mo, W, Ni, or an alloy thereof, and particularly preferably Al or an alloy thereof. The insulation protective layer 118 is a layer having an insulating function and is formed of silicon nitride, silicon dioxide, or a silicon oxynitride film.

In the embodiment shown in FIGS. 6 and 7, the common electrode 122 is a flat plate-shaped electrode formed on substantially the entire surface on the gate insulation layer 112 (that is, the first substrate 12), whereas the pixel electrode 121 is a comb-shaped electrode formed on the insulation protective layer 118 which covers the common electrode 122. In other words, the common electrode 122 is more closely disposed to the first substrate 12 than the pixel electrode 121 is, and these electrodes lie on top of each other by sandwiching the insulation protective layer 118 therebetween. The pixel electrode 121 and the common electrode 122 are formed of, for example, a transparent conductive material such as Indium Tin Oxide (ITO), Indium Zinc Oxide (IZO), Indium Zinc Tin Oxide (IZTO), and the like. Since the pixel electrode 121 and the common electrode 122 are formed of the transparent conductive material, the area of opening in a unit pixel area is increased, and numerical aperture and transmittance increase.

Furthermore, in order to form a fringe electric field between the pixel electrode 121 and the common electrode 122, a distance (minimum separation distance) R between the pixel electrode 121 and the common electrode 122 is shorter than a distance G between the first substrate 12 and the second substrate 17. Here, the distance R between the electrodes indicates a distance between each electrode in a direction parallel to the surface of the substrate. FIG. 7 shows an example in which the flat plate-shaped common electrode 122 and the comb-shaped pixel electrode 121 lie on top of each other, and thus the distance R between the electrodes is 0, and a fringe electric field E is formed, since the distance (minimum separation distance) R between the electrodes is shorter than the distance G between the first substrate 12 and the second substrate 17 (that is, a cell gap). Therefore, in an FFS type liquid crystal display element, an electric field in a horizontal direction which is formed in a direction vertical to the line that forms the comb shape of the pixel electrode 121 and a parabolic electric field can be used. An electrode width l of the comb-shaped portion of the pixel electrode 121 and a gap m in the comb-shaped portion of the pixel electrode 121 are preferably formed to be sufficiently wide to allow all liquid crystal molecules in the liquid crystal layer 15 to be driven by the electric field that is generated. The distance (minimum separation distance) R between the pixel electrode 121 and the common electrode 122 can be adjusted as a (average) film thickness of the gate insulation layer 112. In addition, unlike FIG. 7, the liquid crystal display element of the present invention may be formed such that the distance (minimum separation distance) R between the pixel electrode 121 and the common electrode 122 is longer than the distance G between the first substrate 12 and the second substrate 17 (corresponding to an IPS type). Such liquid crystal display element has, for example, a configuration in which a comb-shaped pixel electrode and a comb-shaped common electrode are alternately provided substantially in the same plane.

The liquid crystal display element of the present invention is preferably an FFS type liquid crystal display element using a fringe electric field, and in the case where the shortest separation distance between the common electrode 122 and the pixel electrode 121 adjacent to each other is shorter than the shortest separation distance between the alignment films 14 (distance between substrates), a fringe electric field is formed between the common electrode and the pixel electrode, and alignment of the liquid crystal molecules in a horizontal direction and a vertical direction can be efficiently used. In the case of the FFS type liquid crystal display element of the present invention, when a voltage is applied to the liquid crystal molecules that are disposed such that the long axis direction thereof is parallel to the alignment direction of the alignment film, a line of electric force of a parabolic electric field between the pixel electrode 121 and the common electrode 122 is formed up to the upper portion of the pixel electrode 121 and the common electrode 122, and the long axes of the liquid crystal molecules in the liquid crystal layer 15 are arranged to be orthogonal to the electric field that is formed. Accordingly, the liquid crystal molecules can be driven even at low dielectric anisotropy.

It is preferable that the color filter 16 forms black matrix (not shown in the drawings) on a portion that corresponds to a thin-film transistor and a storage capacitor 123, from the viewpoint of preventing leakage of light. The color filter 16 is generally formed of three filters of red (R), green (G), and blue (B) and constitutes one dot of a picture or an image. For example, these three filters are lined up in an extending direction of a gate wiring. The color filter 16 can be produced by a pigment dispersion method, a printing method, an electrodeposition method, or a dyeing method. For example, a method for producing a color filter by the pigment dispersion method will be described. A transparent substrate is coated with a curable coloring composition for a color filter, a patterning treatment is performed, and the composition is cured by heating or irradiation with light. This process is performed for each of the three colors, red, green, and blue, thereby producing a pixel portion for a color filter. In addition, a so-called color filter on array in which a pixel electrode provided with an active element such as a TFT and a thin-film diode is placed on the substrate may be adopted.

The pair of alignment films 14 which directly abut against the liquid crystal composition constituting the liquid crystal layer 15 and induce homogeneous alignment are provided on the electrode layer 13 and the color filter 16.

The polarization axis of each of the polarizing plate 11 and the polarizing plate 18 can be adjusted so as to adjust the view angle or the contrast such that the view angle or the contrast is improved, and the polarizing plates preferably have the transmission axes that intersect at a right angle, such that the transmission axes are operated at a normally black mode. In particular, any one of the polarizing plate 11 and the polarizing plate 18 is preferably disposed such that the transmission axis thereof is parallel to the alignment direction of the liquid crystal molecules. The product of the refractive index anisotropy of the liquid crystal and the cell gap is preferably adjusted such that the contrast becomes maximum. Furthermore, in order to widen the view angle, a phase difference film may be used.

In the case where another embodiment of the liquid crystal display element of the present invention is an IPS type, the shortest separation distance between a common electrode and a pixel electrode adjacent to each other is longer than the shortest separation distance between liquid crystal alignment films. For example, in the case where the common electrode and the pixel electrode are formed on the same substrate and the common electrode and the pixel electrode are alternately disposed, the liquid crystal display element has a structure in which the shortest separation distance between the common electrode and the pixel electrode adjacent to each other is longer than the shortest separation distance between the liquid crystal alignment films.

The liquid crystal display element of the present invention is preferably produced by forming a coating on the surface of a substrate having an electrode layer and/or a substrate, separating a pair of the substrates from each other such that the coatings become the inner sides, disposing the substrates such that they oppose each other, and then filling the space between the substrates with the liquid crystal composition. At this time, the spacing between the substrates is preferably adjusted by sandwiching a spacer therebetween.

The distance between the substrates (the average thickness of the obtained liquid crystal layer; also referred to as a separation distance between the coatings) is preferably adjusted to be 1 to 100 μm. An average separation distance between the coatings is preferably 1.5 to 10 μm.

In the present invention, examples of the spacer used to adjust the distance between the substrates include glass particles, plastic particles, alumina particles, a column spacer formed of a photoresist material, and the like.

The FFS type liquid crystal display element described using FIGS. 5 to 7 is an example of the liquid crystal display element of the present invention, and the liquid crystal display element can be modified in various ways within a scope that does not depart from the technical idea of the present invention.

<<Liquid Crystal Display>>

A liquid crystal display of the present invention includes the liquid crystal display element of the present invention, and the liquid crystal display of the present invention can have the same configuration as that of a known liquid crystal display, except for including the liquid crystal display element of the present invention.

The liquid crystal display of the present invention can used as, for example, a liquid crystal display in image display devices such as a liquid crystal television, a monitor for a computer, a mobile phone, an information terminal, and a game machine.

### EXAMPLE

Hereinafter, the present invention will be more specifically described using Examples, however, the present invention is not limited to these Examples.

### Example 1

A liquid crystal composition having a dielectric anisotropy (Δε) of −3.38 and the composition shown below was prepared.

Next, using the cell for a liquid crystal display element having the configuration shown in FIG. 1, K₂₂ and K₃₃ for the liquid crystal composition were obtained from Equation (1), and K₁₁ was separately obtained, so as to obtain a Γ value from Equation (2), as described above. Furthermore, the maximum light transmittance of the liquid crystal composition (hereinafter, may be abbreviated as “Tmax”) was measured. These values are shown in Table 1 along with other physical properties.

When obtaining K₂₂, the liquid crystal composition to which a chiral compound represented by the following formula is further added and which has the composition shown below is used. The helical twisting power (HTP) of the chiral compound is 11.1 μm⁻¹.

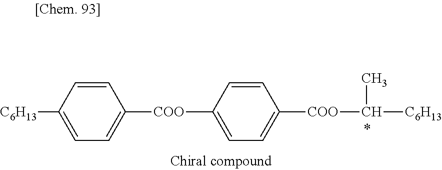

Each symbol in Table 1 indicates the following, respectively.

Δn: refractive index anisotropy

Tni: upper limit temperature of nematic liquid crystal phase

T→n: lower limit temperature of nematic liquid crystal phase

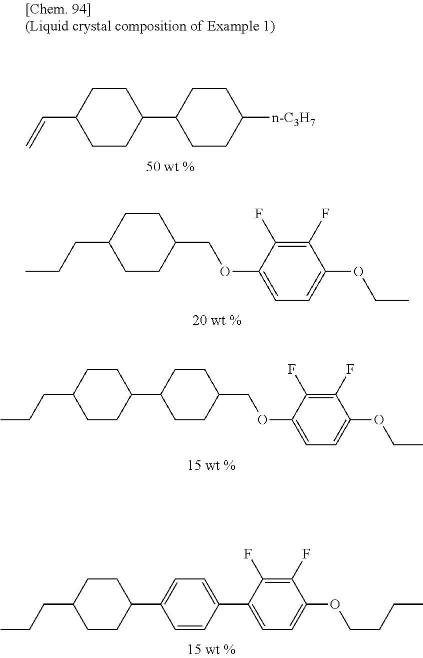

### Example 2

A liquid crystal composition having a dielectric anisotropy (Δε) of −3.75 and the following composition was prepared.

Thereafter, the Γ value was obtained, and Tmax was measured using the same method as in Example 1, except for using this liquid crystal composition. These values and other physical properties are shown in Table 1.

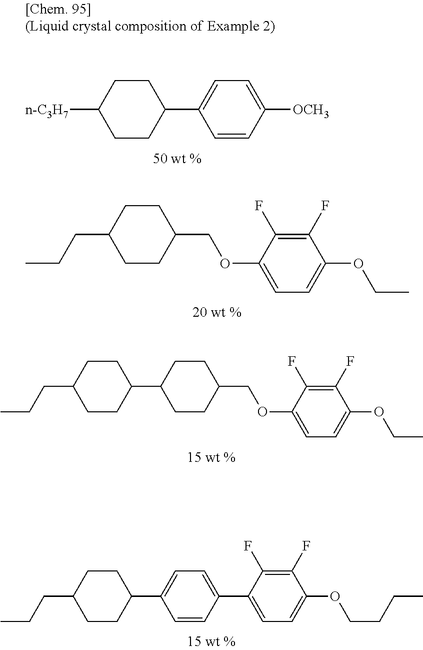

### Comparative Example 1

A liquid crystal composition having a dielectric anisotropy (Δε) of −3.33 and the following composition was prepared.

Thereafter, the Γ value was obtained, and Tmax was measured using the same method as in Example 1, except for using this liquid crystal composition. These values and other physical properties are shown in Table 1.

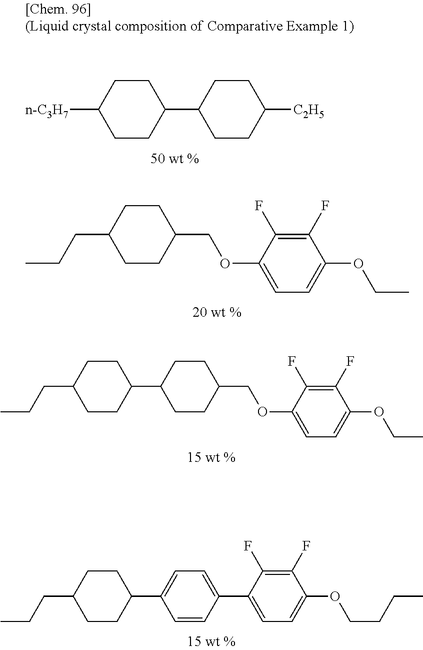

TABLE 1

| | | | Comparative |
|---|---|---|---|
| | Example 1 | Example 2 | Example 1 |
| Tni (° C.) | 67.5 | 47.3 | 62.4 |
| T→n (° C.) | −5 | >0 | >0 |
| Δn | 0.079 | 0.092 | 0.073 |
| Δε | −3.38 | −3.75 | −3.33 |
| K₁₁ | 12.4 | 9.3 | 12.9 |
| K₂₂ | 6.6 | 4.8 | 6.9 |
| K₃₃ | 13.4 | 10.6 | 11.6 |
| Γ | 0.256 | 0.241 | 0.282 |
| Tmax (%) | 21.1 | 25.2 | 18.8 |

As can be clearly understood from the results, the liquid crystal compositions of Examples 1 and 2 having small Γ values had high Tmax's, unlike the liquid crystal composition of Comparative Example 1 having a large Γ value. The liquid crystal compositions of Examples 1 and 2 had favorable characteristics.

### Example 3

A liquid crystal composition having a dielectric anisotropy (Δε) of −2.60 and the following composition was prepared.

Thereafter, the Γ value was obtained, and Tmax was measured using the same method as in Example 1, except for using this liquid crystal composition. These values and other physical properties are shown in Table 2.

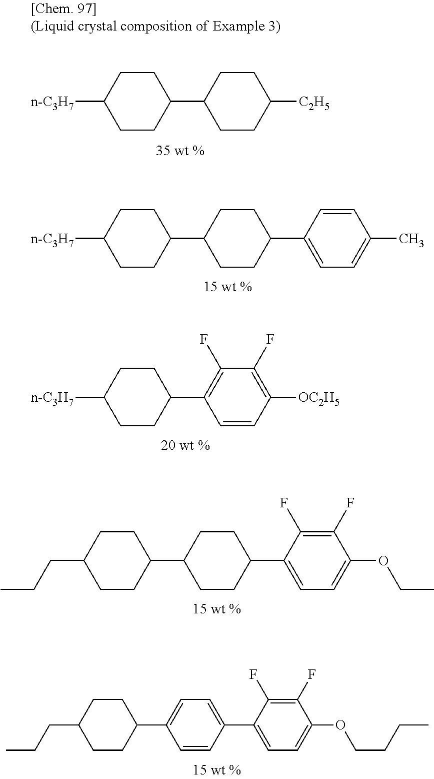

### Example 4

A liquid crystal composition having a dielectric anisotropy (Δε) of −2.59 and the following composition was prepared.

Thereafter, the Γ value was obtained, and Tmax was measured using the same method as in Example 1, except for using this liquid crystal composition. These values and other physical properties are shown in Table 2.

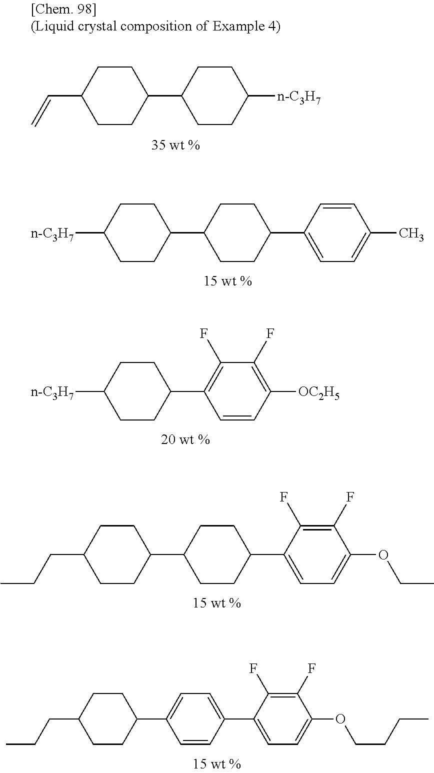

### Example 5

A liquid crystal composition having a dielectric anisotropy (Δε) of −2.54 and the composition shown below was prepared.

Thereafter, the Γ value was obtained, and Tmax was measured using the same method as in Example 1, except for using this liquid crystal composition. These values and other physical properties are shown in Table 2.

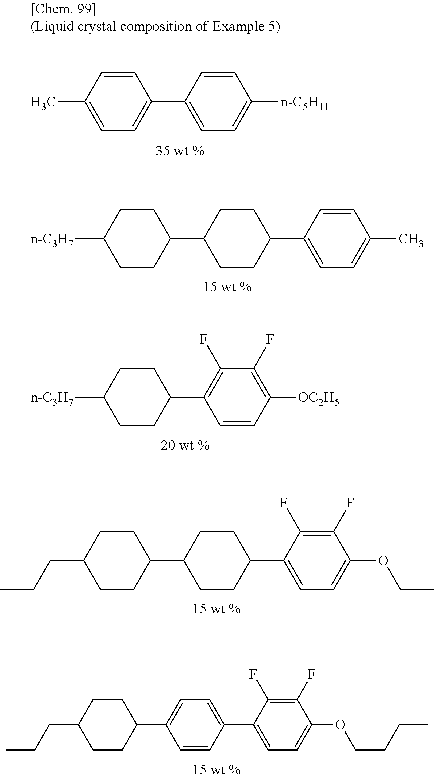

### Example 6

A liquid crystal composition having a dielectric anisotropy (Δε) of −2.18 and the composition shown below was prepared.

Thereafter, the Γ value was obtained, and Tmax was measured using the same method as in Example 1, except for using this liquid crystal composition. These values and other physical properties are shown in Table 2.

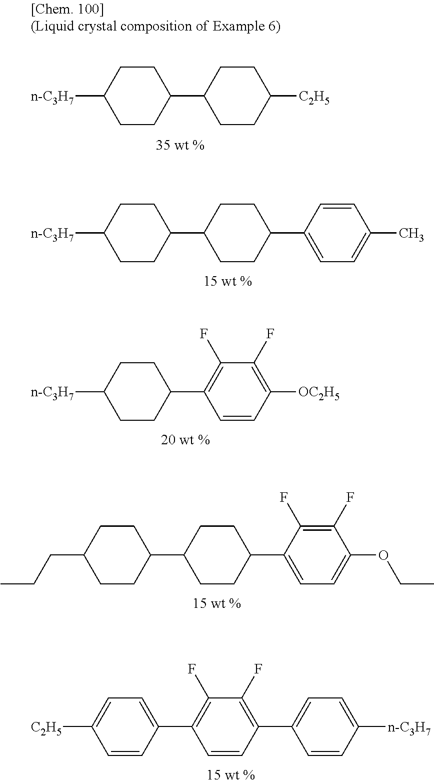

TABLE 2

| | Example 3 | Example 4 | Example 5 | Example 6 |
|---|---|---|---|---|
| Tni (° C.) | 81.5 | 85.4 | 64.0 | 74.1 |
| T→n (° C.) | −22 | −58 | −57 | −19 |
| Δn | 0.084 | 0.090 | 0.133 | 0.095 |
| Δε | −2.60 | −2.59 | −2.54 | −2.18 |
| K₁₁ | 15.3 | 15.1 | 16.1 | 14.4 |
| K₂₂ | 7.2 | 7.2 | 7.1 | 6.8 |
| K₃₃ | 14.9 | 16.5 | 15.6 | 13.9 |
| Γ | 0.238 | 0.228 | 0.224 | 0.240 |
| Tmax (%) | 23.0 | 24.8 | 29.5 | 25.9 |

As can be clearly understood from the results, the liquid crystal compositions of Examples 3 to 6 had small Γ values and high Tmax's, although the kinds of the liquid crystal compound having a dielectric anisotropy of approximately zero were different. The liquid crystal compositions of Examples 3 to 6 had favorable characteristics.

### Example 7

A liquid crystal composition having a dielectric anisotropy (Δε) of −3.05 and the composition shown below was prepared.

Thereafter, the Γ value was obtained, and Tmax was measured using the same method as in Example 1, except for using this liquid crystal composition. These values and other physical properties are shown in Table 3.

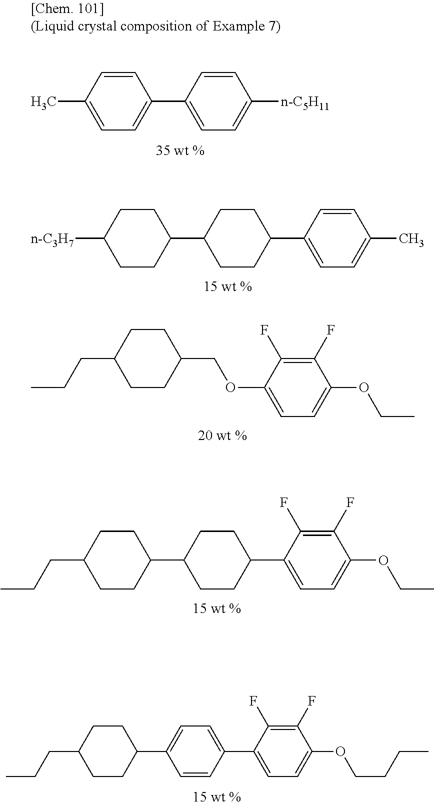

### Example 8

A liquid crystal composition having a dielectric anisotropy (Δε) of −2.86 and the composition shown below was prepared.

Thereafter, the Γ value was obtained, and Tmax was measured using the same method as in Example 1, except for using this liquid crystal composition. These values and other physical properties are shown in Table 3.

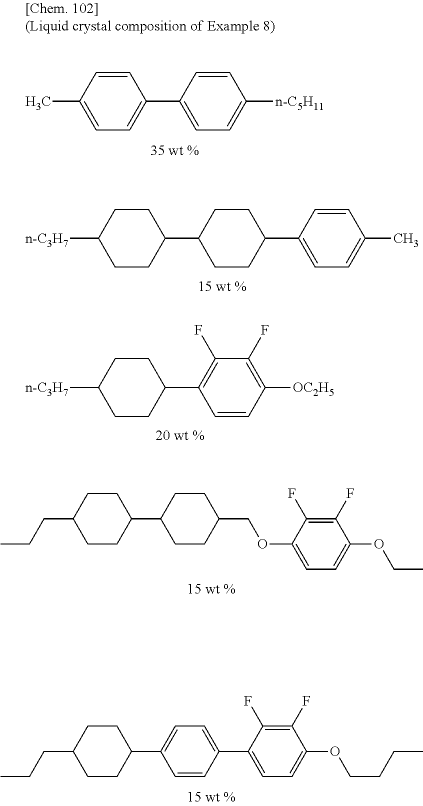

### Example 9

A liquid crystal composition having a dielectric anisotropy (Δε) of −3.41 and the composition shown below was prepared.

Thereafter, the Γ value was obtained, and Tmax was measured using the same method as in Example 1, except for using this liquid crystal composition. These values and other physical properties are shown in Table 3.

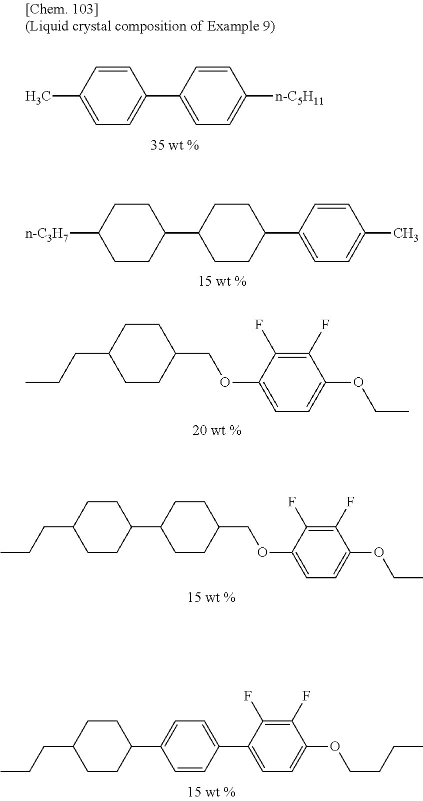

TABLE 3

| | Example 7 | Example 8 | Example 9 |
|---|---|---|---|
| Tni (° C.) | 65.2 | 62.8 | 63.5 |
| T→n (° C.) | −53 | −56 | −50 |
| Δn | 0.133 | 0.131 | 0.132 |
| Δε | −3.05 | −2.86 | −3.41 |
| K₁₁ | 16.8 | 15.6 | 16.7 |
| K₂₂ | 7.1 | 7.0 | 7.1 |
| K₃₃ | 15.4 | 15.0 | 15.1 |
| Γ | 0.220 | 0.229 | 0.223 |
| Tmax (%) | 29.5 | 29.5 | 29.6 |

As can be clearly understood from the results, the liquid crystal compositions of Examples 7 to 9 had small Γ values and high Tmax's, although the kinds of the liquid crystal compound having a negative dielectric anisotropy were different. The liquid crystal compositions of Examples 7 to 9 had favorable characteristics.

### INDUSTRIAL APPLICABILITY

The present invention can be used in production of a liquid crystal display having excellent display characteristics.
2, 2A, 2B, 2C cell
21, 23 first substrate
22, 24 second substrate
211A, 211B, 231 first electrode
212A, 212B, 241 second electrode
213 insulation layer
232 first alignment film
242 second alignment film
d₁, d₂, d₃ cell gap
W₁, W₂ electrode width
L₁ distance between electrodes
10 liquid crystal display element
12 first transparent insulating substrate
121 pixel electrode
122 common electrode
124 gate wiring
125 data wiring
14 alignment film
15 liquid crystal layer
17 second transparent insulating substrate
R distance between electrodes
G distance between substrates

1. A liquid crystal composition having a negative value of dielectric anisotropy (Δε) and a value of Γ of 0.28 or less,
wherein the value of Γ is obtained from the following Equation (2) using a twist elastic constant (K₂₂) value obtained from the following Equation (1) using measured values of a dielectric anisotropy (Δε), a threshold voltage (Vth), a bend elastic constant (K₃₃), vacuum permittivity (ε₀), a cell gap (d), and a helical pitch (P₀) and measured values of a splay elastic constant (K₁₁) and the bend elastic constant (K₃₃):
$$\begin{matrix}{V}_{th} = π \sqrt{\{ 1 - 4 {( \frac{{K}_{22}}{{K}_{33} } )}^{2} {( \frac{d}{{P}_{0}} )}^{2} \} \frac{{K}_{33}}{\vert {ɛ}_{0} Δ ɛ \vert}} & ( 1 ) \\ Γ = \frac{{K}_{22}}{{K}_{11} + {K}_{33}} . & ( 2 )\end{matrix}$$

2. The liquid crystal composition according to claim 1, comprising:
one or two or more compounds selected from the group consisting of compounds represented by General Formulas (N-1), (N-2), and (N-3): 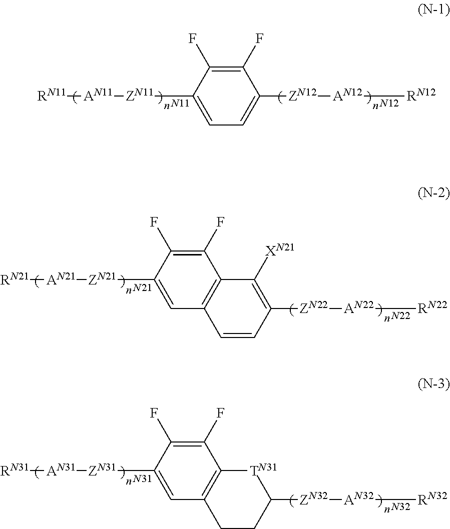
wherein R^{N11}, R^{N12}, R^{N21}, R^{N22}, R^{N31}, and R^{N32} each independently represent an alkyl group having 1 to 8 carbon atoms, and one —CH₂— or two or more —CH₂-'s which are not adjacent to each other in the alkyl group may each independently be substituted with —CH═CH—, —C≡C—, —O—, —CO—, —COO—, or —OCO—;
A^{N11}, A^{N12}, A^{N21}, A^{N22}, A^{N31}, and A^{N32} each independently represent:
(a) a 1,4-cyclohexylene group (one —CH₂— or two or more —CH₂-'s which are not adjacent to each other that are present in the group may be substituted with —O—),
(b) a 1,4-phenylene group (one —CH═ or two or more —CH═'s which are not adjacent to each other that are present in the group may be substituted with —N═), or
(c) a group selected from the group consisting of a naphthalene-2,6-diyl group, a 1,2,3,4-tetrahydronaphthalene-2,6-diyl group, and a decahydronaphthalene-2,6-diyl group (one —CH═ or two or more —CH═'s which are not adjacent to each other that are present in the naphthalene-2,6-diyl group or the 1,2,3,4-tetrahydronaphthalene-2,6-diyl group may be substituted with —N═); and
the group (a), the group (b), and the group (c) may each independently be substituted with a cyano group, a fluorine atom, or a chlorine atom;
Z^{N11}, Z^{N12}, Z^{N21}, Z^{N22}, Z^{N31}, and Z^{N32} each independently represent a single bond, —CH₂CH₂—, —(CH₂)₄—, —OCH₂—, —CH₂O—, —COO—, —OCO—, —OCF₂, —CF₂O—, —CH═N—N═CH—, —CH═CH—, —CF═CF—, or —C≡C—;
X^{N21} represents a hydrogen atom or a fluorine atom;
T^{N31} represents —CH₂— or an oxygen atom; and
n^{N11}, n^{N12}, n^{N21}, n^{N22}, n^{N31}, and n^{N32} each independently represent an integer of 0 to 3, provided that the sum of n^{N11}+n^{N12}, the sum of n^{N21}+n^{N22}, and the sum of n^{N31}+n^{N32} are each independently 1, 2, or 3, and when plural groups or bonds with respect to each of A^{N11} to A^{N32} and Z^{N11} to Z^{N32} are present, they may be the same or different.

3. The liquid crystal composition according to claim 1, comprising:
one or two or more compounds represented by General Formula (L): 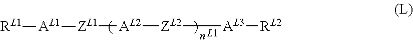
wherein R^{L1} and R^{L2} each independently represent an alkyl group having 1 to 8 carbon atoms, and one —CH₂— or two or more —CH₂-'s which are not adjacent to each other in the alkyl group may each independently be substituted with —CH═CH—, —C≡C—, —O—, —CO—, —COO—, or —OCO—;
n^{L1} represents 0, 1, 2, or 3;
A^{L1}, A^{L2}, and A^{L3} each independently represent:
(a) a 1,4-cyclohexylene group (one —CH₂— or two or more —CH₂-'s which are not adjacent to each other that are present in the group may be substituted with —O—),
(b) a 1,4-phenylene group (one —CH═ or two or more —CH═'s which are not adjacent to each other that are present in the group may be substituted with —N═), or
(c) a group selected from the group consisting of a naphthalene-2,6-diyl group, a 1,2,3,4-tetrahydronaphthalene-2,6-diyl group, and a decahydronaphthalene-2,6-diyl group (one —CH═ or two or more —CH═'s which are not adjacent to each other that are present in the naphthalene-2,6-diyl group or the 1,2,3,4-tetrahydronaphthalene-2,6-diyl group may be substituted with —N═); and
the group (a), the group (b), and the group (c) may each independently be substituted with a cyano group, a fluorine atom, or a chlorine atom;
Z^{L1} and Z^{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—; and
in the case where n^{L1} is 2 or 3 and plural A^{L2}'s are present, the plural A^{L2}'s may be the same or different, and in the case where n^{L1} is 2 or 3 and plural Z^{L3}'s are present, the plural Z^{L3}'s may be the same or different, provided that the compounds represented by General Formula (N-1), General Formula (N-2), and General Formula (N-3) are excluded.

4. The liquid crystal composition according to claim 1,
which has a value of Γ of 0.01 or more.

5. The liquid crystal composition according to claim 1, further comprising:
a polymerizable compound.

6. A liquid crystal display element using the liquid crystal composition according to claim 1.

7. A liquid crystal display comprising:
the liquid crystal display element according to claim 6.
